(19) United States
(12) Patent Application Publication
(10) Pub. No.: US 2026/0121032 A1
(43) Pub. Date: Apr. 30, 2026

(54) CHARACTERISTICS OF SILICON IN SILICON-CARBON COMPOSITE PARTICLES FOR LITHIUM-ION BATTERIES

(71) Applicant: Sila Nanotechnologies, Inc., Alameda, CA (US)

(72) Inventors: Tamlin Dawn Matthews, Oakland, CA (US); Timothy John Milakovich, San Francisco, CA (US); Wayne Lawrence Staats, JR., Livermore, CA (US); Mark Andrew Donohue, San Francisco, CA (US); Saujan Venkat Sivaram, Castro Valley, CA (US); Daniel Maurice Lund, Alameda, CA (US); Joel Sanchez, Modesto, CA (US); Gleb Nikolayevich Yushin, Atlanta, GA (US)

(21) Appl. No.: 19/373,392

(22) Filed: Oct. 29, 2025

Related U.S. Application Data
(60) Provisional application No. 63/713,940, filed on Oct. 30, 2024.

(51) Int. Cl. H01M 4/38; H01M 4/02; H01M 4/134; H01M 4/36; H01M 4/583; H01M 10/0525

(52) U.S. Cl. CPC H01M 4/386; H01M 4/134; H01M 4/366; H01M 4/583; H01M 10/0525; H01M 2004/021; H01M 2004/027

(57) ABSTRACT

A battery electrode composition includes a population of (nano)composite particles. Each of the (nano)composite particles includes silicon (Si) and carbon (C). The population is characterized by a distribution of adjusted mass fractions of the Si in the (nano)composite particles. The adjusted mass fraction W of the Si in a respective one of the (nano)composite particles is given by: W=w−w̅ (Formula 2), where w is a mass fraction of the Si in the respective one of the (nano)composite particles and w̅ is a mean of the mass fractions of the Si in the (nano)composite particles of the population. In some implementations, a standard deviation of the distribution is 0.12 or less. Related battery electrodes, lithium-ion batteries, and methods of making are also disclosed.

### CROSS-REFERENCE TO RELATED APPLICATIONS

The present application for patent claims the benefit of U.S. Provisional Application No. 63/713,940, entitled “CHARACTERISTICS OF SILICON IN SILICON-CARBON COMPOSITE PARTICLES FOR LITHIUM-ION BATTERIES,” filed Oct. 30, 2024, assigned to the assignee hereof, and expressly incorporated herein by reference in its entirety.

### BACKGROUND

### Field

Aspects of the present disclosure relate generally to energy storage devices, and more particularly to battery technology and the like.

### Background

Owing in part to their relatively high energy densities, relatively high specific energy, light weight, and potential for long lifetimes, advanced rechargeable batteries are desirable for a wide range of consumer electronics, electric vehicles, grid storage and other important applications. However, despite the increasing commercial prevalence of batteries, further development of these batteries is needed, particularly for applications in low- or zero-emission, hybrid-electric or fully electric vehicles, consumer electronics, wearable devices, energy-efficient cargo ships and locomotives, drones, aerospace applications, and power grids. Further improvements are desired for various rechargeable batteries, such as rechargeable Li and Li-ion batteries, Na and Na-ion batteries, K and K-ion batteries, and dual ion batteries, to name a few.

In certain types of Li metal and Li-ion rechargeable batteries, charge storing anodes may comprise silicon (Si)-comprising anode particles with gravimetric capacities in the range from about 800 mAh/g to about 3000 mAh/g (per mass of Si-comprising anode particles in a Li-free state). A subset of such anodes includes anodes with the electrode layer exhibiting capacity in the range from about 400 mAh/g to about 2800 mAh/g (per mass of the electrode layer, not counting the mass of the current collector, in a Li-free state). Such a class of charge-storing anodes offers great potential for increasing gravimetric and volumetric energy of rechargeable batteries.

In some batteries, the anode includes Si-comprising anode particles. In some examples, Si-comprising anode particles are silicon-carbon (nano)composite particles. As explained in greater detail herein, Si—C (nano)composite particles may be formed by depositing silicon into porous carbon particles. It may be preferable to employ silicon at relatively high mass fractions in the Si—C (nano)composite particles, such as in a range of 35 to 75 wt. %. This may be accomplished, for example, by depositing relatively large amounts of silicon in the pore volume of the porous carbon particles. In turn, porous carbon particles with sufficient pore volumes for accommodating the silicon in a subsequent silicon deposition operation may be provided. As processes are implemented to increase the silicon mass fraction in a population of Si—C (nano)composite particle, the population may tend to exhibit greater variations (e.g., particle-to-particle variations) in the silicon mass fractions, arising from variations (e.g., spatial variations) in the silicon deposition operation and/or particle-to-particle variations in the pore characteristics of the porous carbon particles.

As described in greater detail herein, there are techniques for quickly estimating an average silicon mass fraction of silicon in a population of Si—C (nano)composite particles. However, little or no attention has been paid to estimating the variations in the Si mass fractions in populations of Si—C (nano)composite particles and assessing the effect of such variations on the performance of the Si—C (nano)composite particles in batteries. Accordingly, there is a need for improved anode materials such as improved Si—C (nano)composite particles, and related batteries, components, and manufacturing and testing processes.

Accordingly, there remains a need for improved batteries, components, and other related materials and manufacturing processes.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a battery electrode composition includes a population of (nano)composite particles, each of the (nano)composite particles comprising silicon (Si) and carbon (C), wherein: the population is characterized by a distribution of adjusted mass fractions of the Si in the (nano)composite particles; the adjusted mass fraction W of the Si in a respective one of the (nano)composite particles is given by: W=w−w̅ (Formula 2), w being a mass fraction of the Si in the respective one of the (nano)composite particles and w being a mean of the mass fractions of the Si in the (nano)composite particles of the population; and a standard deviation of the distribution is 0.12 or less.

In an aspect, a method comprising: (a1) providing porous particles comprising carbon (C); and (a2) depositing silicon (Si) in the porous particles under agitation to form a population of (nano)composite particles, each of the (nano)composite particles comprising the Si and the C; and (a3) obtaining a battery electrode composition from the population of (nano)composite particles, wherein: the population is characterized by a distribution of adjusted mass fractions of the Si in the (nano)composite particles; the adjusted mass fraction of the Si in a respective one of the (nano)composite particles W is given by: W=w−w̅ (Formula 2), w being a mass fraction of the Si in the respective one of the (nano)composite particles and w being a mean of the mass fractions of the Si in the (nano)composite particles of the population; and a standard deviation of the distribution is 0.12 or less.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of embodiments of the disclosure and are provided solely for illustration of the embodiments and not limitation thereof. Unless otherwise stated or implied by context, different hatchings, shadings, and/or fill patterns in the drawings are meant only to draw contrast between different components, elements, features, etc., and are not meant to convey the use of particular materials, colors, or other properties that may be defined outside of the present disclosure for the specific pattern employed.

FIG. 1 illustrates an example Li-ion battery in which the components, materials, processes, and/or other techniques described herein may be implemented.

FIG. 2 is a flow diagram of a process of making a Li-ion rechargeable battery cell in accordance with certain embodiments.

FIG. 3 is a flow diagram of a process of making silicon-carbon (nano)composite particles from porous carbon particles.

FIG. 4 is a flow diagram of a process of estimating a mass fraction of silicon in a population of silicon-carbon composite particles by using thermogravimetric analysis (TGA).

FIG. 5 is a flow diagram of a process of preparing a pellet sample of Si—C (nano)composite particles for SEM-EDX (scanning electron microscopy with energy-dispersive x-ray spectroscopy).

FIG. 6 is a flow diagram of a process of carrying out SEM-EDX analysis on a sample of silicon-carbon composite particles.

FIG. 7 is an SEM image of a polished pellet sample of Si—C (nano)composite particles embedded in a potting medium.

FIG. 8 is a flow diagram of a process of carrying out statistical analysis on a silicon mass fraction distribution of a population of silicon-carbon composite particles.

Each of FIGS. 9A, 9B, and 9C includes (1) a graphical plot (shown in bar graph format) of a distribution (a number of composite particles, in arbitrary units) as a function of the adjusted measured mass fractions of the silicon in the silicon-carbon composite particles for respective populations of silicon-carbon composite particles, and (2) a probability density function (PDF) that is the best curve fit to the distribution (1) above. The PDF is a plot of a probability as a function of the adjusted measured mass fractions of the silicon in the silicon-carbon composite particles. The probability refers to a probability that a randomly-chosen composite particle will exhibit the respective adjusted mass fraction. FIGS. 9A, 9B, and 9C show data obtained from Samples A, B, and C of populations of Si—C (nano)composite particles, respectively.

FIG. 9D shows the probability density functions (PDFs) of the respective populations of silicon-carbon composite particles (corresponding to the PDFs shown in FIGS. 9A, 9B, and 9C).

FIG. 10 shows graphical plots of the estimated number of cycles to reach 80% of the cycling-start discharge capacity (sometimes abbreviated as N80), as a function of number of cycles (room-temperature cycling), for two groups of lithium-ion battery cells.

FIG. 11 (Table 1) shows selected statistical moments (variance, standard deviation, skewness, kurtosis) and full-width at half-maximum (FWHM) of the probability density functions (PDFs) of Samples A, B, and C.

FIGS. 12A, 12B, and 12C are graphical plots of the adjusted Si mass fractions as a function of cumulative probabilities in a range of 0 to 100%, corresponding to the probability density functions (PDFs) of Samples A, B, and C, respectively.

FIG. 13 (Table 2) shows spans of the adjusted Si mass fractions between minimum and maximum cumulative probabilities (minimum and maximum percentiles), for the probability density functions (PDFs) of Samples A, B, and C. In the examples shown, the minimum and maximum cumulative probabilities (minimum and maximum percentiles) are chosen to be symmetrical about a cumulative probability of 50% (50th percentile).

FIG. 14 (Table 3) shows spans of the adjusted Si mass fractions between minimum and maximum cumulative probabilities (minimum and maximum percentiles), for the probability density functions (PDFs) of Samples A, B, and C. The cumulative probabilities are chosen to be 50% or less.

FIG. 15 (Table 4) shows spans of the adjusted Si mass fractions between minimum and maximum cumulative probabilities (minimum and maximum percentiles), for the probability density functions (PDFs) of Samples A, B, and C. The cumulative probabilities are chosen to be 50% or more.

FIG. 16 (Table 5) shows span ratios for selected pairs of left-side spans (obtained for selected minimum and maximum cumulative probabilities, with the cumulative probabilities being of 50% or less, Table 3) and right-side spans (obtained for selected minimum and maximum cumulative probabilities, with the cumulative probabilities being 50% or more, Table 4) of the probability density functions (PDFs) of Samples A, B, and C. The span ratios are calculated by dividing the right-side span by the left-side span and indicate a degree of asymmetry of the adjusted Si mass fractions about the 50th percentile.

FIG. 17A shows graphical plots 1701 and 1702 of volume-weighted particle size distributions (PSDs) of example populations of jagged composite particles. Graphical plot 1701 shows the PSDs of example populations of respective D₅₀ values exhibiting relatively broad PSDs, before any optimization of the respective PSDs. Graphical plot 1702 shows (1) the PSD of an example population before any optimization of its PSD (D₅₀ of about 10.1 μm) and (2) the PSD of an example population after optimization of its PSD (D₅₀ of about 9.8 μm). The PSD optimization includes removal of fine particles and removal of coarse particles. As a result of these PSD optimization processes, the PSD has changes from a relatively broader PSD (e.g., greater span, greater FWHM) to a relatively narrower PSD (e.g., smaller span, smaller FWHM).

FIG. 17B shows a Table 6 tabulating selected characteristics (D₁₀, D₅₀, D₉₀, D₉₉, PSD span, FWHM, D₁₀/D₅₀, BET-SSA, and whether the population has not undergone any optimization of its PSD (so-called “broad” PSD) or has undergone optimization of its PSD (so-called “narrow” PSD)) of example populations of jagged composite particles, and selected characteristics (estimated capacity of electrode active material comprising the respective jagged composite particles and graphite particles, electrode coating density, and cycle life) of electrode coatings and battery cells derived from the respective example populations of jagged composite particles. In this Table 6 (FIG. 17B), a FWHM refers to the full-width at half-maximum of the PSD of the respective populations of jagged composite particles. The electrode active material comprised a mixture of the jagged composite particles and the graphite particles.

FIG. 18 shows graphical plots 1802, 1804, and 1806 of selected PSD characteristics of example populations of jagged composite particles. Graphical plot 1802 shows the dependence of D₉₉ values on D₅₀ values of respective populations of jagged composite particles, illustrating trends among populations that have not undergone PSD optimization (so-called “broad” PSDs) and populations that have undergone PSD optimization (so-called “narrow” PSDs). Graphical plot 1804 shows the dependence of D₉₀ values on D₅₀ values of respective populations of jagged composite particles, illustrating trends among populations that have not undergone PSD optimization (so-called “broad” PSDs) and populations that have undergone PSD optimization (so-called “narrow” PSDs). Graphical plot 1806 shows the dependence of D₁₀ values on D₅₀ values of respective populations of jagged composite particles, illustrating trends among populations that have not undergone PSD optimization (so-called “broad” PSDs) and populations that have undergone PSD optimization (so-called “narrow” PSDs).

FIG. 19 shows graphical plots 1901 and 1902 showing the dependence of cycle life performance of Li-ion batteries made using respective example populations of jagged composite particles on the D₅₀ values of the respective example populations. Graphical plots 1901 and 1901 illustrate trends among populations that have not undergone PSD optimization (so-called “broad” PSDs) and populations that have undergone PSD optimization (so-called “narrow” PSDs). In the examples shown, the Li-ion batteries employed anodes comprising a mixture of the jagged composite particles and graphite particles (“active material mixtures”). Graphical plot 1901 shows cycle life performance of Li-ion batteries employing active material mixtures exhibiting a Li-ion capacity of about 600 mAh/g. Graphical plot 1902 shows cycle life performance of Li-ion batteries employing active material mixtures exhibiting a Li-ion capacity of about 1000 mAh/g.

FIG. 20 shows graphical plots of the PSDs of three populations of Si—C (nano)composite particles. Plots 2001, 2002, and 2003 are PSDs of Samples F, G, and H, respectively. The y-axis shows the volume fraction (in arbitrary units) and the x-axis shows the D₅₀ in μm.

FIG. 21 shows selected PSD characteristics (D₁₀, D₅₀, D₉₀, D₉₉, PSD span) and the BET-SSA of Samples F, G, and H of populations of Si—C (nano)composite particles.

FIG. 22 shows graphical plots of the capacity, the capacity retention (expressed as a percentage of the cycling-start capacity), and the estimated number of cycles to reach 80% of the cycling-start capacity (N80), as a function of cycle number, for lithium-ion batteries with anodes employing Samples F, G, and H of Si—C (nano)composite particles.

FIG. 23 (Table 7) lists estimated capacities (e.g., first-cycle lithiation capacities) of anode active materials that are mixtures of Si—C (nano)composite particles and graphite particles, for (1) respective mass fractions of the Si—C (nano)composite particles and (2) respective selected capacities (e.g., first-cycle lithiation capacities) of the Si—C (nano)composite particles.

FIG. 24 (Table 8) shows selected PSD characteristics (D₁₀, D₅₀, D₉₀, D₉₉, PSD span, right PSD span, left PSD span, extended PSD span, and extended right PSD span) of Samples F, G, and H of populations of Si—C (nano)composite particles.

FIG. 25 shows a graphical plot correlating Si mass fractions as estimated using an SEM-EDX method (shown on the vertical axis) to Si mass fractions estimated using a TGA method (shown on the horizontal axis) for several example populations of Si—C (nano)composite particles.

FIG. 26 shows a numerical fraction distribution as a function of Si mass fraction for respective populations (Samples A, B, C, and J) of Si—C (nano)composite particles. The Si mass fraction is estimated by the TGA method.

FIG. 27 shows a numerical fraction distribution as a function of Si mass fraction for respective populations (Samples J, K, and L) of Si—C (nano)composite particles. The Si mass fraction is estimated by the TGA method.

### DETAILED DESCRIPTION

Aspects of the present invention are disclosed in the following description and related drawings directed to specific embodiments of the invention. The term “embodiments of the invention” does not require that all embodiments of the invention include the discussed feature, advantage, process, or mode of operation, and alternate embodiments may be devised without departing from the scope of the invention. Additionally, well-known elements of the invention may not be described in detail or may be omitted so as not to obscure other, more relevant details.

Aspects of the present disclosure provide processes of making advanced carbon-containing composite particles for use in electrodes (e.g., anode electrodes or cathode electrodes) of Li-ion or Na-ion or K-ion rechargeable batteries, among other types of batteries, electrochemical capacitors and hybrid electrochemical energy storage devices.

Any numerical range described herein with respect to any embodiment of the present invention is intended not only to define the upper and lower bounds of the associated numerical range, but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a temperature range from about −120° C. to about −60° C. encompasses (in ° C.) a set of temperature ranges from about −120° C. to about −119° C., from about −119° C. to about −118° C., from about −61° C. to about −60° C., as if the intervening numbers (in ° C.) between −120° C. and −60° C. in incremental ranges were expressly disclosed. In yet another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range. In yet another example, a numerical range with upper and lower bounds defined at different levels of precision shall be interpreted in increments corresponding to the bound with the higher level of precision. For example, a numerical percentage range from 30.92% to 47.4% (i.e., levels of precision in units or increments of hundredths and tenths, respectively) encompasses (in %) a set of [30.92, 30.93, 30.94, . . . , 47.39, 47.40], as if 47.4% (tenths) was recited as 47.40% (hundredths) and as if the intervening numbers between 30.92 and 47.40 in units or increments of hundredths were expressly disclosed.

It will be appreciated that the level of precision of any particular measurement, threshold or other inexact parameter may vary based on various factors such as measurement instrumentation, environmental conditions, and so on. Below, reference to such measurements or thresholds may thereby be interpreted as a respective value assuming a pseudo-exact level of precision (e.g., a threshold of 80% comprises 80.0000 . . . %). Alternatively, reference to such measurements or thresholds may be described via a qualifier that captures pseudo-exact value(s) plus a range that extends above and/or below the pseudo-exact value(s). For example, the above-noted threshold of 80% may be interpreted as “about”, “approximately”, “around”, “˜” or “˜” 80%, which encompasses “exactly” 80% (e.g., 80.0000 . . . %) plus some range around 80%. In some designs, the range encompassed around a measurement or threshold via the “about”, “approximately”, “around” or “˜” qualifier may encompass the level of precision for which the respective measurement or threshold is capable of being measured by the most accurate commercially available instrumentation as of the priority date of the subject application.

In the following description, various material properties are described so as to characterize materials (e.g., binders, molecules, particles, powders, slurries, electrodes, separators, electrolytes, battery cells) in various states. Note that one of ordinary skill in the art is generally capable of selecting (and is herein assumed to select) the most appropriate measurement technique for any particular measurement. Moreover, in some cases, the most appropriate measurement technique may include a combination of techniques. While the following Table characterizes various measurement type options for particular material types and particular material properties, certain embodiments of the disclosure may be more specifically characterized in context with a specific measurement technique and/or specific commercially available instrumentation, if warranted. Note that while the Table below characterizes measurements with respect to active material particles, similar measurements may also be made with respect to other particle types, such as precursor particles (e.g., carbon particles). Hence, unless otherwise indicated, the following Table provides examples of how such material properties may be readily measured by one of ordinary skill in the art using commercially available instrumentation:

Table of Techniques and Instrumentation for Material Property Measurements

| Material | Property | Measurement | |
|---|---|---|---|
| Type | Type | Instrumentation | Measurement Technique |
| Active | Coulombic | Potentiostat | Charge (current) is passed to |
| Material | Efficiency | | an electrode containing the |
| | | | active material of interest |
| | | | until a given voltage limit is |
| | | | reached. Then, the current is |
| | | | reversed (discharge current) |
| | | | until a second voltage limit is |
| | | | reached. The ratio of the two |
| | | | charges passed determines |
| | | | the Coulombic Efficiency |
| | | | (CE). In the simplest case, |
| | | | the charge and discharge |
| | | | currents may be constant |
| | | | and often have absolute |
| | | | values that are the same or |
| | | | close to each other. It should |
| | | | be understood though that in |
| | | | some experiments, either |
| | | | charge current or discharge |
| | | | current or both may be |
| | | | changing during such |
| | | | experiments (e.g., be initially |
| | | | constant and when the |
| | | | voltage limit is reached, |
| | | | diminishing to a |
| | | | predetermined value). In |
| | | | addition, the absolute value |
| | | | of the charge and discharge |
| | | | currents may differ. |
| Active | Partial | Manometer | The partial vapor pressure |
| Material | Vapor | | of an active material in a |
| | Pressure | | mixture (e.g., composite |
| | (e.g., Torr.) | | particle) at a particular |
| | at a | | temperature is given by the |
| | Temperature | | known vapor pressure of the |
| | (e.g., K) | | active material multiplied by |
| | | | its mole fraction in the |
| | | | mixture. |
| Active | Volume | Gas pycnometer | Gas pycnometer measures |
| Material | | | the skeletal volume of a |
| Particle | | | material by gas displacement |
| | | | using the volume-pressure |
| | | | relationship of Boyle's Law. |
| | | | A sample of known mass is |
| | | | placed into the sample |
| | | | chamber and maintained at |
| | | | a constant temperature. An |
| | | | inert gas, typically helium, is |
| | | | used as the displacement |
| | | | medium. |
| | | | Note: A vol. % change may |
| | | | be calculated from two |
| | | | volume measurements of the |
| | | | active material particle. |
| Active | Open | nitrogen | Nitrogen sorption/desorption |
| Material | Internal | sorption/desorption | isotherm (typically at 77 K) is |
| Particle | Pore Volume | isotherm | collected and analyzed to |
| | (e.g., cc/g or | | estimate the total amount of |
| | cm³/g) | | gas adsorbed/desorbed and |
| | | | internal pore volume of the |
| | | | sample with known mass is |
| | | | estimated from such |
| | | | measurements. Pore size |
| | | | distribution (PSD) may be |
| | | | further estimated from the |
| | | | sorption/desorption isotherm |
| | | | using various analyses, such |
| | | | as Non-Local Density |
| | | | Functional Theory (NLDFT) |
| Active | Volume- | PSA, scanning | PSA using laser scattering, |
| Material | Average Pore | electron microscope | electron microscopy (SEM, |
| Particle | Size and Pore | (SEM), transmission | TEM, STEM) in |
| | Size | electron microscope | combination with image |
| | Distributions | (TEM), scanning | analyses, laser microscopy |
| | (e.g., nm) | transmission | (for larger particles and |
| | | microscope (STEM), | larger pores) in combination |
| | | laser microscope, | with image analyses, optical |
| | | Synchrotron X-ray, | microscopy (for larger |
| | | X-ray microscope | particles and larger pores), |
| | | | neutron scattering, X-ray |
| | | | scattering, X-ray microscopy |
| | | | imaging may be employed to |
| | | | measure pore sizes (average |
| | | | pore size or pore size |
| | | | distribution) in different size |
| | | | ranges (in addition to the |
| | | | analysis of the |
| | | | sorption/desorption |
| | | | isotherms). |
| Active | Closed | Gas pycnometer | Closed porosity may be |
| Material | Internal Pore | | measured by analyzing true |
| Particle | Volume (e.g., | | density values measured by |
| | cc/g or cm³/g) | | using an argon gas |
| | | | pycnometer (or a nitrogen |
| | | | gas pycnometer) and |
| | | | comparing them to the |
| | | | theoretical density of the |
| | | | individual material |
| | | | components present in Si- |
| | | | comprising particles. In |
| | | | addition, closed internal |
| | | | pore volume may be |
| | | | estimated by comparing the |
| | | | total pore volume estimated |
| | | | from neutron scattering and |
| | | | the nitrogen-accessible pore |
| | | | volume estimated from |
| | | | nitrogen sorption isotherms. |
| Active | Closed | Gas pycnometer | With a pycnometer, the |
| Material | Internal | | amount of a certain medium |
| Particle | Volume- | | (liquid or Helium or other |
| | Average Size | | analytical gases) displaced |
| | (e.g., nm) | | by a solid can be determined. |
| Active | Size | TEM, STEM, SEM, | Laser particle size |
| Material | (e.g., nm, | X-Ray, PSA, etc. | distribution analysis (LPSA), |
| Particle | μm) | | laser image analysis, electron |
| | | | microscopy, optical |
| | | | microscopy or other suitable |
| | | | techniques |
| | | | transmission electron |
| | | | microscopy (TEM), scanning |
| | | | transmission electron |
| | | | microscopy (STEM), |
| | | | scanning electron |
| | | | microscopy (SEM)), X-ray |
| | | | microscopy, X-ray |
| | | | diffraction, neutron |
| | | | scattering and other suitable |
| | | | techniques |
| Active | Composition | Balance | Note #1: A wt. % change |
| Material | (e.g., mass | | may be calculated by |
| Particle | fraction or | | comparing the mass fraction |
| | wt. %, mg, | | of a material in the particle |
| | number of | | relative to the total particle |
| | atoms) | | mass. |
| | | | Note #2: The capacity |
| | | | attributable to particular |
| | | | active material(s) in the |
| | | | particle may be derived from |
| | | | the composition, based on |
| | | | the known (e.g., theoretical |
| | | | or practically attainable) |
| | | | capacity(ies) of each active |
| | | | material. |
| | | | Note #3: The composition of |
| | | | the particle may be |
| | | | characterized in terms of |
| | | | weight (e.g., mg). The |
| | | | composition may |
| | | | alternatively be |
| | | | characterized by a number |
| | | | of atoms of a particular |
| | | | element (e.g., Si, C). In case |
| | | | of atoms, the number of |
| | | | atoms may be estimated |
| | | | from the weight of that atom |
| | | | in the particle (e.g., based on |
| | | | gas chromatography) |
| Active | Composition | X-ray Fluorescence | |
| Material | (e.g., mass | (XRF), Inductively | |
| Particle | fraction or | Coupled Plasma | |
| | wt. % of | Optical Emission | |
| | various | Spectroscopy (ICP- | |
| | atomic | OES); Energy | |
| | elements or | Dispersive X-ray | |
| | molecules, | Spectroscopy (EDX), | |
| | atomic | Wavelength | |
| | fraction or | Dispersive | |
| | at. % of | Spectroscopy | |
| | various | (WDS), Electron | |
| | elements) | Energy Loss | |
| | | Spectroscopy | |
| | | (EELS), Nuclear | |
| | | Magnetic Resonance | |
| | | (NMR); Secondary | |
| | | Ion Mass | |
| | | Spectrometry | |
| | | (SIMS); X-Ray | |
| | | Photoelectron | |
| | | Spectroscopy (XPS); | |
| | | Fourier Transform | |
| | | Infrared | |
| | | Spectroscopy (FTIR) | |
| | | and Raman | |
| | | Spectroscopy | |
| | | (Raman) | |
| Active | Specific | Potentiostat | An electrode containing an |
| Material | Capacity | | active anode or cathode |
| Particle, | | | material of interest is |
| Battery | | | charged or discharged (by |
| Half-Cell | | | passing electrical current to |
| | | | the electrode) within certain |
| | | | potential limits using an |
| | | | electrochemical cell with a |
| | | | suitable reference electrode, |
| | | | typically lithium metal. The |
| | | | total charge passed (e.g., in |
| | | | mAh) divided by the active |
| | | | material mass (e.g., in g) |
| | | | gives this quantity (e.g., in |
| | | | mAh/g). The active mass is |
| | | | computed by multiplying the |
| | | | total mass of the electrode by |
| | | | the active material mass |
| | | | fraction. Both reversible and |
| | | | irreversible capacity during |
| | | | charge or discharge may be |
| | | | calculated in this way. |
| Active | BET-SSA | BET instrument | A sample is placed into a |
| Material | (Brunauer- | | sealed chamber at 77 K, |
| Particle | Emmett- | | where nitrogen is introduced |
| | Teller | | at increasing pressure. The |
| | specific | | change in pressure of the |
| | surface area) | | nitrogen is used to calculate |
| | (e.g., m²/g) | | the surface area of the |
| | | | sample. |
| Active | Aspect Ratio | SEM, TEM | The dimensions and shape of |
| Material | | | the particles are typically |
| Particle | | | measured by using SEM or |
| | | | TEM or (for large particles) |
| | | | by using optical microscopy. |
| Active | True Density | Argon Gas | True density values may be |
| Material | of Particle | Pycnometer or | measured by using an argon |
| Particle | (e.g., g/cc or | nitrogen gas | gas pycnometer (or a |
| | g/cm³) | pycnometer | nitrogen gas pycnometer) |
| | | | and comparing to the |
| | | | theoretical density of the |
| | | | individual material |
| | | | components present in the |
| | | | particle. |
| Active | Particle Size | Dynamic light | laser particle size |
| Material | Distribution | scattering particle | distribution analysis (LPSA) |
| Particle | (e.g., nm or | size analyzer, | on well-dispersed particle |
| Population | μm) | scanning electron | suspensions in one example |
| | | microscope | or by image analysis of |
| | | | electron microscopy images, |
| | | | or by other suitable |
| | | | techniques. While there are |
| | | | diverse processes of |
| | | | measuring PSDs, laser |
| | | | particle size distribution |
| | | | analysis (LPSA) is quite |
| | | | efficient for some |
| | | | applications. Note that other |
| | | | types of particle size |
| | | | distribution (e.g., by SEM |
| | | | image analysis) could also be |
| | | | utilized (and may even lead |
| | | | to more precise |
| | | | measurements, in some |
| | | | experiments). Using LPSA, |
| | | | particle size parameters of a |
| | | | population's PSD may be |
| | | | measured, such as: a tenth- |
| | | | percentile volume-weighted |
| | | | particle size parameter (e.g., |
| | | | abbreviated as D₁₀), a |
| | | | fiftieth-percentile volume- |
| | | | weighted particle size |
| | | | parameter (e.g., abbreviated |
| | | | as D₅₀), a ninetieth-percentile |
| | | | volume-weighted particle |
| | | | size parameter (e.g., |
| | | | abbreviated as D₉₀), and a |
| | | | ninety-ninth-percentile |
| | | | volume-weighted particle |
| | | | size parameter (e.g., |
| | | | abbreviated as D₉₉). |
| Active | Width (e.g., | PSA | Parameters relating to |
| Material | nm) | | characteristic widths of the |
| Particle | | | PSD may be derived from |
| Population | | | these particle size |
| | | | parameters, such as D₅₀ − |
| | | | D₁₀ (sometimes referred to |
| | | | herein as a left width), D₉₀ − |
| | | | D₅₀ (sometimes referred to |
| | | | herein as a right width), and |
| | | | D₉₀ − D₁₀ (sometimes |
| | | | referred to herein as a full |
| | | | width). |
| Active | Cumulative | Computed via LPSA | A cumulative volume |
| Material | Volume | data | fraction, defined as a |
| Particle | Fraction | | cumulative volume of the |
| Population | | | composite particles with |
| | | | particle sizes of a threshold |
| | | | particle size or less, divided |
| | | | by a total volume of all of the |
| | | | composite particles, may be |
| | | | estimated by LPSA. |
| Active | Composition | Balance | The mass of active materials |
| Material | (e.g., wt. %) | | added to the electrode |
| Particle | | | divided by the total mass of |
| Population | | | the electrode. |
| Active | BET-SSA | BET Isotherm | obtained from the data of |
| Material | (e.g., m²/g) | | nitrogen sorption-desorption |
| Particle | | | at cryogenic temperatures, |
| Population | | | such as about 77 K |
| Electrolyte | Salt | balance, volumetric | Total volume of the solution |
| | Concentration | pipette | is computed either via the |
| | (e.g., M or | | sum of the volume of the |
| | mol. %) | | constituents (measured by a |
| | | | volumetric pipette), or by |
| | | | the mass of the constituents |
| | | | divided by the density. The |
| | | | molar mass of the salt is then |
| | | | used to calculate the total |
| | | | number of moles of salt in |
| | | | the solution. The moles of |
| | | | salt is then divided by the |
| | | | total volume to obtain the |
| | | | solvent concentration in M |
| | | | (mol/L). |
| Electrolyte | Solvent | balance, volumetric | Total volume of the solution |
| | Concentration | pipette | is computed either via the |
| | (e.g., M or | | sum of the volume of the |
| | mol. %) | | constituents (measured by a |
| | | | volumetric pipette), or by |
| | | | the mass of the constituents |
| | | | divided by the density. The |
| | | | molar volume of each solvent |
| | | | is then used to calculate the |
| | | | total number of moles of |
| | | | solvent in the solution. The |
| | | | moles of solvent is then |
| | | | divided by the total volume |
| | | | to obtain the solvent |
| | | | concentration in M (mol/L). |
| Electrode | Composition | Balance | The mass fraction of a |
| | (e.g., mass | | material (e.g., active |
| | fraction or | | material, active material |
| | wt. %) | | particle, binder) in the |
| | | | electrode is calculated based |
| | | | on a measured or estimated |
| | | | mass of the material and a |
| | | | measured or estimated mass |
| | | | of the electrode, excluding |
| | | | the electrode current |
| | | | collector. |
| | | | Note: The mass of individual |
| | | | components (e.g., composite |
| | | | active material particles, |
| | | | graphite particles, binder, |
| | | | function additive(s)) of the |
| | | | battery electrode |
| | | | composition may be |
| | | | measured before being |
| | | | mixed into a slurry to |
| | | | estimate their mass in a |
| | | | casted electrode. The mass of |
| | | | materials deposited onto the |
| | | | casted electrode may be |
| | | | measured by comparing the |
| | | | weight of the casted |
| | | | electrode before/after the |
| | | | material deposition. |
| Electrode | Areal Binder | balance | A mass fraction of the |
| | Loading (e.g., | | binder in the battery |
| | mg/m²) | | electrode, divided by a |
| | | | product of (1) a mass |
| | | | fraction of the active |
| | | | material (e.g., Si—C |
| | | | nanocomposite) particles in |
| | | | the battery electrode, and (2) |
| | | | a Brunauer-Emmett-Teller |
| | | | (BET) specific surface area |
| | | | of the active material |
| | | | particle population. |
| Electrode | Capacity | Calculated | Measure the mass (wt.) of |
| | Attributable | | active material in the |
| | to Active | | electrode, and calculate |
| | Material | | electrode capacity based on |
| | (active | | the known theoretical |
| | material | | capacity of the active |
| | capacity | | material. For example, the |
| | fraction) | | average wt. % of active |
| | | | material in each active |
| | | | material particle may be |
| | | | measured and used to |
| | | | calculate the mass of the |
| | | | active material based on the |
| | | | mass of the active material |
| | | | particles before being mixed |
| | | | in the slurry. This process |
| | | | may be repeated if the |
| | | | electrode includes two or |
| | | | more active materials to |
| | | | calculate the relative |
| | | | capacity attribution for each |
| | | | active material in the |
| | | | electrode. |
| Electrode | Capacity | Potentiostat and | Determine the average |
| | Attributable | balance | specific capacity (mAh/g) of |
| | to Active | | active material particles. For |
| | Material | | example, the average specific |
| | Particles | | capacity may be estimated |
| | (active | | from the average wt. % of |
| | material | | active material(s) in each |
| | particle | | particle and its associated |
| | capacity | | known theoretical |
| | fraction) | | capacity(ies). Then, measure |
| | | | the mass (wt.) of active |
| | | | material particles in the |
| | | | electrode before being mixed |
| | | | in slurry, which may be used |
| | | | to calculate the capacity |
| | | | attributable to that active |
| | | | material. This process may |
| | | | be repeated if the electrode |
| | | | includes two or more active |
| | | | material particle types to |
| | | | calculate the relative |
| | | | capacity attribution for each |
| | | | active material particle type |
| | | | in the electrode. |
| Electrode | Mass of | balance | The average wt. % of active |
| | Active | | material in each active |
| | Material in | | material particle may be |
| | Electrode | | measured, and used to |
| | | | calculate the mass of the |
| | | | active material based on the |
| | | | mass of the active material |
| | | | particles before being mixed |
| | | | in slurry. |
| Electrode | Mass of | balance | Measure the active material |
| | Active | | particle before the active |
| | Material | | material particle type is |
| | Particle in | | mixed in the slurry. |
| | Electrode | | |
| Electrode | Areal | Potentiostat and | Areal capacity loading is the |
| | Capacity | balance | weight of the coated active |
| | Loading (e.g., | | material per unit area |
| | mAh/cm²) | | (g/cm²) multiplied by the |
| | | | gravimetric capacity of the |
| | | | active material (not the |
| | | | electrode, but the active |
| | | | material itself with zero |
| | | | binder and zero electrolyte; |
| | | | mAh/g). |
| Electrode | Coulombic | Potentiostat | The change in charge |
| | Efficiency | | inserted (or extracted) to an |
| | | | electrode divided by the |
| | | | charge extracted (or |
| | | | inserted) from the electrode |
| | | | during a complete |
| | | | electrochemical cycle within |
| | | | given voltage limits. Because |
| | | | the direction of charge flow |
| | | | is opposite for cathodes and |
| | | | anodes, the definition is |
| | | | dependent on the electrode. |
| | | | Coulombic Efficiency is |
| | | | measured for both materials |
| | | | by constructing a so-called |
| | | | half-cell, which is an |
| | | | electrochemical cell |
| | | | consisting of a cathode or |
| | | | anode material of interest as |
| | | | the working electrode and a |
| | | | lithium metal foil which |
| | | | functions as both the counter |
| | | | and reference electrode. |
| | | | Then, charge is either |
| | | | inserted or removed from |
| | | | the material of interest until |
| | | | the cell voltage reaches an |
| | | | appropriate limit. Then, the |
| | | | process is reversed until a |
| | | | second voltage limit is |
| | | | reached, and the charge |
| | | | passed in both steps is used |
| | | | to calculate the Coulombic |
| | | | Efficiency, as described |
| | | | above. |
| Battery Cell | Rate | Potentiostat | This is the time it takes to |
| | Performance | | charge or discharge a |
| | | | battery between a given state |
| | | | of charge. It is measured by |
| | | | charging or discharging a |
| | | | battery and measuring the |
| | | | time until a specified amount |
| | | | of charge is passed, or until |
| | | | the battery operating voltage |
| | | | reaches a specified value. |
| Battery Cell | Cell | Potentiostat | A battery consisting of a |
| | Discharge | | relevant anode and cathode |
| | Voltage (e.g., | | is charged and discharged |
| | V) | | within certain voltage limits |
| | | | and the charge-weighted cell |
| | | | voltage during discharge is |
| | | | computed. |
| Battery Cell | Operating | Potentiostat and | Average temperature of |
| | Temperature | thermocouples | battery cell as measured at |
| | | | the positive/negative |
| | | | terminal/cell shaft/etc. |
| | | | while charging/discharging, |
| | | | or at a certain voltage level, |
| | | | or while a load is applied |
| Battery | Anode | Potentiostat | An electrode containing an |
| Half-Cell | Discharge | | active anode material (or a |
| | (de- | | mixture of active materials) |
| | lithiation) | | of interest is charged and |
| | Potential | | discharged (by passing |
| | (e.g., V) | | electrical current to the |
| | | | electrode) within certain |
| | | | potential limits using an |
| | | | electrochemical cell with a |
| | | | suitable reference electrode, |
| | | | typically lithium metal. The |
| | | | charge-averaged cell |
| | | | potential upon discharge |
| | | | (corresponding to de- |
| | | | lithiation of the anode) is |
| | | | computed. |
| Battery | Cathode | Potentiostat | An electrode containing an |
| Half-Cell | Discharge | | active cathode material (or a |
| | (lithiation) | | mixture of active materials) |
| | Potential | | of interest is charged and |
| | (e.g., V) | | discharged (by passing |
| | | | electrical current to the |
| | | | electrode) within certain |
| | | | potential limits using an |
| | | | electrochemical cell with a |
| | | | suitable reference electrode, |
| | | | typically lithium metal. The |
| | | | charge-averaged cell |
| | | | potential upon discharge |
| | | | (corresponding to lithiation |
| | | | of the cathode) is computed. |
| Battery Cell | Volumetric | Potentiostat | The VED is calculated by |
| | Energy | | first calculating the energy |
| | Density | | per unit area of the battery, |
| | (VED) | | and then dividing the energy |
| | | | per unit area by the sum of |
| | | | the illustrative anode, |
| | | | cathode, separator, and |
| | | | current collector thicknesses |
| Battery Cell | Internal | Potentiostat | The internal resistance (also |
| | Resistance | | known as impedance in |
| | (impedance) | | many contexts) is measured |
| | | | by applying small pulses of |
| | | | current to the battery cell |
| | | | and recording the |
| | | | instantaneous change in cell |
| | | | voltage. |

In certain aspects, the disclosure relates to batteries. While the description below may describe certain examples in the context of Li metal and Li-ion batteries (for brevity and convenience, and because of the current popularity of Li technology), it will be appreciated that various aspects may be applicable to other rechargeable and primary batteries (such as Na and Na-ion, Mg and Mg-ion, K and K-ion, Ca and Ca-ion, and other metal and metal-ion batteries, dual ion batteries, alkaline or alkaline ion batteries, flow batteries) as well as electrochemical capacitors and hybrid energy storage devices.

While the description below may describe certain examples in the context of composites comprising specific (e.g., alloying-type or conversion-type) active anode materials (such as Si, among others) or specific (e.g., intercalation-type or conversion-type) active cathode materials, it will be appreciated that various aspects may be applicable to many other types and chemistries of conversion-type anode and cathode active materials, intercalation-type anode and cathode active materials, pseudocapacitive anode and cathode active materials, and materials that may exhibit mixed electrochemical energy storage mechanisms.

While the description below may also describe certain examples of the material formulations in a Li-free state (for example, as in silicon-comprising nanocomposite anodes or metal fluoride cathodes or sulfur cathodes), it will be appreciated that various aspects may be applicable to Li-comprising electrodes and active materials (for example, partially or fully lithiated Si-comprising anodes or partially or fully lithiated Si-comprising anode particles, partially or fully lithiated metal fluoride comprising cathodes (such as a mixture of LiF and metals such as Cu, Fe, Ni, Bi, Zr, Ti, Mg, Nb, and various other metals and metal alloys and mixtures of such and/or other metals) or partially or fully lithiated metal halide comprising cathode particles, partially or fully lithiated chalcogenides (such as Li₂S, Li₂S/metal mixtures, Li₂Se, Li₂Se/metal mixtures, Li₂S—Li₂Se mixtures, various other compositions comprising lithiated chalcogenides etc.), partially or fully lithiated metal oxides (such as Li₂O, Li₂O/metal mixtures), partially or fully lithiated intercalation-type cathode materials, partially or fully lithiated carbons, among others). In some designs, various material properties (e.g., at particle level, at inter-particle level, at electrode level) may change based on whether active material particle(s) are in a Li-free state, a partially lithiated state, or a fully lithiated state. Such Li-dependent material properties may include particle pore volume, electrode pore volume, and so on. Unless stated or implied otherwise, reference to such Li-dependent anode material properties (e.g., at particle level, at inter-particle level, at electrode level) may be assumed to be provided as if the active material particles are in the Li-free state. Further, some examples below are characterized at the electrode level (e.g., as opposed to particle level or interparticle level or cell level). Below, unless stated or implied otherwise, reference to such electrode level properties (e.g., electrode porosity or areal capacity loading or gravimetric/volumetric capacity) may be assumed to refer to the electrode components (e.g., active material particles, binder, conductive additives), excluding the current collector.

While the description below may describe certain examples in the context of some specific alloying-type, conversion-type and intercalation-type chemistries for anode active materials and conversion-type and intercalation-type chemistries for cathode active materials for Li-ion batteries (such as silicon-comprising anodes or metal fluoride-comprising or lithium sulfide-comprising cathodes), it will be appreciated that various aspects may be applicable to other chemistries for Li-ion batteries (other conversion-type and alloying-type electrodes as well as various intercalation-type anodes and cathodes) as well as to other battery chemistries. In the case of metal-ion batteries (such as Li-ion batteries), examples of other suitable conversion-type electrodes include metal fluorides, metal oxyfluorides, metal chlorides, metal iodides, metal bromides, sulfur, metal sulfides (including lithium sulfide), selenium, metal selenide (including lithium sulfide), metal oxides, metal nitrides, metal phosphides, metal hydrides, their various mixtures, composites (including nanocomposites) and alloys and others.

During battery (such as a Li-ion battery) operation, conversion materials change (convert) from one crystal structure to another (hence the name “conversion”-type), where a material structure and composition may chemically and structurally change to one or multiple structures. This process is also accompanied by breaking chemical bonds and forming new ones. During battery (e.g., Li-ion battery) operation, Li ions are inserted into alloying-type materials forming lithium alloys (hence the name “alloying”-type). Sometimes, “alloying”-type electrode materials are considered to be a subclass of “conversion”-type electrode materials.

While the description below may describe certain examples in the context of Si—C composite (e.g., nanocomposite) anode active materials (e.g., nanocomposite particles which comprise silicon (Si) and carbon (C) and may comprise other elements, such as nitrogen (N), phosphorus (P), boron (B), oxygen (O), hydrogen (H), sulfur(S), fluorine (F), to name a few and where a total mass of the Si and the C atoms may contribute from about 75 wt. % to about 100 wt. % of the total mass of the composite particles), it will be appreciated that various aspects may be applicable to other types of the high-capacity silicon-comprising anode active materials (including for example, various silicon-comprising or silicon oxide-comprising or silicon nitride-comprising or silicon oxy-nitride-comprising or silicon phosphide-comprising particles or particles comprising a mixture or alloy or other combinations of such active materials, various other types of Si-comprising composites including core-shell or hierarchical or nanocomposite particles).

An aspect is directed to a battery anode and/or a battery anode precursor composition comprising a population of Si-comprising particles (e.g., nanocomposite particles, among others), in which some or all of the Si-comprising particles comprise silicon (Si) and carbon (C) elements and may comprise other elements, such as nitrogen (N), phosphorus (P), boron (B), oxygen (O), hydrogen (H), sulfur(S), fluorine (F), to name a few. In some embodiments, the total mass of the Si and the C (on average) in the Si-comprising particles may contribute from about 75 wt. % to about 100 wt. % of the total mass of the Si-comprising particles. Such composite particles are sometimes referred to herein as Si—C composite particles (or nanocomposite particles, if Si and/or C are nanostructures, for example). Herein, the wording “Si—C (nano)composite particles” is used to refer to Si—C composite particles including Si—C nanocomposite particles.

In some embodiments, the total mass of O may contribute (on average) from about 0 wt. % to about 10 wt. % of the total mass of the Si-comprising particles (e.g., about 0-1 wt. %; about 1-2.5 wt. %; about 2.5-5 wt. %; about 5-10 wt. %). In some embodiments, the total mass of N may contribute (on average) from about 0 wt. % to about 10 wt. % of the total mass of the Si-comprising particles (e.g., about 0-0.1 wt. %; about 0.1-2 wt. %; about 2-5 wt. %; about 5-10 wt. %). In some embodiments, the total mass of P may contribute (on average) from about 0 wt. % to about 10 wt. % of the total mass of the Si-comprising particles (e.g., about 0-0.1 wt. %; about 0.1-1 wt. %; about 1-5 wt. %; about 5-10 wt. %). In some embodiments, the total mass of B may contribute (on average) from about 0 wt. % to about 5 wt. % of the total mass of the Si-comprising particles (e.g., about 0-0.1 wt. %; about 0.1-2.5 wt. %; about 2.5-5 wt. %). In some embodiments, the total mass of H may contribute (on average) from about 0 wt. % to about 2 wt. % of the total mass of the Si-comprising particles (e.g., about 0-0.5 wt. %; about 0.5-1 wt. %; about 1-2 wt. %). In some embodiments, the total mass of S may contribute (on average) from about 0 wt. % to about 2.5 wt. % of the total mass of the Si-comprising particles (e.g., about 0-0.1 wt. %; about 0.1-0.5 wt. %; about 0.5-2.5 wt. %). In some embodiments, the total mass of F may contribute (on average) from about 0 wt. % to about 2.5 wt. % of the total mass of the Si-comprising particles (e.g., about 0-0.1 wt. %; about 0.1-0.5 wt. %; about 0.5-2.5 wt. %).

In some embodiments, a total atomic fraction of the Si and the C may contribute from about 75 at. % or about 80 at. % to about 100 at. % of the overall composite particles. Such composite particles are sometimes referred to herein as Si—C composite particles. In some embodiments, such composite particles comprise nano-sized or nanostructured elements (e.g., nano-sized or nanostructured Si, Si nanoparticles, nanoporous Si nanoparticles, nano-sized, nanoporous or nanostructured C, or both), which may be referred to as nanocomposite particles. In some implementations, the Si or Si-comprising active material present in such nanocomposites may be in the form of nanoparticles. In some implementations, the mass-average size of Si or Si-comprising material nanoparticles (e.g., silicon nanoparticles or nanocrystals) may range from about 1 nm to about 200 nm (e.g., about 1.0-10.0 nm; about 10.0-30.0 nm; about 30.0-100.0 nm; about 100.0-200.0 nm), as measured using image analysis of electron microscopy (e.g., transmission electron microscopy (TEM), scanning transmission electron microscopy (STEM), scanning electron microscopy (SEM)), X-ray microscopy, X-ray diffraction, neutron scattering and/or other suitable techniques. In some designs, Si or Si-comprising material nanoparticles (e.g., silicon nanoparticles) may be doped (e.g., in some designs with Group V or Group III elements, such as N, P, B; or, in other designs, with Group IV elements, such as C; or their various combinations). The degree of doping may range from about 10 ppm to about 50,000 ppm (e.g., about 10-100 ppm; about 100-1000 ppm; about 1000-10,000 ppm; about 10,000-50,000 ppm), in some designs. X-ray diffraction may be particularly convenient and easy for identifying the average size of Si nanocrystals. Too small (e.g., smaller than about 1.0 nm or about 2.0 nm) Si nanocrystals may exhibit too high reactivity during synthesis and become less active or induce too high first cycle capacity losses, while too large (e.g., larger than about 200 nm or about 100 nm) Si crystals may reduce cycle stability of such Si—C composites (nanocomposites) or, broadly, nanocomposite silicon. As used here, a “nano”-material (e.g., nanostructure or nanoparticle or nanocomposite) may refer to any material that exhibits at least one dimension that is less than about 200 nm.

An aspect is directed to a battery anode and/or a battery anode precursor composition comprising a population of Si-comprising composite particles (e.g., nanocomposite particles, among others), in which each of the Si-comprising composite particles comprises Si and C, and the Si-comprising composite particles have certain characteristics. In some embodiments, a mass fraction of the silicon in the Si-comprising composite particles is in a range of about 3 wt. % to about 80 wt. % (e.g., about 3-20 wt. %; about 20-35 wt. %; about 35-50 wt. %; about 50-80 wt. %; about 50-60 wt. %; about 60-70 wt. %; about 70-80 wt. %; about 20-80 wt. %; about 35-60 wt. %). In some embodiments, a Brunauer-Emmett-Teller specific surface area (BET-SSA) of the Si-comprising composite particles (e.g., nanocomposite particles, among others) is in a range of about 0.5 m²/g to about 150 m²/g (e.g., about 0.5-3 m²/g; about 3-12 m²/g; about 12-18 m²/g; about 18-30 m²/g; about 30-50 m²/g; about 50-150 m²/g). In some embodiments, about 90% or more of the Si-comprising composite particles (e.g., nanocomposite particles, among others) in the population are characterized by aspect ratios of about 2.3 or less, or aspect ratios of about 2.1 or less. In some embodiments, about 50% or more of the composite particles in the population are characterized by aspect ratios of about 1.25 or more, or aspect ratios of about 1.35 or more.

An aspect is directed to a battery electrode and/or a battery electrode precursor composition comprising a population of Si-comprising active material particles (e.g., nanocomposite particles, among others), in which the particle population of may be characterized by a particle size distribution (PSD) as determined by laser particle size distribution analysis (LPSA), image analysis of electron microscopy images, or other suitable techniques. The particle size distribution (PSD) that characterizes a particle population may be determined by laser particle size distribution analysis (LPSA) on well-dispersed particle suspensions in one example. Note that other types of particle size distribution (e.g., by SEM image analysis) could also be utilized (and may even lead to more precise measurements, in some experiments). While there are diverse processes of measuring PSDs, laser particle size distribution analysis (LPSA) is quite efficient for some applications. Using LPSA, particle size parameters of a population's PSD can be measured, such as: a tenth-percentile volume-weighted particle size parameter (abbreviated as D₁₀), a fiftieth-percentile volume-weighted particle size parameter (D₅₀), a ninetieth-percentile volume-weighted particle size parameter (D₉₀), and a ninety-ninth-percentile volume-weighted particle size parameter (D₉₉). Generally, an n^{th} percentile volume-weighted particle size parameter is abbreviated as Dn. Additionally, parameters relating to characteristic widths of the PSD may be derived from these particle size parameters, such as D₅₀-D₁₀ (sometimes referred to herein as a left width), D₉₀-D₅₀ (right width), D₉₀-D₁₀ (full width), (D₉₀-D₁₀)/D₅₀ (PSD span or just span), (D₅₀-D₁₀)/D₅₀ (left PSD span), (D₉₀-D₅₀)/D₅₀ (right PSD span), (D₉₉-D₁₀)/D₅₀ (sometimes extended PSD span), and (D₉₉-D₅₀)/D₅₀ (extended right PSD span). A cumulative volume fraction, defined as a cumulative volume of the composite particles with particle sizes of a threshold particle size or less, divided by a total volume of all of the composite particles, may be estimated by LPSA. In some embodiments, a fiftieth-percentile volume-weighted particle size parameter (D₅₀) of the PSD of Si-comprising active material particles may advantageously be in a range of about 0.5 μm to about 25.0 μm (e.g., about 0.5-4.0 μm, about 4.0-6.0 μm, about 6.0-8.0 μm, about 8.0-16.0 μm, about 16.0-25.0 μm). A cumulative volume fraction, defined as a cumulative volume of the composite particles with particle sizes of a threshold particle size or less, divided by a total volume of all of the composite particles, may be estimated by LPSA. In some embodiments (e.g., when the D₅₀ is in a range from about 0.5 μm to about 4.0 μm), the cumulative volume fraction, with the threshold particle size at about 5 μm, may advantageously be about 99 vol. % or less, or about 95 vol. % or less, or about 90 vol. % or less, or about 85 vol. % or less, or about 80 vol. % or less. In other embodiments (e.g., when the D₅₀ is in a range from about 4.0 μm to about 6.0 μm), the cumulative volume fraction, with the threshold particle size at about 7 μm, may advantageously be about 99 vol. % or less, or about 95 vol. % or less, or about 90 vol. % or less, or about 85 vol. % or less, or about 80 vol. % or less. In other embodiments (e.g., when the D₅₀ is in a range from about 6.0 μm to about 8.0 μm), the cumulative volume fraction, with the threshold particle size at about 10 μm, may advantageously be about 99 vol. % or less, or about 95 vol. % or less, or about 90 vol. % or less, or about 85 vol. % or less, or about 80 vol. % or less. In other embodiments (e.g., when the D₅₀ is in a range from about 8.0 μm to about 16.0 μm), the cumulative volume fraction, with the threshold particle size at about 20 μm, may advantageously be about 99 vol. % or less, or about 95 vol. % or less, or about 90 vol. % or less, or about 85 vol. % or less, or about 80 vol. % or less. In yet other embodiments (e.g., when the D₅₀ is in a range from about 16.0 μm to about 25.0 μm), the cumulative volume fraction, with the threshold particle size at about 30 μm, may advantageously be about 99 vol. % or less, or about 95 vol. % or less, or about 90 vol. % or less, or about 85 vol. % or less, or about 80 vol. % or less. In some embodiments, D₅₀ in a range from about 7.0 μm to about 13.0 μm may be particularly advantageous. In such embodiments, the cumulative volume fraction, with the threshold particle size at about 20 μm, may advantageously be about 99 vol. % or less, or about 95 vol. % or less, or about 90 vol. % or less, or about 85 vol. % or less, or about 80 vol. % or less.

Note that in some designs the presence of excessively large Si-comprising active material particles (e.g., in the form of nanocomposite particles, among others) may reduce cell performance characteristics (e.g., reduce cell stability, increase its impedance, reduce rate performance, reduce packing density, reduce electrode smoothness or uniformity, reduce electrode mechanical properties, reduce volumetric capacity, increase (e.g., localized) volume expansion). In some embodiments (e.g., when the D₅₀ is in a range from about 0.5 μm to about 4.0 μm), the cumulative volume fraction, with the threshold particle size at about 10 μm, may advantageously be about 80 vol. % or more, or about 85 vol. % or more, or (in some designs) even about 90 vol. % or more. In some embodiments (e.g., when the D₅₀ is in a range from about 0.5 μm to about 4.0 μm), the cumulative volume fraction, with the threshold particle size at about 12 μm, may advantageously be about 90 vol. % or more, or about 95 vol. % or more, or (in some designs) even about 98 vol. % or more. In other embodiments (e.g., when the D₅₀ is in a range from about 4.0 μm to about 6.0 μm), the cumulative volume fraction, with the threshold particle size at about 15 μm, may advantageously be about 80 vol. % or more, or about 85 vol. % or more, or (in some designs) even about 90 vol. % or more. In other embodiments (e.g., when the D₅₀ is in a range from about 4.0 μm to about 6.0 μm), the cumulative volume fraction, with the threshold particle size at about 25 μm, may advantageously be about 90 vol. % or more, or about 95 vol. % or more, or (in some designs) even about 98 vol. % or more. In other embodiments (e.g., when the D₅₀ is in a range from about 6.0 μm to about 8.0 μm), the cumulative volume fraction, with the threshold particle size at about 18 μm, may advantageously be about 80 vol. % or more, or about 85 vol. % or more, or (in some designs) even about 90 vol. % or more. In other embodiments (e.g., when the D₅₀ is in a range from about 6.0 μm to about 8.0 μm or from about 8.0 μm to about 12.0 μm), the cumulative volume fraction, with the threshold particle size at about 22 μm or about 25 μm, may advantageously be about 80 vol. % or more, or about 85 vol. % or more about 90 vol. % or more, or about 95 vol. % or more, or (in some designs) even about 98 vol. % or more. In other embodiments (e.g., when the D₅₀ is in a range from about 8.0 μm to about 16.0 μm or from about 12.0 μm to about 16.0 μm), the cumulative volume fraction, with the threshold particle size at about 30 μm or about 40 μm, may advantageously be about 80 vol. % or more, or about 85 vol. % or more, or (in some designs) even about 90 vol. % or more. In other embodiments (e.g., when the D₅₀ is in a range from about 8.0 μm to about 16.0 μm), the cumulative volume fraction, with the threshold particle size at about 50 μm, may advantageously be about 90 vol. % or more, or about 95 vol. % or more, or (in some designs) even about 98 vol. % or more. In other embodiments (e.g., when the D₅₀ is in a range from about 7.0 μm to about 13.0 μm), the cumulative volume fraction, with the threshold particle size at about 30 μm, may advantageously be about 90 vol. % or more, or about 95 vol. % or more, or (in some designs) even about 98 vol. % or more. In other embodiments (e.g., when the D₅₀ is in a range from about 7.0 μm to about 13.0 μm), the cumulative volume fraction, with the threshold particle size at about 40 μm, may advantageously be about 90 vol. % or more, or about 95 vol. % or more, or (in some designs) even about 98 vol. % or more.

In one or more embodiments of the present disclosure, Si-comprising active material particles (e.g., Si-comprising active material composite particles) may exhibit true density (e.g., as measured by using nitrogen gas pycnometer, hence in this case sometimes referred to as pycnometer-measured density or pycnometer density or pyc density) in the range from about 1.1 g/cc to about 2.8 g/cc (e.g., about 1.1-1.5 g/cc; about 1.5-1.8 g/cc; about 1.8-2.1 g/cc; about 2.1-2.4 g/cc; about 2.4-2.8 g/cc).

In one or more embodiments of the present disclosure, Si-comprising active material particles (e.g., Si-comprising active material composite particles) may comprise internal pores. In some designs, the open (e.g., to nitrogen gas at 77K) pore volume (e.g., as measured by nitrogen sorption/desorption isotherm measurement technique and including the pores in the range from about 0.4 nm to about 100 nm) may range from about 0.00 cc/g to about 0.50 cc/g (assuming theoretical density of the individual material components present in Si-comprising active material particles)—e.g., about 0.00-0.10 cc/g; about 0.10-0.20 cc/g; about 0.20-0.30 cc/g; about 0.30-0.40 cc/g; or about 0.40-0.50 cc/g. In some designs, the closed (e.g., to nitrogen gas at 77K) pore volume (e.g., measured by analyzing true density values measured by using an argon gas pycnometer and comparing to the theoretical density of the individual material components present in Si-comprising active material particles) may range from about 0.00 cc/g to about 1.00 cc/g—e.g., about 0.00-0.10 cc/g; about 0.10-0.20 cc/g; about 0.20-0.30 cc/g; about 0.30-0.40 cc/g; about 0.40-0.50 cc/g; about 0.50-0.60 cc/g; about 0.60-0.70 cc/g; about 0.70-0.80 cc/g; about 0.80-0.90 cc/g; or about 0.90-1.00 cc/g). In some designs, the volume-average size of the open (e.g., to nitrogen gas at 77K) pores may range from about 0.5 nm to about 100 nm—e.g., about 0.5-5 nm; about 5-20 nm; about 20-50 nm; about 50-100 nm. In some designs, the volume-average size of the closed (e.g., to nitrogen gas at 77K) pores (e.g., measured by image analysis of cross-sectional electron microscopy images such as SEM or TEM or measured by the neutron scattering or other suitable technique) may range from about 0.5 nm to about 200 nm—e.g., about 0.5-5 nm; about 5-20 nm; about 20-50 nm; about 50-100 nm; about 100-200 nm.

In one or more embodiments of the present disclosure, Si-comprising active material particles (e.g., Si-comprising active material composite particles) may exhibit moderate (e.g., about 7-120 vol. %) or high (e.g., about 120-300 vol. %) volume changes during initial lithiation (e.g., down to around 0.01 V vs. Li/Li). In some designs, Si-comprising active material particles may exhibit high or very high volume expansion in the range from about 120 vol. % to about 300 vol. % (e.g., 120-140, 140-160, 160-180, 180-200, 200-225, 225-250, 250-275, or 275-300 vol. %) during the first charge (often called “formation” half-cycle) of the battery cell. In some designs, Si-comprising active material particles may exhibit volume changes in the range from about 8 vol. % to about 180 vol. % during one or more charge-discharge cycles of the battery cell. In one or more embodiments of the present disclosure, Si-comprising active material particles may exhibit moderately small (e.g., about 3-7 vol. %) or moderate (e.g., about 7-120 vol. %) volume changes during electrochemical battery cycling from about 0-5% state of charge (SOC) to about 90-100% SOC and back during battery operation.

In one or more embodiments of the present disclosure, a preferred anode for a battery cell may comprise a mixture of Si-comprising active material particles (e.g., nanocomposite Si—C particles, nanocomposite Si particles, among others, the carbon of which is separate from any carbon that forms part of the Si-comprising active material particles) and graphite active material particles (or, more broadly, carbon active material particles, such as lithium intercalation-type carbon active materials, comprising of 90-100% of sp²-bonded carbon atoms, among others) as the anode active material particles, i.e., a so-called blended anode. In addition to the anode active material particles, an anode may comprise inactive material (separate from any inactive material that is an integral part of the Si-comprising active material composite particles), such as binder(s) (e.g., polymer binder) and/or other functional additives (e.g., surfactants, electrically conductive additives). In some implementations, the anode active material particles (e.g., Si-comprising active material composite particles, carbon or graphite (Gr) anode particles in case of a blended anode) may be in a range of about 85 wt. % to about 98 wt. % of the total weight of the anode (not counting the weight of the current collector)—e.g., about 85-89 wt. %; about 89-91 wt. %; about 91-93 wt. %; about 93-95 wt. %; about 95-98 wt. %.

In some implementations, blended anodes may comprise Si-comprising active material particles (e.g., Si—C nanocomposite particles, among others) ranging from about 7 wt. % to about 98 wt. % (e.g., about 7-15 wt. %; about 15-25 wt. %; about 25-40 wt. %; about 60-80 wt. %; about 80-98 wt. %) of all the (blended) anode active material particles, and the graphite particles making up the remainder of the mass (the weight) of the anode active material particles (from about 2 wt. % to about 93 wt. %). In some implementations of a blended anode, a mass fraction of the Si—C (nano)composite particles in the battery electrode composition, excluding any binder, may be in a range of about 10 wt. % to about 70 wt. %, and/or a mass fraction of the graphite particles in the battery electrode composition, excluding any binder, may be in a range of about 30 wt. % to about 90 wt. %.

While the descriptions below may also describe certain examples of the blended anode formulations expressed as mass (wt. %) of Si-comprising active material particles (e.g., Si—C nanocomposite particles, among others) among the anode active materials or as mass (wt. %) of Si-comprising active material particles (e.g., Si—C nanocomposite particles) in the total anode (not counting the weight of the current collector), it will be appreciated that various aspects of this disclosure may be applicable to blended anode formulations expressed as wt. % of Si in the anode (counting the weight of all the active material particles, binder, conductive and/or other additives, but not counting the weight of the current collector). In some implementations, a blended anode composition of about 7 wt. % of Si-comprising active material particles (e.g., Si—C nanocomposite particles, among others) (relative to the total weight of all the active materials in the anode, binder(s), conductive and/or other additive(s), but not counting the weight of the current collector) may correspond, for example, to about 3 wt. % of Si in the blended anode. In some implementations, a blended anode composition of about 19 wt. % of Si-comprising active material particles (e.g., Si—C nanocomposite particles, among others) may correspond, for example, to about 8-11 wt. % of Si in the blended anode. In some implementations, a blended anode composition of about 35 wt. % of Si-comprising active material particles (e.g., Si—C nanocomposite particles, among others) may correspond, for example, about 15-21 wt. % of Si in the blended anode. In some implementations, a blended anode composition of about 50 wt. % of Si-comprising active material particles (e.g., Si—C nanocomposite particles, among others) may correspond, for example, to about 21-30 wt. % of Si in the blended anode. In some implementations, a blended anode composition of about 70 wt. % of Si-comprising active material particles (e.g., Si—C nanocomposite particles, among others) may correspond, for example, to about 30-42 wt. % of Si in the blended anode. In some implementations, a blended anode composition of about 90 wt. % of Si-comprising active material particles (e.g., Si—C nanocomposite particles, among others) may correspond, for example, to about 38-54 wt. % of Si in the blended anode. The wt. % of Si in the anode depends on the wt. % of Si in the Si-comprising active material particles, the wt. % of the binder and conductive additives and the wt. % of the graphite in the blended anode. Smaller fractions of inactive materials (e.g., binder and conductive or other additives), higher fraction of Si in the Si-comprising anode material particles (e.g., Si—C (nano)composite particles) and smaller fraction of graphite in the blended anode result in higher wt. % Si in the anode. For example, in some implementations, a blended anode composition of about 80 wt. % of Si-comprising active material particles (e.g., Si—C nanocomposite particles, among others) and about 20 wt. % of the total of binder(s), conductive or other additive(s) (if present) and graphite may correspond, for example, to about 30 wt. % of Si in the blended anode. In other implementations, a blended anode composition of about 80 wt. % of Si-comprising active material particles (e.g., Si—C nanocomposite particles, among others) and about 20 wt. % of the total of binder(s), conductive or other additive(s) (if present) and graphite may correspond, for example, to about 40 wt. % of Si in the blended anode. In other implementations, a blended anode composition of about 80 wt. % of Si-comprising active material particles (e.g., Si—C nanocomposite particles, among others) and about 20 wt. % of the total of binder(s), conductive or other additive(s) (if present) and graphite may correspond, for example, to about 50 wt. % of Si in the blended anode. In other implementations, a blended anode composition of about 80 wt. % of Si-comprising active material particles (e.g., Si—C nanocomposite particles) and about 20 wt. % of the total of binder(s), conductive or other additive(s) (if present) and graphite may correspond, for example, to about 60 wt. % of Si in the blended anode. In respective implementations, blended anodes may be obtained in which the mass (weight) of the silicon is in a range of about 3 wt. % to about 60 wt. % of a total mass of the anode (not counting the weight of the current collector).

While the descriptions below may also describe certain examples of the blended anode formulations expressed as mass (wt. %) of Si-comprising active material particles (e.g., Si—C nanocomposite particles) in the active material blends, it will be appreciated that various aspects of this disclosure may be applicable to blended anode formulations attributing a fraction (e.g., %) of the total capacity of the blended anode to the capacity of the Si-comprising active material particles. In some implementations, for example, about 25% of the total capacity of the blended anode may be obtained from the Si-comprising active material particles (e.g., Si—C nanocomposite particles) in a blended anode composition of about 5-8 wt. % of Si-comprising active material particles (e.g., Si—C nanocomposite particles) relative to the total weight of active material particles (both Si-comprising and graphite active material particles). In some other implementations, as another example, about 50% of the total capacity of the blended anode may be obtained from the Si-comprising active material particles (e.g., Si—C nanocomposite particles) in a blended anode composition of about 15-21 wt. % of Si-comprising active material particles (e.g., Si—C nanocomposite particles). In some other implementations, about 70% of the total capacity of the blended anode may be obtained from the Si-comprising active material particles (e.g., Si—C nanocomposite particles) in a blended anode composition of about 30-40 wt. % of Si-comprising active material particles (e.g., Si—C nanocomposite particles). In some other implementations, about 80% of the total capacity of the blended anode may be obtained from the Si-comprising active material particles (e.g., Si—C nanocomposite particles) in a blended anode composition of about 45-55 wt. % of active material Si-comprising active material particles (e.g., Si—C nanocomposite particles). In some other implementations, about 92% of the total capacity of the blended anode may be obtained from the Si-comprising active material particles (e.g., Si—C nanocomposite particles) in a blended anode composition of about 65-75 wt. % of Si-comprising active material particles (e.g., Si—C nanocomposite particles). In some other implementations, about 95% of the total capacity of the blended anode may be obtained from the Si-comprising active material particles (e.g., Si—C nanocomposite particles) in a blended anode composition of about 75-85 wt. % of Si-comprising active material particles (e.g., Si—C nanocomposite particles). In some other implementations, about 98% of the total capacity of the blended anode may be obtained from the Si-comprising active material particles (e.g., Si—C nanocomposite particles) in a blended anode composition of about 85-95 wt. % of Si-comprising active material particles (e.g., Si—C nanocomposite particles). Note that the exact % capacity provided by the Si-comprising active material particles in the blended anode having a specific wt. % of the Si-comprising active material particles depends on the specific capacity of the plurality of the Si-comprising active material particles and the specific capacity of the plurality of graphite (or, broadly, carbon) active material particles.

In some embodiments, the battery anode composition may advantageously comprise one, two or more carbon-comprising functional additives (e.g., additives that enhance electrical conductivity or rate performance of mechanical properties of the electrode). In some embodiments, the carbon-comprising functional additive(s) is (are) selected from: carbon nanotubes (CNTs) (e.g., single walled carbon nanotubes (SWCNTs), double walled carbon nanotubes (DWCNTs), multi-walled carbon nanotubes (MWCNTs)), carbon nanofibers, carbon black, graphite, graphite ribbons, exfoliated graphite (e.g., exfoliated graphite flakes), graphene oxide (e.g., graphite oxide flakes) and graphene (e.g., flakes) (including, e.g., single-layered and/or multi-layered graphene or graphene oxide). In some embodiments, carbon additives may be purified, defective, curved and/or comprise chemical functional groups. In some embodiments, the battery electrode composition may comprise one or more binders (in some designs, two or more binder components). In some embodiments, the D₅₀ of the carbon additives' longest dimensions (e.g., length in case of CNTs or width in case of graphite flakes or graphene) may advantageously range from about 5 micron to about 200 micron (e.g., about 5-10 micron, about 10-20 micron, about 20-50 micron, about 50-100 micron, about 100-200 micron). Too small value of D₅₀ may, for example, reduce effectiveness of such additives and, for example, increase resistance or reduce cycle stability, while too large value of D₅₀ may, for example, excessively increase slurry viscosity or reduce electrode compaction and thus volumetric capacity, in some designs.

An aspect is directed to a battery anode. In some embodiments, the battery anode comprises any of the foregoing battery anode electrode compositions, disposed on and/or in a current collector (e.g., Cu-based or Cu-containing current collector, such as a dense or porous foil or a mesh or a foam or a nanowire-comprising or nanoflake-comprising current collector or (e.g., metalized) polymer-comprising current collector). In some embodiments, the battery anode comprises a battery electrode composition and a binder. In some embodiments, a coating density of the battery electrode is in a range of about 0.8 to about 1.7 g/cm³ (e.g., about 0.8-0.9 g/cm³; about 0.9-1.0 g/cm³; about 1.0-1.2 g/cm³; about 1.2-1.4 g/cm³, about 1.4-1.7 g/cm³). Higher fraction of suitable graphite material in a blended anode may benefit from higher anode density for better performance (e.g., better stability, better rate performance, higher volumetric capacity, lower swell during cycling), although excessive density may also be detrimental for the same or other characteristics. As such, a detailed optimization may be conducted for a particular battery design, with respect to factors such as electrode thickness, areal capacity loading, battery cycling environment and regime, among other factors.

An aspect is also directed to a blended battery anode, wherein both the Si-comprising anode active material particles (e.g., nanocomposite Si—C particles, among others) and graphite (or, broadly, carbon-based) active anode material may be present. The anode may preferably comprise a binder amount optimized for the properties of both the Si-comprising active material particles and the graphite particles. For example, the anode may be characterized by an areal binder loading, defined as a mass of the binder in the battery anode (e.g., measured in mg) normalized by the surface area of the active material particles (e.g., Si-comprising (e.g., nanocomposite) anode active material particles and (if present) graphite active material particles in the same battery anode (e.g., measured in m² and defined by the mass of active material particles (in g) multiplied by the Brunauer-Emmett-Teller specific surface area (BET-SSA) in m²/g). Since a BET-SSA of both the Si-comprising active material particle population and the graphite active material particle population may vary from slurry to slurry, the binder loading may preferably be adjusted based on the desired areal binder loading. Higher BET-SSA of the active anode materials (measured in m²/g) may require a higher mass fraction of the binder in the anode electrode. For example, an anode electrode comprising an active material particle population (e.g., Si-comprising (e.g., nanocomposite) active anode material particle population or a blend of Si-comprising active material(s) particle(s) and graphite active material(s) particle(s)) with BET-SSA of about 10 m²/g may require from about 20 mg to about 150 mg of binder per about 1 g of active material particles (approximately 2-13 wt. % relative to the total weight of the binder and the active material composition, not counting the weight of conductive or other additives or the weight of the current collector), while another anode electrode comprising another active material particle population (e.g., Si-comprising (e.g., nanocomposite) anode active material particle population or a blend of Si-comprising active material(s) particle(s) and graphite active material(s) particle(s)) with BET-SSA of only about 1 m²/g may require from about 2 mg to about 40 mg of the binder per about 1 g of active material particles (approximately 0.2-4 wt. % relative to the total weight of the binder+active material composition, not counting the weight of conductive or other additives or the weight of the current collector). However, in some designs, an areal binder loading of the battery anode in both cases is in a range from about 2.0 mg/m² to about 40.0 mg/m² (e.g., about 2.0-5.0 mg/m²; about 5.0-9.0 mg/m²; about 9.0-15.0 mg/m²; about 15.0-40.0 mg/m²). In some designs, a higher fraction of Si-comprising (e.g., nanocomposite) anode active material particle population in the anode (relative to the total weight of all active materials) may preferably exhibit a higher areal binder loading. In some designs, a larger average particle size of Si-comprising (e.g., nanocomposite) anode active material particle population in the anode may preferably require a slightly smaller areal binder loading. In some designs, a larger BET-SSA of Si-comprising (e.g., nanocomposite) anode active material particle population in the anode may preferably exhibit a slightly higher areal binder loading. In some designs, the areal binder loading may also depend on the binder composition and properties (e.g., adhesion, chemical composition, hardness, elastic modulus when exposed to electrolyte, maximum elongation at break, among others). So, in some designs, the optimal areal binder loading content within a range of about 2.0 mg/m² to about 40.0 mg/m² (e.g., 2.0-5.0 mg/m², 5.0-9.0 mg/m², 9.0-15.0 mg/m², 15.0-40.0 mg/m²) depends on the anode composition.

While the description below may describe certain examples of suitable intercalation-type graphites to be used in combination with Si-comprising (e.g., Si—C nanocomposites) active material particles in a blend, it will be appreciated that various aspects of this disclosure may be applicable to various soft-type synthetic graphite (or soft carbon, broadly), various hard-type synthetic graphite (or hard carbon, broadly), various natural graphite (which may, for example, be pitch carbon coated, among others), and graphite-like (graphitic, mostly sp²-bonded) materials; including those which exhibit discharge capacity from about 320 to about 372 mAh/g (e.g., about 320-350 mAh/g; about 350-362 mAh/g; about 362-372 mAh/g); including those which exhibit low, moderate and high swelling; including those which exhibit good and poor compression, including those which exhibit BET-SSA of about 0.5 to about 40 m²/g (e.g., about 0.5-2 m²/g; about 2-4 m²/g; about 4-6 m²/g; about 6-8 m²/g; about 8-10 m²/g; about 10-14 m²/g; about 14-20 m²/g; about 20-40 m²/g); including those which exhibit lithiation efficiency of about 85-90% and more; including those which exhibit true densities ranging from about 1.5 g/cm³ to about 2.3 g/cm³ (e.g., about 1.5-1.8 g/cm³, about 1.8-2.3 g/cm³); including those which exhibit poor, moderate, or good cycle life when used in Li-ion battery anodes on their own (e.g., without Si-comprising or other active material particles); including to those which are coated and comprise coatings with coating thickness to appreciably improve compression and springing during cycling.

An aspect is also directed to a Li-ion battery comprising: (i) a suitable blended battery anode (wherein both the Si-comprising anode active material particles (e.g., nanocomposite Si—C particles, among others) and suitable graphite (or, broadly, carbon-based) active anode material (e.g., graphite active material particles) are present in the anode) and (ii) a suitable battery cathode, wherein the suitable cathode may comprise, in some designs: (iia) intercalation-type cathode or (iib) conversion-type cathode (which may include a displacement-type cathode, a chemical transformation type cathode or a true conversion-type cathode) or (iic) a mixed intercalation/conversion type cathode.

Illustrative examples of suitable intercalation-type cathodes to be used in preferable cells may include, e.g.: lithium nickel cobalt aluminum oxides (NCA), lithium nickel cobalt manganese aluminum oxides (NCMA), lithium nickel oxides (LNO), lithium manganese oxides (LMO) (including high voltage spinels), lithium nickel manganese oxides (LMNO) (including high voltage spinels), lithium manganese-rich oxides (LMR) (a general formula for LMR often being written as xLi₂MnO₃·(1-x)LiMO₂, where M is a mixture of Ni, Mn, Co and/or other transition metals, where LMR often comprise 60-80 at. % Mn, 20-40 at. % Ni, 0-10 at. % Co as atomic fractions of all the transition metals; an illustrative example composition: Li[Li_{0.15}Mn_{0.6}Ni_{0.2}Co_{0.05}]O₂), lithium nickel manganese cobalt oxides (NCM), lithium cobalt oxide (LCO), lithium cobalt aluminum oxides (LCAO), other types of Ni-based layered cathode materials (e.g., comprising about 50-98 at. % Ni relative to other non-Li (e.g., transition) metals and thus 2-20 at. % of other remaining non-Li metals (e.g., Mn, among others) added to stabilize or otherwise improve performance of layered nickel-based oxides), lithium iron phosphate (LFP), lithium cobalt phosphate (LCP), lithium manganese phosphate (LMP), lithium manganese iron phosphate (LMFP), lithium nickel phosphate (LiNiPO₄), lithium vanadium fluoro phosphate (LiVFPO₄), lithium iron fluoro sulfate (LiFeSO₄F), various Li excess materials (e.g., lithium excess (rocksalt) transition metal oxides and oxy-fluorides such as Li_{1.211}Mo_{0.467}Cr_{0.3}O₂, Li_{1.3}Mn_{0.4}Nb_{0.3}O₂, Li_{1.2}Mn_{0.4}Ti_{0.4}O₂, Li_{1.2}Ni_{0.333}Ti_{0.333}Mo_{0.133}O₂ and others which may comprise Ti and/or Mn, in some designs), various high capacity Li-ion based materials with partial substitution of oxygen for fluorine or iodine (e.g., rocksalt Li₂Mn_{2/3}Nb_{1/3}O₂F, Li₂Mn_{1/2}Ti_{1/2}O₂F, Li_{1.5}Na_{0.5}MnO_{2.85}I_{0.12}, among others) and other types of Li-comprising disordered, layered, tavorite, olivine, or spinel type active materials or their mixtures comprising at least oxygen or fluorine or sulfur and at least one transition metal and/or other lithium transition metal (TM) oxides or phosphates or sulfates (or mixed) cathode active materials that rely on the intercalation of lithium (Li) and changes in the TM oxidation state (including those that may be doped or heavily doped; including those that have gradient in composition or core-shell morphology; including those that may be partially fluorinated or comprise some meaningful fraction of fluorine (e.g., about 0.001-10 at. %) in their composition, etc.).

Various aspects may be applicable to high-voltage lithium transition metal oxide (or phosphate or sulfate or mixed or other) cathodes where TMs and oxygen (O) are covalently bonded and both TM and O take part in electrochemical reduction-oxidation (redox) reactions during charge and discharge (including those oxides or phosphate or sulfate or mixed cathodes that may comprise at least about 0.25 at. % of Mn, Fe, Ni, Co, Nb, Mg, Cr, Mo, Zr, W, Ta, Ti, Hf, Y, La, Sb, V, Sn, Si, or Ge).

Illustrative examples of suitable conversion-type cathodes to be used in preferable cells may include: metal fluorides, metal oxy-fluorides, metal chlorides, metal sulfides, metal selenides, their various mixtures, composites and/or others. Illustrative examples of metal fluorides, in a Li-free state, include FeF₃, FeF₂, MnF₃, CuF₂, NiF₂, BiF₃, BiF₅, SnF₂, SnF₄, SbF₃, SbFs, CdF₂, ZnF₂, TiF₃, TiF₄, AgF, AgF₂, their various mixtures, alloys and combinations, among others. In some designs, it may be advantageous to produce nanocomposites and/or core-shell structures comprising metal fluorides to enhance their performance and stability. In some designs, it may be advantageous to dope metal fluorides with oxygen or utilize metal oxy-fluorides. In a fully lithiated state, pure metal fluorides convert to a composite comprising a mixture of metal and LiF clusters (or nanoparticles). Examples of the overall reversible reactions of the conversion-type metal fluoride cathodes may include 2Li+CuF₂↔2LiF+Cu for CuF₂— based cathodes or 3Li+FeF₃↔3LiF+Fe for FeF₃-based cathodes. It will be appreciated that metal fluoride-based cathodes may be prepared in Li-free or partially lithiated or fully lithiated states. In addition to fluorides, other illustrative examples of conversion-type active electrode materials may include various metal oxy-fluorides, sulfo-fluorides, chloro-fluorides, oxy-chloro-fluorides, oxy-sulfo-fluorides, fluoro-phosphates, sulfo-phosphates, sulfo-fluoro-phosphates, mixtures of metals (e.g., Fe, Cu, Ni, Co, Bi, Cr, Zn, Ti, other metals, their various mixtures and alloys, partially oxidized metals and metal alloys) and salts (metal fluorides (including LiF or NaF), metal chlorides (including LiCl or NaF), metal oxy-fluorides, metal oxides, metal sulfo-fluorides, metal fluoro-phosphates, metal sulfides, metal oxy-sulfo-fluorides, their various combinations), and/or other salts that comprise halogen or sulfur or oxygen or phosphorous or a combination of these elements, among others. In some designs, F in metal fluorides may be fully or partially replaced with another halogen (e.g., Cl, Br, I) or their mixtures to form the corresponding metal chlorides or metal fluoride-chlorides and/or other metal halide compositions.

Yet another example of a promising and suitable conversion-type cathode active material is sulfur(S) (in a Li-free state) or lithium sulfide (Li₂S, in a fully lithiated state). In some designs, selenium (Se) may also be used together with S or on its own for the formation of such cathode active materials. In some designs, it may be advantageous to produce nanocomposites and/or core-shell structures comprising S, Li₂S, Se, Li₂Se or their various mixtures and combinations to enhance their performance and stability. In some designs, conversion-type active cathode materials may also advantageously comprise metal oxides or mixed metal oxides. In some designs, such (nano)composites may advantageously comprise metal sulfides or mixed metal sulfides. In some examples, mixed metal oxides or mixed metal sulfides may comprise lithium. In some examples, mixed metal oxides may comprise titanium or vanadium or manganese or iron metal.

In some examples, lithium-comprising metal oxides or metal sulfides may exhibit a layered structure. In some examples, metal oxides or mixed metal oxides or metal sulfides or mixed metal sulfides may advantageously be both ionically and electrically conductive (e.g., in the range from around 10⁻⁷ to around 10⁺⁴ S/cm). In some examples, various other intercalation-type active materials may be utilized instead of or in addition to metal oxides or metal sulfides. In some designs, such an intercalation-type active material exhibits charge storage (e.g., Li insertion/extraction capacity) in the potential range close to that of S or Li₂S (e.g., within around 1.5-3.8 V vs. Li/Li).

In some designs, the use of so-called Li-air cathodes (e.g., cathodes with active material in the form of Li₂O₂, Li₂O, LiOH in their lithiation state) or similar metal-air cathodes based on Na, K, Ca, Al, Fe, Mn, Zn and/or other metals (instead of Li) may similarly be beneficial due to their very high capacities. In some designs, such cathode active materials should ideally reversibly react with oxygen or oxygen containing species in the electrochemical cell and may fully disappear upon full de-lithiation (metal removal). Cathode active materials that exhibit such characteristics may also be considered to belong to conversion-type cathodes.

In some of the preferred examples a surface of cathode active materials (e.g., intercalation-type cathode materials, such as LCO, NCM, NCMA, LMR, NCA, LMO, LMNO, LFP, LMP, LMFP, or conversion-type active materials comprising S, Li₂S, metal sulfides, metal fluorides, etc.) may be coated with a layer of ceramic material. Illustrative examples of a preferred coating material for such cathodes include titanium oxide (e.g., TiO₂), tantalum oxide (Ta₂O₅), aluminum oxide (e.g., Al₂O₃), tungsten oxide (e.g., WO), chromium oxide (e.g., Cr₂O₃), niobium oxide (e.g., NbO or NbO₂) and zirconium oxide (e.g., ZrO₂), lithium phosphate (e.g., Li₃PO₄), lithium oxy-thiophosphate (e.g., Li₃P₁₊ₓO₄S₄ₓ), and their various mixtures, alloys, and combinations. In some designs, such ceramic materials may additionally comprise lithium (Li)—e.g., as lithium phosphate, lithium oxy-thiophosphate, lithium titanium oxide, lithium tantalum oxide, lithium aluminum oxide, lithium tungsten oxide, lithium chromium oxide, lithium niobium oxide, lithium zirconium oxide and their various alloys, mixtures and combinations. In other preferred examples, LCO, NCM, NCMA, LMR, NCA, LFP, LMFP, LMP, LMO or LMNO may be doped with Al, Ti, Mg, Nb, Zr, Cr, Hf, Ta, W, Mo or La. In some designs, a preferred cathode current collector material is aluminum or aluminum alloy. In some designs, a preferred battery cell includes a polymer separator. In some of the preferred examples, a polymer separator is made of or comprises polyethylene, polypropylene or a mixture thereof. In some of the preferred examples, a surface of a polymer separator is coated with a layer of ceramic material. Examples of a preferred coating material for polymer separators may include titanium oxide (TiO₂), aluminum oxide (Al₂O₃), aluminum hydroxide or oxyhydroxide, zirconium oxide (ZrO₂), magnesium oxide (MgO) or magnesium hydroxide or oxyhydroxide. In some designs, a preferred battery cell includes a ceramic-based or ceramic-comprising (e.g., ceramic/polymer composite) separator. The ceramic or ceramic component of such a ceramic or ceramic-comprising separator may comprise titanium oxide (TiO₂), aluminum oxide (Al₂O₃), aluminum hydroxide or oxyhydroxide, zirconium oxide (ZrO₂), magnesium oxide (MgO) or magnesium hydroxide or oxyhydroxide. The ceramic or ceramic component of such a ceramic or ceramic-comprising separator may comprise ceramic particles (e.g., elongated particles, nanofibers, flake-shaped particles, randomly shaped particles including nanoparticles) in some designs. In some preferred examples, one surface or both surfaces of a polymer-comprising separator is coated with a porous layer of an adhesive (e.g., polyvinylidene fluoride, PVDF). For each side of the separator that is coated with an adhesive, a fraction of the geometrical area of the surface that is coated with the adhesive may range from about 2 areal % to about 50 areal %. In some cases, the adhesive separator has been found to be beneficial for Li-ion prismatic cells and even more so for Li-ion pouch cells with Si-comprising anodes.

An aspect is directed to a Li-ion battery with a blended anode (e.g., comprising Si-comprising active material and graphite active material) that exhibits a relatively high areal capacity loading and properly matched (by areal capacity) cathode (e.g., with a slightly smaller areal capacity loading, selected according to the desired negative (N) to positive (P) ratio, N/P in the range of around 1:01 to around 1:35 (e.g., around 1.01-1.05; around 1.05-1.10; around 1.10-1.15; around 1.15-1.20; around 1.20-1.25; around 1.25-1.35); wherein the N/P ratio corresponds to the ratio of the reversible areal capacities of the anode to cathode). Note that in some designs both the performance characteristics and cycle stability of Li-ion battery cells comprising some of such blended anodes (particularly for blended anodes with high fractions of Si or high fractions of Si-comprising active material particles—e.g., for the blended anodes with about 3-60 wt. % Si (e.g., about 3-10 wt. % Si, about 10-20 wt. % Si, about 20-40 wt. % Si, or about 40-60 wt. % Si) or for blended anodes with the Si-comprising active material particles (e.g., Si—C nanocomposite particles, among others) contributing to about 20-100% of the total blended anode capacity (e.g., about 20-50%, about 50-70%, about 70-80%, about 80-90%, about 90-95%, about 95-99%, about 99-100% of the total blended anode capacity) may become particularly unsatisfactory for applications requiring long calendar life or long cycle life or low first cycle losses or other properties, if the electrode areal capacity loading exceeds around 1-2 mAh/cm², even more if the electrode areal capacity exceeds around 4-5 mAh/cm², and further more if the electrode areal capacity exceeds around 6-8 mAh/cm². Higher loading, however, is advantageous for reducing cost of energy storage devices and increasing their energy density. One or more embodiments of the present disclosure are directed to synthesis processes, compositions and various physical and chemical properties of graphite(s) and or binder(s) in such blended anodes that provide satisfactory performance for electrode area loadings in the range from around 2 mAh/cm² to around 5 mAh/cm² and more so for loadings in the range from around 5 mAh/cm² to around 8 mAh/cm² and even more so for loadings in the range from around 8 mAh/cm² to around 16 mAh/cm² (e.g., in some designs, an areal capacity loading of an electrode composition may range from around 2 mAh/cm² to around 16 mAh/cm²).

An aspect is directed to a Li-ion battery with a blended anode (e.g., comprising Si-comprising (e.g., composite) active material particles and graphite active material particles) that exhibits high energy. In some designs, degradation of Li-ion cells with blended anodes not comprising suitable graphite(s) or binder(s) may become particularly undesirably fast for multi-layered (e.g., stacked or rolled) medium sized cells (e.g., cells with cell capacity in the range from 0.2 Ah to around 10 Ah), even more so for large cells (e.g., cells with cell capacity in the range from around 10 Ah to around 40 Ah), even more so for ultra-large cells (e.g., cells with cell capacity in the range from around 40 Ah to around 400 Ah) or gigantic cells (e.g., cells with cell capacity in the range from around 400 Ah to around 4,000 Ah or even more), particularly if the blended anodes comprise moderate-to-relatively high mass fraction of Si (about 3-60 wt. %; e.g., about 3-10 wt. %, about 10-20 wt. %, about 20-40 wt. %, or about 40-60 wt. %) or if the Si-comprising active material particles (e.g., Si—C nanocomposite particles, among others) contribute to a moderate or a relatively high fraction of the total anode capacity (about 20-100%; e.g., about 20-50%, about 50-70%, about 70-80%, about 80-90%, about 90-95%, about 95-99%, or about 99-100%). However, multi-layered medium or large size cells may be attractive for some electronic devices and multi-layered large, ultra-large or gigantic cells may be particularly attractive for use in some electric transportation or grid storage applications. One or more aspects of the present disclosure facilitates the use of proper graphite(s) (or, more broadly carbon(s)) in the blended anodes with suitable microstructural, chemical, physical and/or other properties, and proper binder(s) to mitigate or overcome some or all of such limitations of blended anodes and substantially enhance performance of such Li-ion cells.

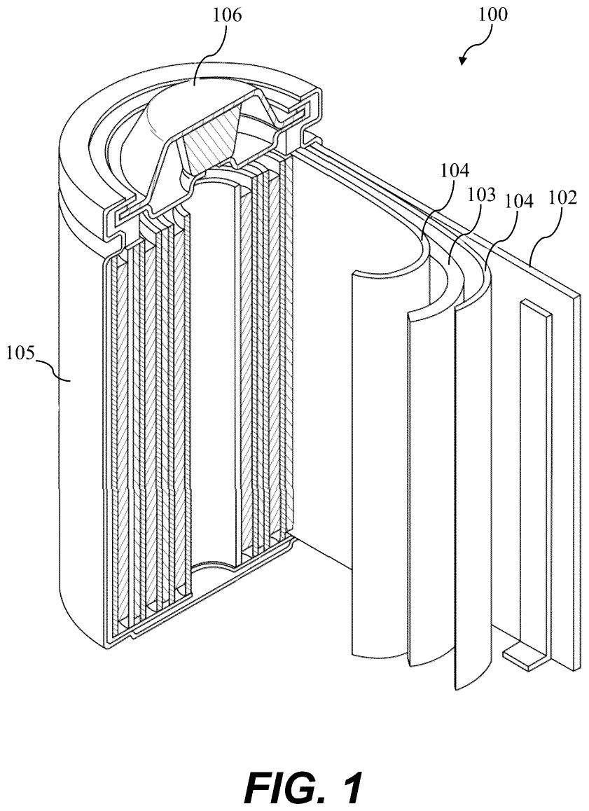

FIG. 1 illustrates an example metal-ion (e.g., Li-ion) battery in which the electrode particles, components, materials, processes, and/or other techniques described herein, or combinations thereof, may be applied according to various embodiments. A cylindrical battery is shown here for illustration purposes, but other types of arrangements, including prismatic or pouch (laminate-type) batteries, may also be used as desired. The example battery 100 includes a negative electrode (anode electrode or anode) 102, a positive electrode (cathode electrode or cathode) 103, a separator 104 interposed between the anode 102 and the cathode 103, an electrolyte (shown implicitly) impregnating the separator 104, a battery case 105, and a sealing member 106 sealing the battery case 105. The electrolyte ionically couples the anode (negative electrode) and the cathode (positive electrode). The electrolyte is interposed between the anode electrode and the cathode electrode. In some implementations, battery 100 also includes an anode current collector and a cathode current collector. The anode is disposed on and/or in the anode current collector and the cathode is disposed on and/or in the cathode current collector.

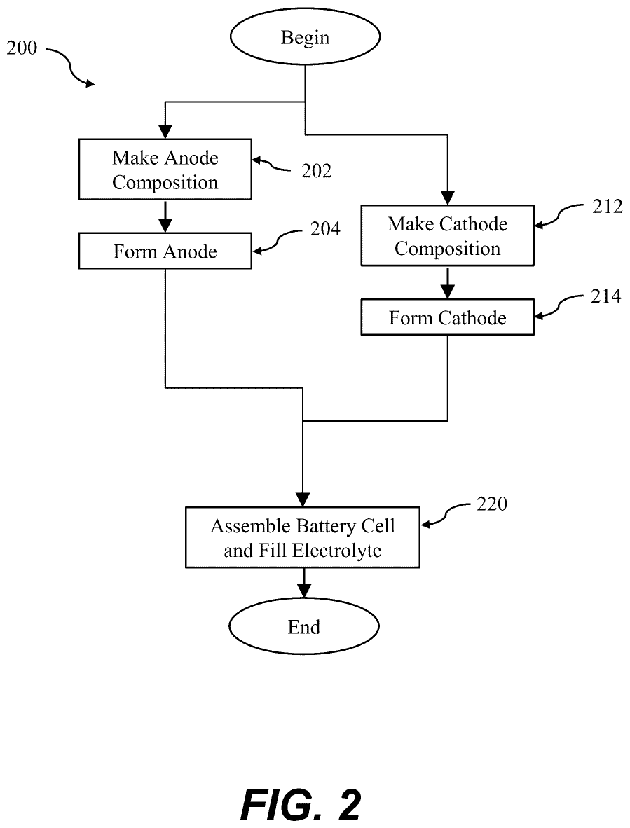

FIG. 2 is a flow diagram of a process 200 of making a Li-ion rechargeable battery cell, such as the example battery 100 of FIG. 1. In the example shown, process 200 includes stages 202, 204, 212, 214, and 220. The flow diagram includes an anode branch (left branch) that includes stages 202 and 204, and a cathode branch (right branch) includes stages 212 and 214. At stage 202, anode particles (e.g., conventional graphite (carbon) anode particles or Si-comprising (e.g., Si—C nanocomposite(s), core-shell, SiOₓ-based, or SiNₓ-based) particles are provided or made, and at stage 204, an anode is formed using the anode particles from stage 202. Similarly, at stage 212, cathode particles (e.g., conventional intercalation-type cathode particles or core-shell cathode particles or composite cathode particles, including conversion-type cathode material-comprising composite particles) are provided or made, and at stage 214, a cathode is formed.

Electrodes utilized in Li-ion batteries are typically produced by (i) formation of a slurry comprising active materials, conductive additives, binder solutions and, in some cases, surfactant or other functional additives; (ii) casting the slurry onto and/or into a metal foil current collector (e.g., Cu or Cu-alloy foil for most anodes and Al or Al-alloy foil for most cathodes); and (iii) drying the casted electrodes to completely evaporate the solvent. Note that a metal mesh, metal foam or very rough metal foil (e.g., comprising metal nanowires or metal nanosheets on its surface) may be used as current collector(s) in some designs (e.g., for higher areal capacity loadings or for achieving faster charge). Also note that a metal-coated thin polymer sheet may also be used in some designs as current collector(s) (e.g., to achieve improved safety or lower current collector weight). Also note that a porous metal foil or composite (e.g., nanocomposite) metal foils may be used in some designs (e.g., for improved properties, lower weight).

Stage 204 includes forming an anode electrode, with the anode electrode including the anode particles made or provided at stage 202. For example, stage 204 can include (1) making an anode slurry that includes the anode particles (e.g., from stage 202) and other anode slurry components (e.g., binder, additives) and (2) casting the anode slurry on and/or (in case of a porous current collector) in an anode current collector (e.g., copper foil or copper-alloy foil current collector, porous copper or copper alloy or nickel or nickel alloy foam or foil, or nickel-alloy current collector or polymer-comprising current collector). For example, other anode slurry components may include: other electrochemically-active anode active materials (e.g., suitable natural or synthetic graphite, soft carbon or hard carbon blended with Si-comprising active material particles, such as Si—C (nano)composite particles), electrically conductive additives (e.g., carbon nanotubes or carbon black or branched carbon or carbon nanofibers or graphite flakes or exfoliated graphite or graphene or graphene oxide or soft graphite or their various combinations), binders (e.g., polymer binders), and solvents (e.g., water or an organic solvent or their mixtures). In some designs, solvent-free (“dry”) electrode fabrication may be utilized.

Stage 214 includes forming a cathode electrode, with the cathode electrode including the cathode particles made or provided at stage 212. For example, this stage 214 can include (1) making a cathode slurry that includes the cathode particles (e.g., from stage 212) and other cathode slurry components and (2) casting the cathode slurry on and/or (in case of a porous current collector) in a cathode current collector (e.g., aluminum foil or aluminum-alloy foil current collector). For example, other cathode slurry components may include: other electrochemically-active cathode active materials, electrically conductive additives (e.g., carbon nanotubes or carbon black or branched carbon or carbon nanofibers or graphite flakes or graphene or graphene oxide or soft graphite or their various combinations), binders (e.g., polymer binders), and solvents (e.g., water or an organic solvent or their mixtures). In some designs, solvent-free (“dry”) electrode fabrication may be utilized.

At stage 220, the Li-ion rechargeable battery cell is assembled from at least the anode electrode (e.g., blended anode comprising graphite particles and Si—C (nano)composite particles) and the cathode electrode with an electrolyte interposed between the anode electrode and the cathode electrode. The electrolyte provides ionic conduction between the anode and the cathode. The electrolyte ionically couples the anode and the cathode. The electrolyte may comprise a liquid electrolyte or a solid electrolyte (or a mixture of liquid and solid electrolyte) at battery operating temperatures (e.g., in some designs, the solid electrolyte may be molten or semi-molten during melt-infiltration and may subsequently solidify). In some implementations (e.g., implementations in which a liquid electrolyte is used), a porous separator (e.g., comprising a porous ceramic layer and/or a porous adhesive layer on one or both sides) may be used to maintain a space between the anode and the cathode electrodes (e.g., to avoid a short-circuit). The liquid electrolyte can fill the pores of the porous separator and any open pores of the electrode(s).

In still further aspects, the step of assembling the battery can comprise positioning a suitable separator that can comprise polymer and/or ceramic components between the cathode and anode electrodes. In other designs, the separator may be omitted (e.g., if a solid electrolyte is used, the solid electrolyte may take the place of the separator). Packaging the battery into a desired configuration (e.g., a cylindrical cell configuration, a prismatic cell configuration, a pouch cell configuration), carrying out electrochemical formation (e.g., formation of a solid-electrolyte interphase (SEI) in the anode and/or a cathode-electrolyte interphase (CEI) in the cathode), degassing, sealing, and aging operations may also be carried out as part of stage 220.

Battery cell modules or battery cell packs may advantageously comprise cells with electrode and/or electrolyte compositions provided in one or more embodiments of the present disclosure. Such cell modules or packs may offer improved performance characteristics, simplified designs, better safety features or lower cost.

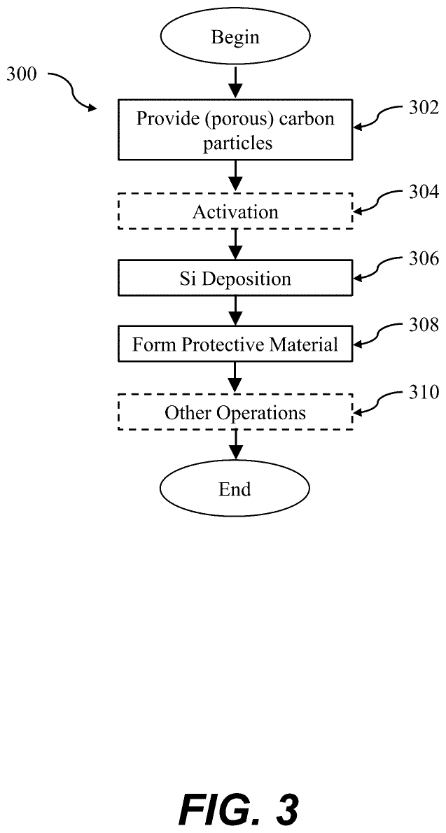

FIG. 3 is a flow diagram of a process 300 of making anode particles. Process 300 includes stages 302, 304, 306, 308, and 310. At least some of the stages that are optional in some implementations are shown in boxes with dotted lines. Accordingly, stages 304 and 310 are optional in some implementations. In some implementations, the stages may be carried out in the order shown by the arrows. In some designs, process 300 may be particularly useful when implemented as part of stage 202. If suitable modifications are made to process 300 to make cathode particles, process 300 may be implemented as part of stage 212. In some implementations, electrode particles are made using porous carbon particles or porous carbon-containing particles (e.g., using graphitic, sp²-bonded carbon or porous graphitic, sp²-bonded carbon—containing particles), with nanostructured or nano-sized active material particles (e.g., Si-comprising, among others) being formed in the pores of the porous carbon or porous carbon-containing particles.

At stage 302, porous carbon particles are provided. In some designs, carbon (e.g., graphitic, sp²-bonded carbon) particles may be obtained from pyrolysis or carbonization (e.g., by heat treatment or hydrothermal treatment) (in some designs, followed by washing of metal-comprising or impurity compounds; and may be further followed by another heat-treatment or annealing) of a suitable precursor particle, such as a polymer particle or a biomass-derived particle or a metal-organic particle (e.g., with examples of suitable metals or combinations of two, three or more metals include magnesium (Mg), calcium (Ca), Na, K, among others). In some designs, carbon particles may be obtained from carbon-comprising inorganic precursor particles (e.g., carbides or oxy-carbides). In some designs, it may be particularly advantageous to utilize Mg-comprising metalorganic compounds (e.g., Mg-comprising organic salts). Herein, processes, materials, and techniques for obtaining carbon-comprising particles by pyrolysis of magnesium (Mg) organic salt compositions are described below in more detail.

In some designs, inorganic sacrificial templates (including various oxides or hydroxides or oxyhydroxides of various metals and semi-metals—e.g., Zn, Mg, Si, Al, Ti, Ca, Mg, Sc, etc. and their various combinations) or soft (organic) templates may be used for the formation of porous carbon particles. In some designs, the inorganic sacrificial material may be selectively removed (e.g., etched) to form the pores of the porous carbon material. An example process can include forming precursor particles comprising a metal compound (e.g., MgO) and carbon, by pyrolysis, and etching the metal compound (e.g., MgO) from the precursor particles to form porous carbon particles.

In some designs, it may be preferable that the porosity (e.g., specific surface area and specific pore volume) of the porous carbon or carbon-containing particles (e.g., upon completion of stage 302) be quite high (e.g., BET specific surface area (BET-SSA) of at least about 500 m²/g) before the formation (e.g., by gaseous deposition) of the nanostructured or nano-sized active material particles therein. In some cases, the precursor particles themselves may be highly porous (e.g., BET-SSA of at least about 500 m²/g). BET-SSA values may be obtained from the data of nitrogen sorption-desorption at cryogenic temperatures, such as about 77 K. In some implementations, it is preferable that the porous carbon particles exhibit a BET specific surface area in a range of about 500 m²/g to about 4800 m²/g (e.g., about 500-1000 m²/g, about 1000-3500 m²/g, about 1800-3500 m²/g, about 1000-2000 m²/g; about 2000-3000 m²/g; about 3000-3800 m²/g; about 3000-4500 m²/g; around 3800-4800 m²/g), before formation of the active material particles therein.

In some implementations, it is preferable that the porous carbon particles exhibit a total pore volume (TPV) in a range of about 0.5 to about 5.0 cm³/g (e.g., about 0.5-1.2 cm³/g; about 1.2-2.5 cm³/g, about 1.8-2.2 cm³/g; about 0.5-1.0 cm³/g; about 1.0-1.5 cm³/g; about 1.5-2.0 cm³/g; about 2.0-2.5 cm³/g; about 2.5-3.0 cm³/g; about 3.0-4.0 cm³/g; about 4.0-5.0 cm³/g). In some implementations, it is preferable that the porous carbon particles exhibit a cumulative pore volume for pores in the micropore (≤2 nm) and mesopore (2 to 50 nm) size ranges (but not counting macropores, ≥50 nm) in a range of about 0.5 cm³/g to about 5 cm³/g (e.g., about 0.5-1.0 cm³/g; about 1.0-2.0 cm³/g; about 2.0-3.5 cm³/g; about 3.5-5 cm³/g), before formation of the active material particles therein.

In some designs, it may be preferable to produce or enhance porosity in carbon or carbon precursor particles (e.g., by carrying out chemical and/or physical activation on the carbon or carbon-containing particles or by leaching out non-carbon components of carbon-containing particles or by multiple processes) before formation of the active material particles therein to tune the porosity characteristics. Accordingly, stage 304 includes carrying out a porosity enhancing (e.g., an activation) process on the carbon particles (e.g., from stage 302). Stage 304 is optional depending on whether the porous carbon particles from stage 302 meet the porosity requirements for the subsequent formation of active materials, at stage 306. If stage 304 (activation) is carried out after stage 302, then stages 302 and 304 in combination may sometimes be referred to as a stage of providing porous carbon particles.

In some implementations, one may perform activation (stage 304) to increase the porosity and the surface area of carbon-comprising (porous) particles (from stage 302). If stage 304 is carried out, the carbon-comprising particles from stage 302 may sometimes be referred to as precursor carbonaceous particles. In some implementations, the activation may be performed such that the surface area (e.g., the BET-SSA) falls within a desired range. The BET-SSA measurement may be carried out on a sample (a population) of precursor carbonaceous particles and the obtained BET-SSA value averages over the population; particle-to-particle variations in the BET-SSA values are not measured. In some designs, the activation involves so-called “physical activation”. In some implementations, the “physical” activation is carried out in an environment (“activation environment”) that includes one or more of H₂O, CO₂, and O₂ in a temperature range of about 700° C. to about 1300° C. (in some cases, in a range from about 850° C. to about 1150° C.). In some designs, the activation environment can additionally include inert (or largely inert in this temperature range) diluent gas. In some designs, the activating may be carried out under agitation (e.g., in an agitating reactor). Some examples of agitating reactors suitable for carrying out (physical) activation are fluidized-bed reactor (FBR), rotary kiln, moving-bed reactor, vertical shaft kiln, stirred-tank reactor, and multiple hearth furnace. In some examples, the use of a fluidized-bed reactor (FBR) is preferred for (physical) activation.

In some designs, a chemical activation is used instead of or in addition to a physical activation of the precursor carbonaceous particles. In a chemical activation, a suitable chemical activation agent (e.g., zinc chloride (ZnCl₂), phosphoric acid, other acids or their various mixtures; potassium hydroxide (KOH), sodium hydroxide (NaOH), other bases and their various mixtures) is mixed with the precursor carbonaceous particles and heated above the melting point of activating agents (e.g., in a temperature range from about 350 to about 1100° C.) to induce additional porosity (e.g., produce additional pores, preferably primarily in a range from about 0.5 nm to about 100 nm) within precursor carbonaceous particles (e.g., by exfoliation of graphitic layers or by chemical reaction with carbon or by other means). In some implementations, the chemical activation is carried out under agitation (e.g., in an activation agitating reactor). In some implementations, the activation agitating reactor is selected from: a fluidized-bed reactor, a rotary kiln, a moving-bed reactor, a vertical shaft kiln, a stirred-tank reactor, and a multiple hearth furnace. In some examples, the use of a fluidized-bed reactor (FBR) is preferred for chemical activation.

For illustration, process 300 is described with respect to the formation of certain electrode (e.g., anode) particles. The concepts of process 300 including porosity enhancing (e.g., an activation) of carbon particles can be applied to other anode particles or with cathode particles that require activation of carbon particles.

In the example illustrated in FIG. 3, nanostructured or nano-sized silicon (Si) or silicon oxide (SiOₓ) or silicon nitride (SiN_{y}) or silicon oxy-nitride (SiOₓN_{y}) or silicon phosphide (SiP_{z}) particles (0<x<2; 0<y<1.3; 0<z<1) or their various combinations, alloys and mixtures are formed within the pores (and/or on the surface) of porous carbon or porous carbon-containing particles (e.g., mostly graphitic, sp²-bonded porous carbon or mostly graphitic, sp²-bonded carbon-containing particles). For example, stage 306 includes the formation of silicon-based active material particles at least in some of the pores of the porous carbon particles. The formation (e.g., by deposition or infiltration or deposition/infiltration of a Si-comprising precursor with the subsequent conversion to the final Si or Si-based material) of silicon-based active material particles in the porous carbon particles can be accomplished by solution-based or vapor-based deposition processes, in some examples, or by other suitable means. For brevity, the particles upon completion of stage 306 are sometimes referred to as silicon-carbon composite particles (with an understanding that elements other than Si and C may be present within such composite particles in some designs). In some embodiments, such composite particles comprise nano-sized or nanostructured elements (e.g., nano-sized or nanostructured Si, nano-sized or nanostructured C), which may be referred to as nanocomposite particles. In some implementations, the Si or Si-comprising material present in such nanocomposites may be in the form of nanoparticles. In some implementations, the mass-average size of Si or Si-comprising material nanoparticles may range from about 1 nm to about 200 nm (e.g., about 1-10 nm; about 10-30 nm; about 30-100 nm; about 100-200 nm), as measured using image analysis of electron microscopy (e.g., transmission electron microscopy (TEM), scanning transmission electron microscopy (STEM), scanning electron microscopy (SEM)), X-ray microscopy, X-ray diffraction, neutron scattering and other suitable techniques. In some designs, Si or Si-comprising nanoparticles formed within such Si-comprising composites (e.g., Si—C (nano)composites) may advantageously exhibit small average (e.g., mass-averaged) crystalline grain size (e.g., less than 10 nm, less than 5 nm, less than 4 nm, less than 3 nm, less than 2 nm, or less than 1 nm), including so-called “X-ray” amorphous Si or Si-comprising nanoparticles (e.g., with grain size in the range from about 0 nm to about 2.5 nm), as determined by X-ray diffraction or electron diffraction or TEM or other suitable technique.

At stage 306, silicon or silicon-comprising active material is deposited on and/or in the porous carbon-comprising particles to form silicon- and carbon-comprising (in some designs, primarily silicon-carbon) composite particles. In some implementations, the depositing of silicon or silicon-comprising active material (306) is carried out in a silicon deposition agitating reactor. In some implementations, the silicon deposition agitating reactor is selected from: a fluidized-bed reactor (FBR), a rotary kiln, a moving-bed reactor, a vertical shaft kiln, a stirred-tank reactor, and a multiple hearth furnace. In some examples, the use of a fluidized-bed reactor (FBR) is preferred for deposition of silicon or silicon-comprising active material. In some implementations, the depositing of silicon or silicon-comprising active material is carried out by thermal decomposition of a silicon-comprising gas in a temperature range of about 370° C. to about 750° C. Some examples of silicon-comprising gas are silane gas (e.g., SiH₄) and chlorosilane gas (e.g., SiHCl₃, SiH₂Cl₂, and SiH₃Cl). More broadly, in some implementations, the silicon-comprising gas is selected from: monosilane (sometimes referred to as “silane”) (SiH₄), disilane (Si₂H₆), trisilane (Si₃H₈), tetrachlorosilane (SiCl₄), trichlorosilane (SiHCl₃,), dichlorosilane (SiH₂Cl₂,), monochlorosilane (SiH₃Cl), and other silanes and other chlorosilanes. In some designs, silicon-comprising gas may be diluted with (mixed with) one or more other gas(es). In some designs, one or more other gas(es) may include one or more of: hydrogen (H₂), nitrogen (N₂), chlorine (Cl₂), HCl vapors. In some designs, the deposition of silicon may be conducted at near atmospheric pressure (e.g., at a pressure from about 0.5 atm to about 5 atm; or around 1 atm). In some designs, stage 306 includes depositing silicon in the porous carbon-comprising particles in an agitating reactor, to form silicon-carbon composite particles. In some designs, plasma enhancement of the decomposition reaction (PE-CVD) may be utilized to reduce Si deposition temperature to a lower range that is above room temperature, such as from about 150° C. to about 550° C.

In the example shown, stage 308 is carried out after stage 306. For example, stage 308 includes the formation of a protective coating on and/or in the silicon-carbon (Si—C) composite particles (from stage 306). In some designs, the suitable average thickness of the protective coating may range from about 0.2 nm to about 50 nm (about 0.2-2 nm; about 2-5 nm; about 5-10 nm; about 10-50 nm). In some designs, the true density of the protective coating may range from about 0.8 g/cc to about 4.8 g/cc or about 5.8 g/cc (e.g., about 0.8-1.6 g/cc; about 1.6-3 g/cc; about 3-4.5 g/cc; about 4.5-4.8 g/cc; or about 4.5-5.8 g/cc).

In some designs, the protective coating may comprise metal or semimetal oxide or oxy-carbide (including silicon oxide or silicon oxy-carbide). In some implementations, the protective material comprises one or more of the following: protective carbon, hydrocarbon, polymer, silicon oxide, silicon nitride, silicon phosphide, and ceramic material. In other examples, the protective material can comprise: silicon oxy-hydride, silicon phosphate, aluminum oxide, aluminum phosphide, aluminum phosphate, silicon aluminum phosphate, silicon-aluminum oxide, silicon-aluminum oxy-hydride, silicon fluoride, aluminum fluoride (AlF₃), lithium fluoride (LiF), lithium phosphate (Li₃PO₄), titanium oxide (TiO₂), or another Li-permeable ceramic material that is stable in air, and more preferably, stable in both water and in air, their mixtures and combinations.

In some designs, the protective coating may comprise or be based on electronically conductive material such as carbon. In some designs, such a carbon coating may be doped (e.g., with B, P, N, O and/or other elements). In some designs, the atomic fraction of individual dopants may range from about 0.01 at. % to about 10.01 at. % (e.g., about 0.01-0.1 at. %; about 0.1-1.0 at. %; about 1.0-5.0 at. %; about 5.0-10.01 at. %). In some designs, the protective coating may be largely impermeable to electrolyte solvent.

In some designs, carbon is selected as a protective material. Herein, carbons that are deposited during this protective material deposition step (stage 308), after silicon (or silicon-comprising material) deposition (stage 306), may be characterized as “protective carbon” to more readily distinguish from other carbons (e.g., carbon in the primary particles, at stage 306). In some implementations, the protective material includes protective carbon, and the forming of the protective material includes depositing protective carbon on and/or in the silicon- and carbon-containing (e.g., silicon-carbon) composite particles (more particularly, on the silicon of the composite particles). The protective material can be deposited in the pores in the composite particles as well on the outer surface of the composite particles; herein, the deposition in the pores and/or on the outer surface are referred to as deposition on the composite particles. In some implementations, the depositing of protective carbon on and/or in the silicon- and carbon-containing (e.g., silicon-carbon) composite particles (more particularly, on the silicon of the composite particles) is carried out by thermal decomposition of a carbon-comprising gas in a temperature range of about 380° C. to about 900° C. In some designs, plasma enhancement (e.g., radio-frequency, microwave, or pulsed plasma) may be utilized to reduce the decomposition temperature (e.g., down to a lower temperature for C deposition in a range of about 250-550° C.) or to increase the decomposition rate. Alternatively, a filtered cathodic vacuum arc process, which uses magnetic filters to remove macroscopic carbon from the plasma beam to enhance the quality of the deposited carbon, may be employed. Accordingly, a temperature range of about 250-800° C. can be employed for decomposition of carbon for carbon deposition. In some implementations, the depositing of protective carbon on and/or in the silicon- and carbon-containing (e.g., silicon-carbon) composite particles (more particularly, on the silicon of the composite particles) is carried out by thermal decomposition of a carbon-comprising gas in a temperature range of about 450° C. to about 800° C. or about 400° C. to about 700° C. In some implementations, carbon can be deposited by thermal decomposition of a carbon-comprising gas at temperatures greater than about 900° C. In some implementations, the protective carbon layer includes two or more sublayers. In some designs, the deposition of one of the sublayers may be carried out in a first temperature range and the deposition of another one of the sublayers may be carried out in a second temperature range that may be different from or overlap the first temperature range. In some implementations, the carbon-comprising gas is selected from: alkanes (e.g., methane, ethane, propane), alkenes (e.g., ethylene, propylene, butylene), dienes (e.g., butadiene), alkynes (e.g., acetylene, propyne), and aromatic hydrocarbons (e.g., benzene). Some illustrative gases are propylene, ethylene, acetylene, methane, and natural gas. In some implementations, the depositing of protective carbon is carried out under agitation (e.g., in a carbon deposition agitating reactor). In some implementations, the carbon deposition agitating reactor is selected from: a fluidized-bed reactor (FBR), a rotary kiln, a moving-bed reactor, a vertical shaft kiln, a stirred-tank reactor, and a multiple hearth furnace. Even in a convergent reaction such as chemical vapor deposition (CVD) of carbon, in some designs, the mixing of the particles in an agitating reactor may enable more uniform deposition. In some implementations, the protected silicon- and carbon-containing (e.g., silicon-carbon) composite particles, after forming of the protective material (e.g., deposition of protective carbon), are characterized by a Brunauer-Emmett-Teller specific surface area (BET-SSA) of smaller than about 1000 m²/g. In some implementations, the protected silicon-carbon pre-comminution particles, after forming of the protective material (e.g., deposition of protective carbon) or upon completion of the operations in process 300 (e.g., stages 302, 304, 306, 308, 310), are characterized by a Brunauer-Emmett-Teller specific surface area (BET-SSA) of smaller than about 50 m²/g, such as in a range of about 0.25-0.5 m²/g to about 50 m²/g (e.g., about 0.25-25 m²/g, about 0.5-20 m²/g, about 0.5-18 m²/g, about 0.5-15 m²/g, about 0.5-12 m²/g, about 0.5-9 m²/g, about 0.5-5 m²/g, about 0.5-2 m²/g; about 2-4 m²/g; about 4-5 m²/g; about 5-7 m²/g; about 7-9 m²/g, about 9-12 m²/g; about 12-18 m²/g; about 18-30 m²/g; about 30-50 m²/g). In some implementations, the carbon is deposited (e.g., under agitation), to obtain composite particles (e.g., comprising Si and C) with reduced specific surface areas accessible to air, slurry, or electrolyte (e.g., BET-SSA in a range of about 0.25-25 m²/g).

During operation of a Li-ion battery cell (e.g., 100 in FIG. 1), the protective coating may reduce or prevent direct contact between the silicon nanoparticles and an electrolyte solvent composition. In some designs, direct contact between the electrolyte solvent composition and the silicon nanoparticles may undesirably accelerate degradation of the Li-ion battery cell.

In the example shown, stage 310 is carried out after stage 308. For example, stage 310 includes making changes to the particle size distribution (PSD). Stage 310 may include carrying out comminution on the protected silicon-carbon composite particles (from stage 308). Comminution may be carried out when the particle sizes are larger (on average) than a final desired (e.g., for a slurry and electrode processing) particle size distribution. Various processes of carrying out comminution are known in the art. For example, the comminution can be carried out by one or more of: ball milling, jet milling, attrition milling, pin milling, and hammer milling. In some implementations, it may be preferable to carry out particle size selection during stage 310. In some cases, stage 310 can include particle size selection (e.g., by sieving or by screening or by centrifugation or by other aerodynamic size classification or by other means) in addition to comminution. In some cases, stage 310 can include particle size selection without comminution. For example, it may be preferable to retain some of the larger particle sizes and discard the finer particle sizes. The particle size selection may be carried out by any one of suitable processes known to those skilled in the art, such as screening, sieving, and aerodynamic size classification.

The foregoing process stage 310 includes examples, such as comminution and particle size selection, of making changes to a particle size distribution (PSD) of a population of particles. In some cases, it may be preferable to employ additional or alternative processes for changing or adjusting a PSD, such as mixing two or more populations of particles wherein each of the populations has a PSD different from others of the populations. For example, particle populations of different PSDs may be obtained (e.g., obtained from a supplier or made to different PSDs including employing the aforementioned processes of comminution and/or particle size selection under different processing conditions).

In some implementations, upon completion of process 300, the D₅₀ of the population's PSD is in a range of about 2.0 μm to about 16.0 μm (e.g., 2.0-4.0 μm, about 4.0-6.0 μm, about 6.0-8.0 μm, or about 8.0-16.0 μm). In some embodiments, (D₉₀-D₁₀)/D₅₀ may preferably be in the range from about 0.5 to about 6 (e.g., about 0.5-1, about 1-2, about 2-4, about 4-6). Smaller value of a PSD span (more narrow particle size distribution) may be advantageous in some designs (e.g., in low or mid. % blended anode where graphite provides 30-90% (in some designs, 50-90%) of the total capacity and Si—C or other types of Si-comprising materials provide the remaining 10-70% of the total anode capacity (in some designs, 10-50%)). Narrow PSD often may allow one to attain lower BET-SSA (and often reduce surface area available for undesirable side reactions) and superior cycle stability, high temperature storage, service life and other attractive characteristics of Li-ion battery cells comprising Si in the anodes.

Note, however, that in some designs, too small value of the PSD span, particularly too small value of left PSD span (too narrow particle size distribution), may lead to mechanical instabilities in the anode. Anodes with a higher % of capacity provided by Si—C (nano)composite particles (or, more broadly, by suitable Si-comprising particles) and/or higher wt. % of Si in the anode and/or larger capacity of Si—C (nano)composite particles and/or larger average particle size (D₅₀) of Si—C (nano)composite particles (or, more broadly, by suitable Si-comprising particles) may benefit from a larger value of the PSD span (particularly left PSD span) to attain superior performance in Li-ion battery cells. A combination of two, three or more factors above makes it even more important to fine-tune the PSD (e.g., make it sufficiently broad) and the PSD span to attain superior Li-ion battery cell performance. In particular, having sufficiently broad PSD and sufficiently large PSD span, particularly sufficiently large left PSD span (e.g., by having sufficient volume of particles that are sized 2-10 times smaller than D₅₀) was found to be beneficial for the following cases and even more so in case of their various combinations, in some designs: (1) when 30-100% (even more so when 40-100%, 50-100%, 60-100%, 70-100%, 80-100%, or 90-100%) of the total capacity in the anode is provided by Si—C (nano)composite particles (or, more broadly, by suitable Si-comprising particles) and smaller remaining fraction of 0-70% (e.g., 0-60%, 0-50%, 0-40%, 0-30%, 0-20%, or 0-10%) provided by graphite or graphitic carbon; (2) when Si—C (nano)composite particle capacity is relatively high (e.g., 1600-1800 mAh/g, 1800-2000 mAh/g, 2000-2200 mAh/g, 2200-2400 mAh/g, 2400-2600 mAh/g, or 2600-2800 mAh/g) and 20-30% or more of anode capacity is provided by Si—C in half cell measurements; (3) when high wt. % of Si (e.g., element or nanoparticles) is present in the anode such as 5-80 wt. % (e.g., 5-10 wt. %, 10-20 wt. %, 20-30 wt. %, 30-40 wt. %, 40-50 wt. %, 50-60 wt. %, 60-80 wt. %); (4) when D₅₀ of Si—C (nano)composite particles exceeds 5 micron (e.g., when D₅₀ is in the range of 5-7 micron, even more so when 7-9 micron, even more so when 9-12 micron, even more so when 12-15 micron, even more so when in excess of 15 micron) and 20-30% or more of anode capacity is provided by the Si—C (nano)composite particles (e.g., according to half cell measurements). Note that the optimal PSD depends on the combination of multiple parameters, such as: Si wt. % in the Si—C (nano)composite particles; mass fraction of Si—C (nano)composite particles in the anode; capacity (e.g., first-cycle lithiation capacity) of the anode active material (e.g., mixture of Si—C (nano)composite particles and graphite particles); Si wt. % in the anode; areal capacity loading; type and amount of binder; type, size distribution, shape, mechanical properties and amount of graphite or graphitic carbon; type, size distribution, shape, mechanical properties and amount of Si—C (nano)composite particles, BET-SSA of graphite, BET-SSA of Si—C (nano)composite particles, among many others as well as the specific key performance requirements for the Li-ion battery cells comprising Si in the anode. It is also important to note that while elimination of very large (e.g., Si—C) particles (e.g., reducing Do or D₉₀ or D₉₈ or D₉₉ or reducing the right PSD span) does not typically reduce mechanical stability of the anode (may only slightly increase BET-SSA), but the elimination of smaller (e.g., Si—C) particles (e.g., excessively increasing D₂, D₁₀ or D₂₀ or reducing the left PSD span) may negatively affect cell performance (e.g., reduce stability) in spite of the subsequent BET-SSA reduction, in some designs (e.g., particularly in so-called “high Si %” blended anode where graphite or graphitic carbon provides only 0-70% (e.g., 0-50% or 0-30%) of the total capacity and Si—C or other types of Si-comprising materials provide the remaining 30-100% of the total anode capacity (e.g., 50-99% or 70-97%). In particular, in some of such designs, it may be advantageous for the D₂₀ of Si—C particles to range from about 20% to about 70% of D₅₀ (e.g., about 20-50%, about 20-30%, about 30-40%, about 40-50%, about 50-60%, about 60-70%). In particular, in some of such designs, it may be advantageous for the D₁₀ of Si—C particles to range from about 10% to about 60% of D₅₀ (e.g., about 20-40%, about 10-20%, about 20-30%, about 30-40%, about 40-50%, about 50-55%, about 55-60%, about 60-70%). In particular, in some of such designs, it may be advantageous for the left PSD span ((D₅₀-D₁₀)/D₅₀) of Si—C particles to range from about 0.4 to about 0.95 (e.g., about 0.50-0.85; about 0.40-0.45; about 0.45-0.50; about 0.5-0.6; about 0.6-0.7; about 0.7-0.8; about 0.8-0.9; about 0.9-0.95). In particular, in some of such designs, it may be advantageous for the PSD span ((D₉₀-D₁₀)/D₅₀) of Si—C particles to range from about 0.95 to about 3 (e.g., about 1.15-2.25; about 1.25-2.5; about 0.95-1.15; about 1.15-1.25; about 1.25-1.5; about 1.50-1.75; about 1.75-2.0; about 2.0-2.25; about 2.25-2.5; about 2.5-2.75; about 2.75-3.00).

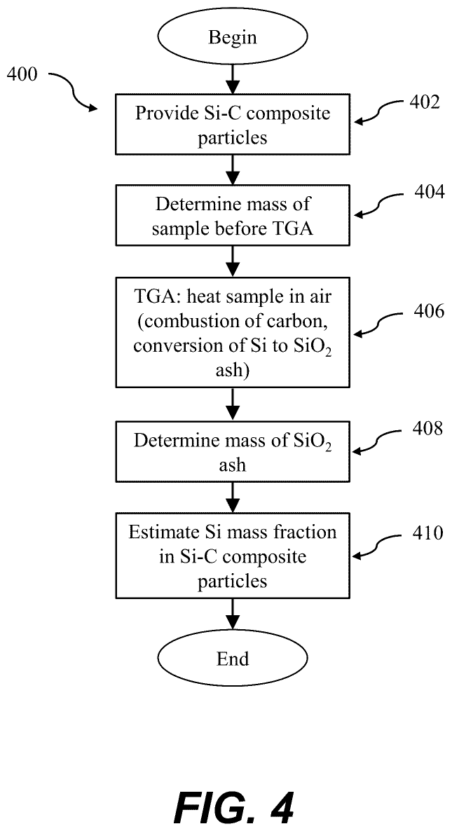

Various measurement techniques are available for determining the presence of certain constituents (e.g., atomic elements, molecules) in a material and for measuring the relative mass fractions of the respective constituents in the material. Some of these techniques are listed in the foregoing “Table of Techniques and Instrumentation for Material Property Measurements” in the sections for “Composition (e.g., mass fraction or wt. % of various atomic elements or molecules, atomic fraction or at. % of various elements).” One parameter of interest is the mass fraction of silicon in the Si—C (nano)composite particles. For example, inductively-coupled plasma optical emission spectroscopy (ICP-OES) is a measurement technique that can be used to measure the elemental composition of liquid or digested-solid samples with high sensitivity, including the detection of trace elements. In the case of Si—C (nano)composite particles in which the content of non-C, non-Si elements (e.g., oxygen, nitrogen, and dopants such as boron, phosphorus) is quite low (e.g., 5 wt. % or lower, 3 wt. % or lower, 1 wt. % or lower, 0.1 wt. % or lower, or 0.01 wt. % or lower), the Si mass fraction may be estimated quickly by employing a thermogravimetric analysis (TGA)-based process as outlined in FIG. 4. FIG. 4 illustrates a process 400, which includes stages 402, 404, 406, 408, and 410. At stage 402, a sample of Si—C (nano)composite particles (e.g., particles of a particular synthesis batch) is provided for analysis. At stage 404, the sample is dried and weighed to determine the mass before the subsequent TGA stage. At stage 406, TGA is carried out on the sample. The sample is dried and weighed before the heating protocol (the mass of the sample is referred to as mₛₐₘₚₗₑ). The sample (e.g., Si—C (nano)composite particles) undergoes a heating protocol in an oxidizing environment using a TGA instrument. In one example, the heating protocol is as follows: ramp from room temperature to a maximum temperature of 900° C. in air at a ramp rate of 40° C./min, hold at 900° C. for a heating period at maximum temperature of 60 min, and cool to 80° C. This heating protocol is sufficient to yield combustion of the carbon and conversion of the silicon to SiO₂. Other examples of heating protocols that may be employed include: (1) a maximum temperature in a range of about 900° C. to 1200° C. (e.g., 900° C., 1000° C., 1100° C., 1200° C.); (2) a ramp rate of not more than 20° C./min or in a range of 20° C./min to 50° C./min (e.g., 10° C./min, 20° C./min, 30° C./min, 40° C./min, 50° C./min); and (3) a heating period (at maximum temperature) in a range of 1 hour to 12 hours (e.g., 60 min, 2 hr, 4 hr, 8 hr, 12 hr). In some implementations, higher maximum temperatures and/or longer heating periods may provide even greater confidence that any carbides that are present (e.g., silicon carbides) will be fully oxidized and that all of the silicon nodes will be fully oxidized. Additionally, instead of cooling the furnace to 80° C., the furnace may be cooled to any temperature below 200° C. before the crucible is taken out. At stage 408, the residual ash, which is presumed to be substantially SiO₂ (e.g., SiO₂ mass fraction is at least 99 wt. %), is weighed (e.g., the mass of the ash mₐₛₕ is calculated as the mass of the crucible (sample holder) subtracted from the mass of the crucible and the ash, after the heating protocol). At stage 410, the mass fraction of Si in the Si—C (nano)composite particles w is estimated as follows:

$$w = \frac{{m}_{ash}}{{m}_{sample}} \frac{{M}_{Si}}{{M}_{{SiO}_{2}}} . \qquad ( Formula 1 )$$

Here, M_{Si} is the atomic mass of silicon (28.09) and M_{SiO2} is the molecular mass of SiO₂ (60.09). This calculation, which converts the mass of the ash to an estimated mass of Si before the TGA, assumes that (1) the content of oxidized silicon in the Si—C (nano)composite particles before the TGA is quite low (e.g., the content of oxidized silicon in the composite particles is 1 wt. % or lower), (2) the Si in the Si—C (nano)composite particles is substantially converted to SiO₂ during the TGA's heating protocol (e.g., at least 99 wt. % of the Si is converted to SiO₂), and (3) the residual ash is substantially SiO₂ (e.g., the SiO₂ is 99 wt. % or more of the residual ash). In some implementations, the content of oxidized silicon in the Si—C (nano)composite particles is indeed quite low; however, it is possible to quantify the oxygen content in a sample before the heating procedure using instrumental gas analysis (IGA) or another suitable technique, to correct for the presence of oxygen in the sample.

The TGA-based process as outlined in FIG. 4 may be employed to estimate the mean Si mass fraction in a sample of Si—C (nano)composite particles. In some implementations of Si—C (nano)composite particles, the mean Si mass fraction has been estimated to be in a range of 20 to 75 wt. % (e.g., 20-35 wt. %, 35-40 wt. %, 40-45 wt. %, 45-50 wt. %, 50-55 wt. %, 55-60 wt. %, 60-65 wt. %, 65-70 wt. %, 70-75 wt. %, 35-45 wt. %, 45-55 wt. %, 55-65 wt. %, 65-75 wt. %, 35-55 wt. %, 40-60 wt. %, or 45-65 wt. %). The TGA process of FIG. 4, while effective in estimating the mean Si mass fraction, does not yield information about the distribution of Si mass fractions in a population of Si—C (nano)composite particles. This limitation also holds true for other bulk elemental characterization techniques such as ICP-MS (inductively-coupled plasma mass spectrometry), ICP-OES, and XRF (x-ray fluorescence). Information about the distribution of Si mass fractions would be highly beneficial in improving (1) the processes for obtaining porous carbon particles for silicon deposition, and (2) the processes for depositing silicon in the porous carbon particles, among others.

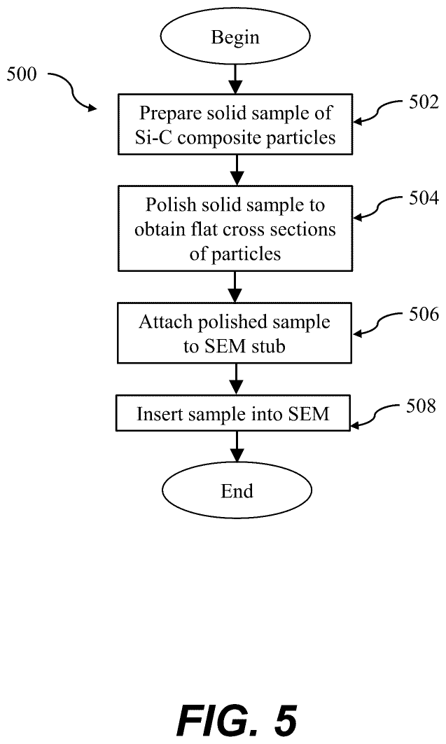

We have developed a technique for measuring the distribution of Si mass fractions in a sample of Si—C (nano)composite particles. This technique employs SEM-EDX (scanning electron microscopy with energy dispersive x-ray spectroscopy) analysis. We used a ThermoFisher Scientific Phenom ParticleX Desktop SEM operating at 10 kV with 75% spot size and a BSED detector for such studies. FIG. 5 is a flow diagram of a process 500 of preparing a pellet sample of silicon-carbon composite particles embedded in a Z-contrasting (atomic contrast) medium, for SEM-EDX. In other implementations, the process may be modified to form other solid samples in which silicon-carbon composite particles are (1) embedded in a Z-contrasting medium or (2) dispersed (preferably quite homogeneously) on a Z-contrasting substrate (e.g., metal foil). An example process 500 includes stages 502, 504, 506, and 508. At stage 502, a sample of Si—C (nano)composite particles is provided, dispersed (preferably quite homogeneously) with a suitable potting medium, and pressed using a pellet press. A potting medium may be selected that provides good Z-contrast (e.g., materials with atomic masses that are sufficiently different from Si and C). At stage 504, the pressed pellet is polished using a suitable polisher to obtain a flat cross section of particles (e.g., the Si—C (nano)composite particles). A polished, flat, cross-sectioned sample is preferably employed for EDX quantification. At stage 506, the polished pellet is attached to a suitable SEM stub. At stage 508, the sample including the polished pellet and the SEM stub is inserted into an SEM instrument with EDX capability. Alternatively, a suitable solid sample can be obtained by: (1) dispersing Si—C (nano)composite particles (preferably quite homogeneously) on a Z-contrasting substrate (e.g., metal foil); (2) attaching the sample of the composite particles dispersed on the Z-contrasting substrate to a suitable SEM stub, without any cross-sectioning of the composite particles; and (3) inserting the sample including the SEM stub into an SEM-EDX instrument. In this case, a sample without any particle cross sections may be employed for EDX quantification.

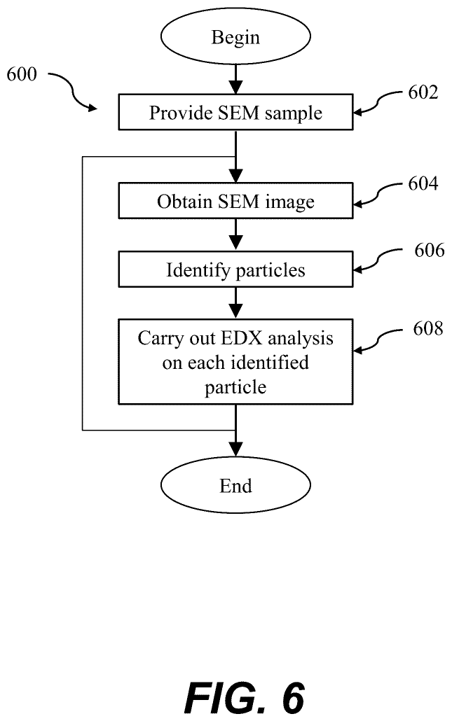

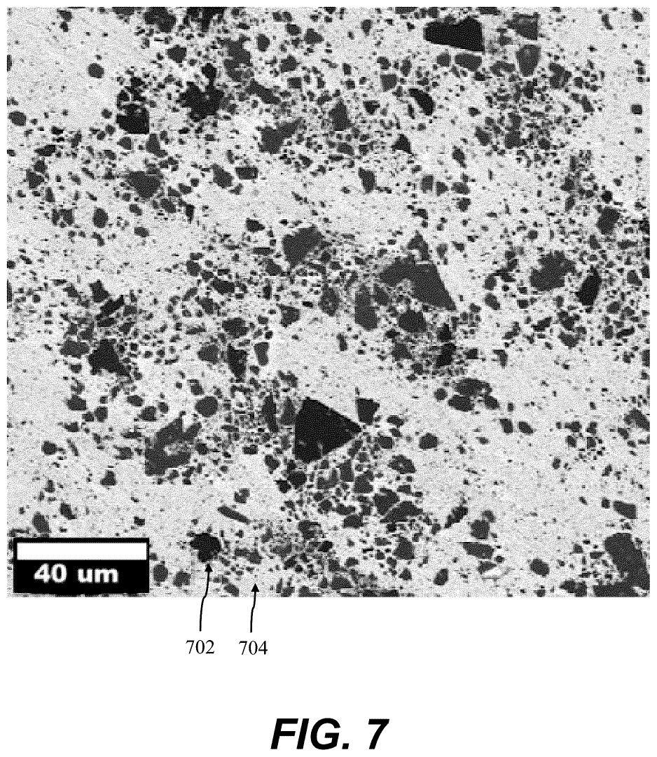

FIG. 6 is a flow diagram of a process 600 of carrying out SEM-EDX analysis on a sample of silicon-carbon composite particles, as prepared according to FIG. 5. Process 600 includes stages 602, 604, 606, and 608. Stage 602 includes providing a sample for analysis with the SEM-EDX. For example, this may be done by carrying out process 500. At stage 604, SEM images of the polished cross section of composite particles are obtained. FIG. 7 is an SEM image of a polished pellet sample of Si—C (nano)composite particles embedded in a potting medium. The SEM image shows a Z-contrast (atomic contrast) between the Si—C (nano)composite particles (darker shade, example shown as 702) and the potting medium (lighter shade, example shown as 704). Note that some of the darker shade areas could also be alumina particles (used in the polishing operation, 504) in this case. In this implementation, the Si—C (nano)composite particles appear in darker shade than the potting medium because the potting medium is heavier (greater atomic mass) than Si and C. In other implementations, if a potting medium that is lighter (relatively low atomic mass, e.g., polymer, epoxy, gallium) were employed, the potting medium would appear to have a lower contrast to the Si—C (nano)composite particles. Herein, the example Si—C (nano)composite particles had jagged shapes (e.g., having sharp edges and/or sharp uneven surfaces) but Si—C (nano)composite particles of other shapes (e.g., round, spheroidal) may also be employed in some implementations.

Stage 606 includes identifying particles meeting certain characteristics. Image analysis software may be employed to automatically identify the composite particles, in accordance with the gray-scale contrast (from the Z-contrast) between the composite particles and the background (e.g., potting medium or substrate). For a composite particle of interest, the cross-sectional diameter dₚₗᵤₘₑ of the electron beam (e-beam) (from the SEM) may be a relatively large fraction f of the size of the composite particle (e.g., “a relatively large fraction” may refer to 0.20 or greater, 0.25 or greater, 0.30 or greater, 0.35 or greater, 0.40 or greater, 0.45 or greater, 0.50 or greater, 0.55 or greater, 0.60 or greater, 0.65 or greater, 0.70 or greater, or 0.75 or greater). In such cases, the e-beams that “leak” out of the composite particle (e.g., the e-beams that are partially incident on the potting medium or substrate and partially incident on the composite particles) may make a meaningful contribution to the EDX data of the composite particle. It may be preferable to limit the contribution of the potting material to the EDX data. In the operation of the image analysis software, it may be preferable to exclude identified particles that are estimated to be smaller than a minimum particle size (e.g., diameter) dₘᵢₙ. In some examples, the cross-sectional diameter dₚₗᵤₘₑ of the e-beam is estimated to be 2 μm and the minimum particle size dₘᵢₙ is set to 3 μm. In this case, if the image analysis software estimates an identified particle to be less than 3 μm in size, the identified particle is excluded from subsequent EDX analysis. The identification of particles at stage 606 includes forming a masked region (e.g., rectangular mask) for each particle. Preferably, each masked region contains one and only particle. A masked region that contains two or more particles would be less preferable because the composition information that is obtained by EDX analysis would be an average for the two or more particles.

Stage 608 includes carrying out EDX analysis on the masked region containing the identified particle meeting certain characteristics (e.g., minimum size characteristics, as discussed above). EDX analysis is carried out to obtain composition information about the masked region. The composition information may include the content of certain atomic elements (e.g., C, O, Si, Al). If alumina is employed as a polishing material, residual alumina particles may be detected by corresponding Al signals in the EDX analysis. Such alumina particles may be excluded from the EDX data on Si—C (nano)composite particles. Other polishing materials may also be employed; however, it may be preferable to employ polishing materials that are different or distinguishable from the composition of interest. The potting medium is a material (e.g., metal, polymer, epoxy) that comprises none of C, Si, and Al, is readily detected by EDX, and offers good Z-contrast. Accordingly, the potting medium may be excluded from the EDX data on Si—C (nano)composite particles. For each masked region, the composition may be measured. In some examples, the mass fraction of Si may be calculated by dividing the wt. % value of the detected Si by the total wt. % value of detected C and Si.

Stage 608 may also include carrying out image analysis on the identified particle within the masked region. The image analysis may include obtaining size parameters (e.g., minimum Feret diameter, maximum Feret diameter, average diameter) and/or shape parameters (e.g., area, void area, perimeter, aspect ratio, roundness). Stage 608 may be carried out repeatedly, for multiple identified particles (masked regions) within a field of view of an SEM image (e.g., FIG. 7). Stages 604 (obtain SEM image), 606 (identify particles), and 608 (carry out EDX analysis, image analysis) may be repeated for multiple SEM images in an SEM sample. In order to obtain a statistical distribution of Si mass fractions, it may be preferable to obtain EDX data on a relatively large number (e.g., at least 200, at least 300, at least 500, at least 1000, at least 2000, at least 3000, at least 4000, at least 5000, or at least 1×10⁴) of Si—C (nano)composite particles, excluding extraneous particles (e.g., alumina particles). The mean Si mass fraction (Si wt. %) obtained by the TGA-based process as outlined in FIG. 4 can be correlated to the mean mass fraction of Si obtained by the SEM-EDX method outlined in FIG. 6; example results are shown in FIG. 25.

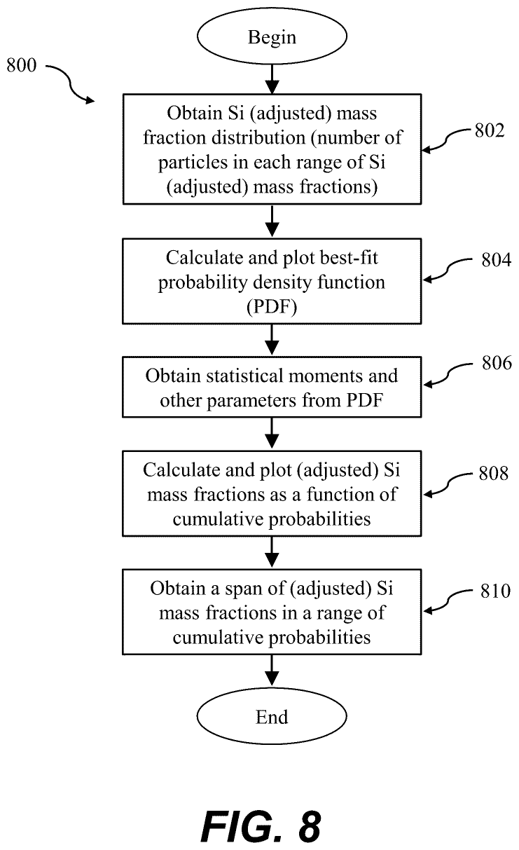

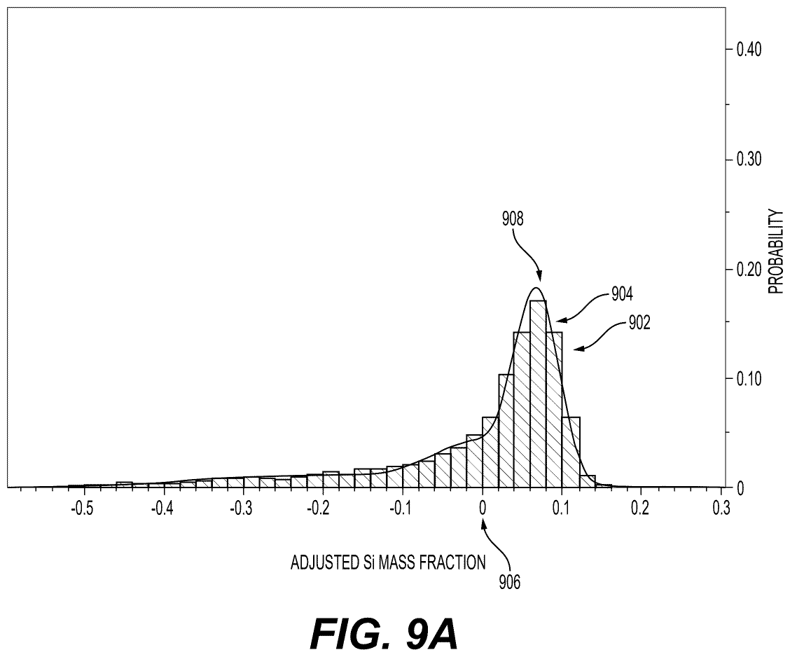

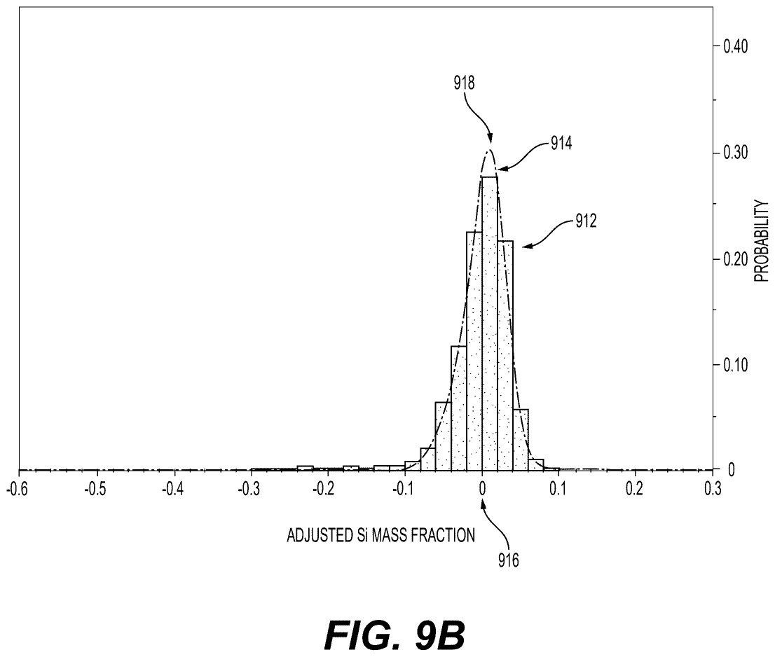

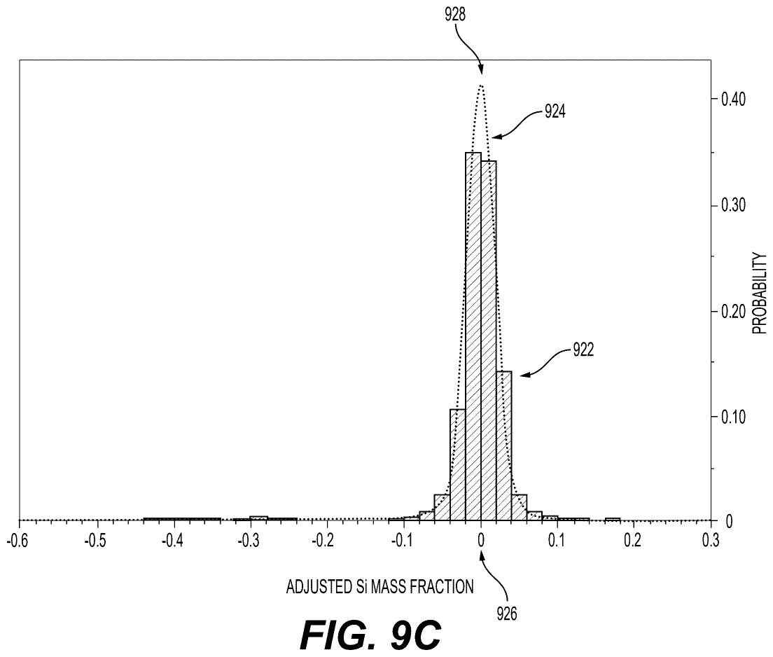

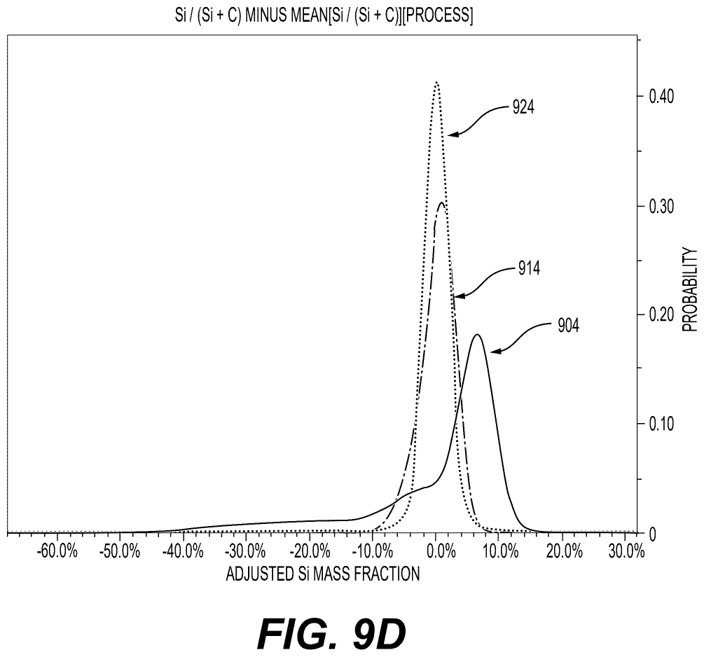

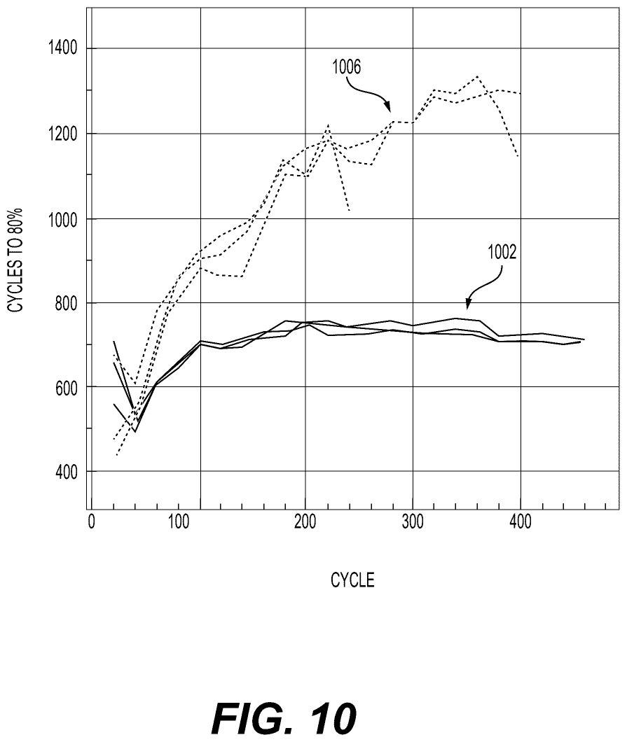

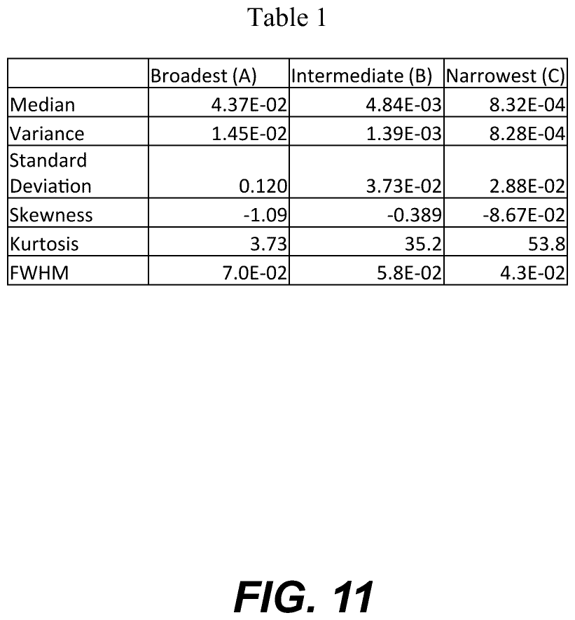

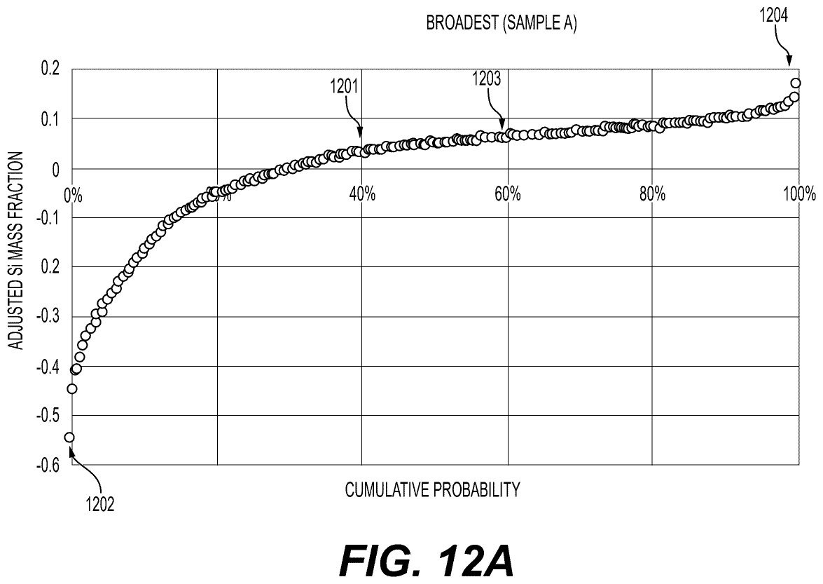

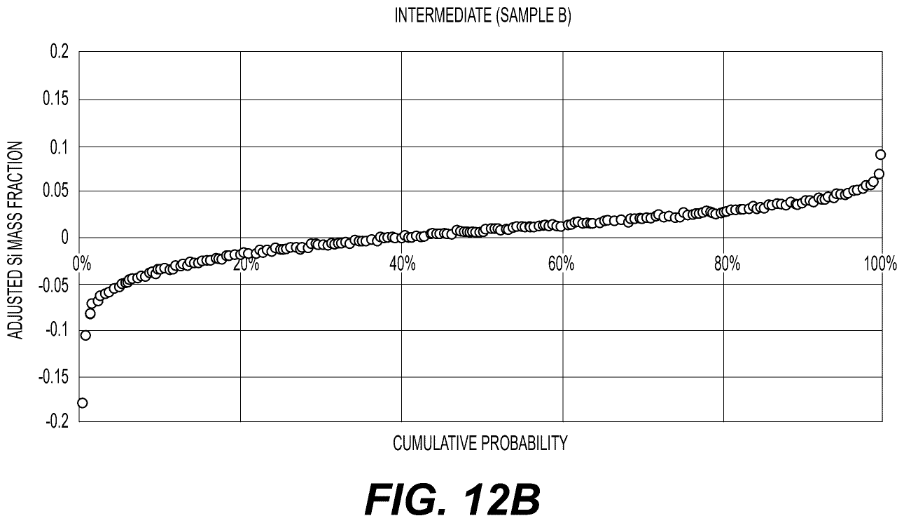

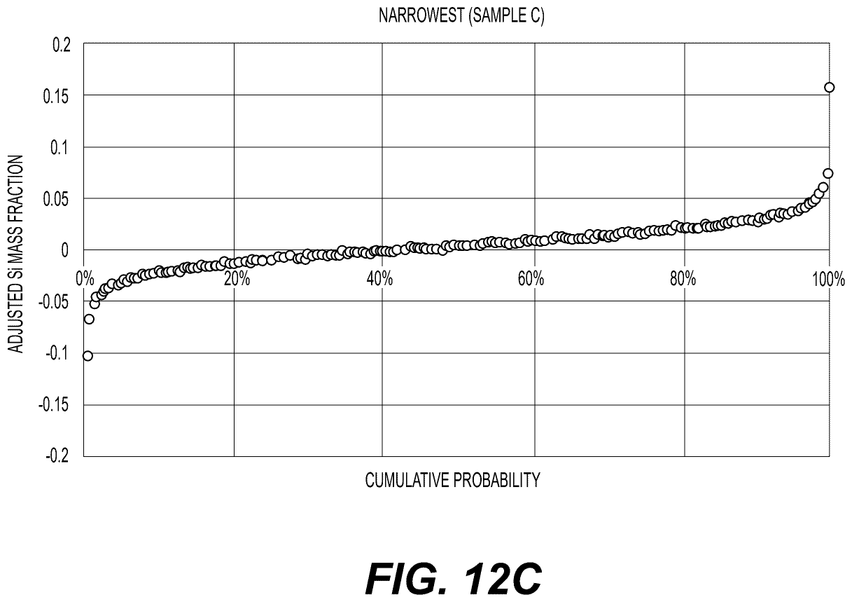

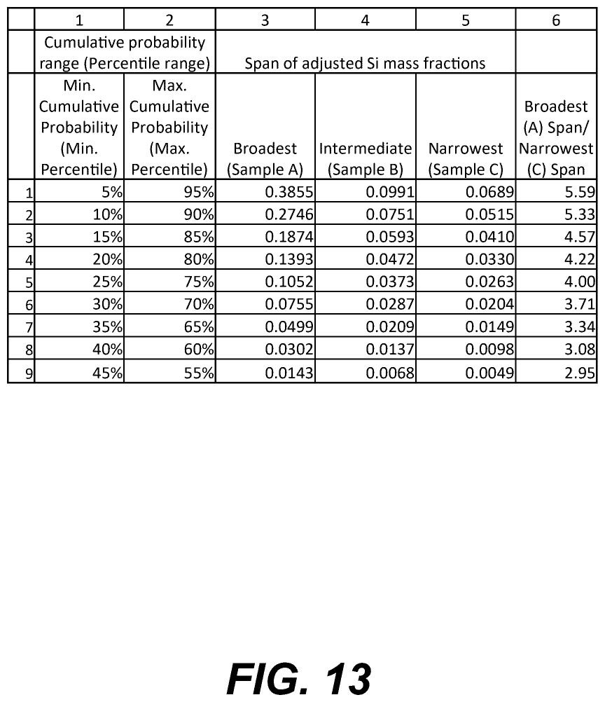

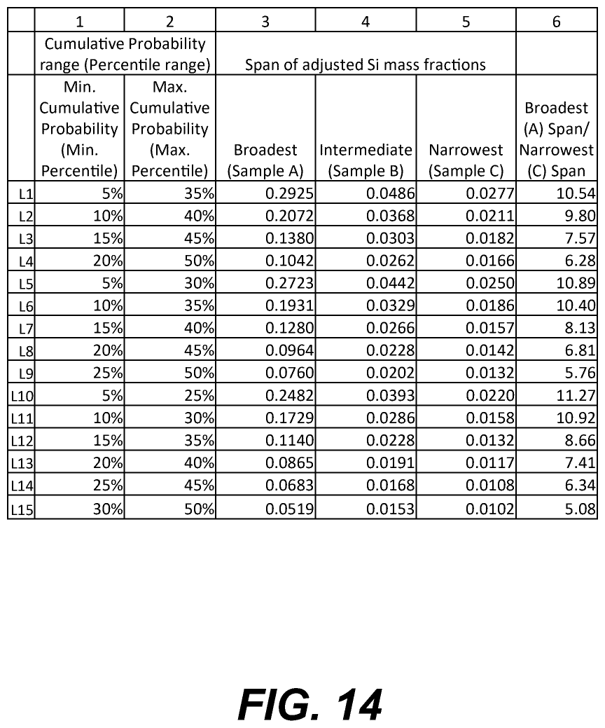

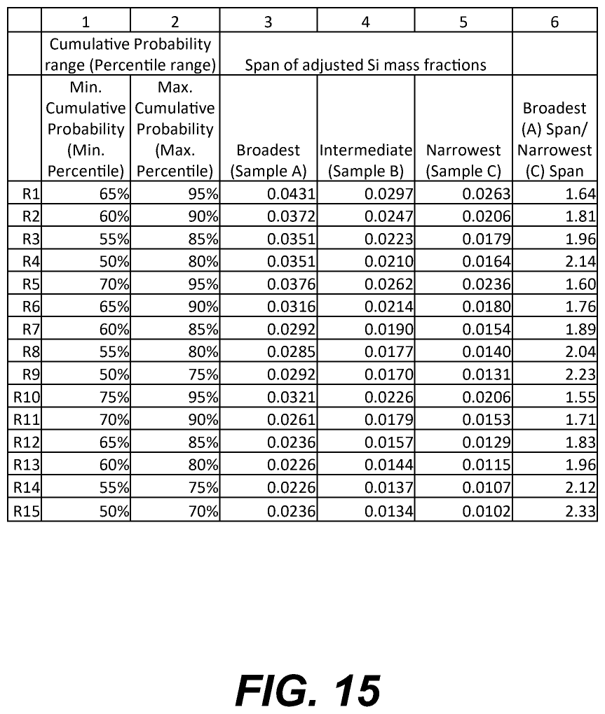

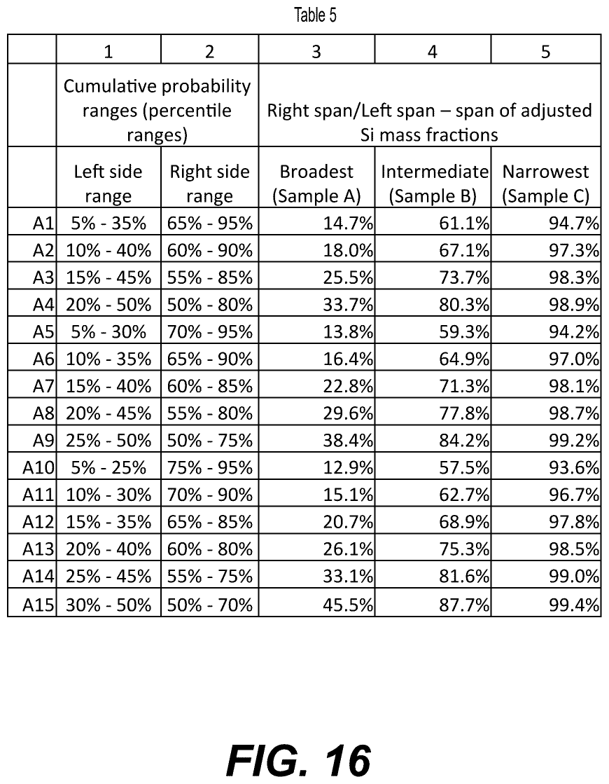

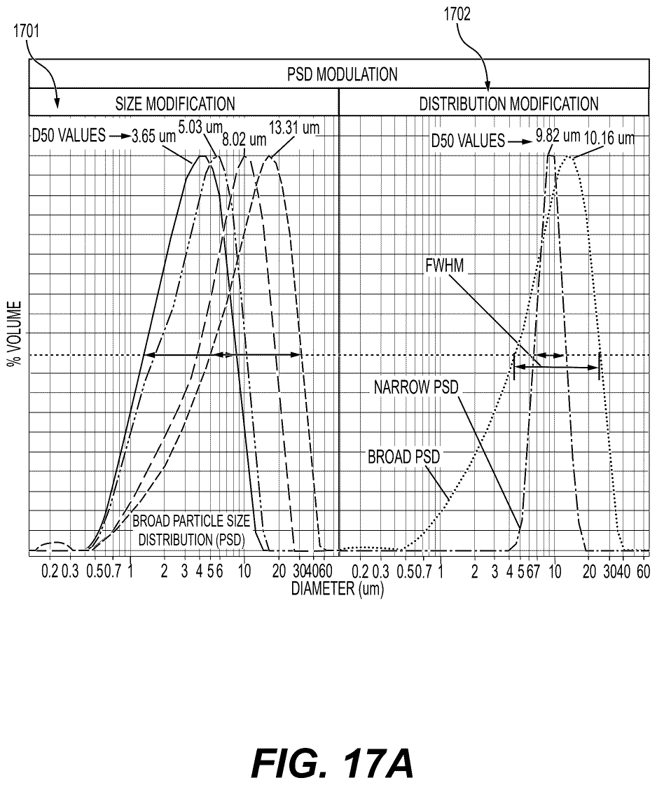

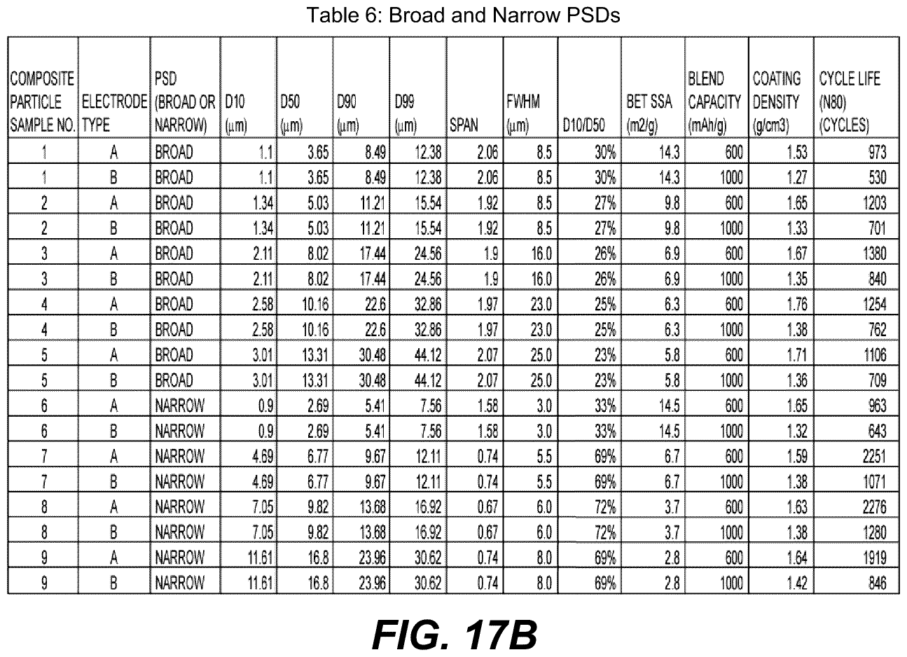

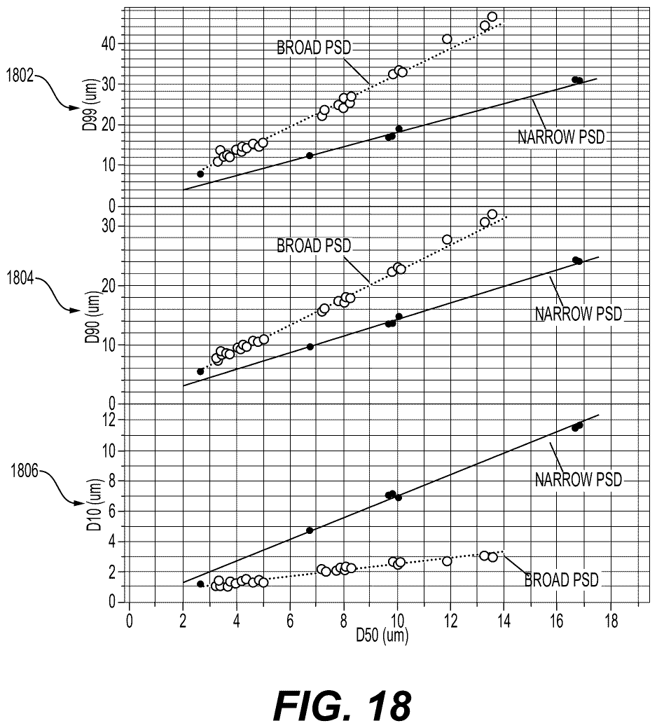

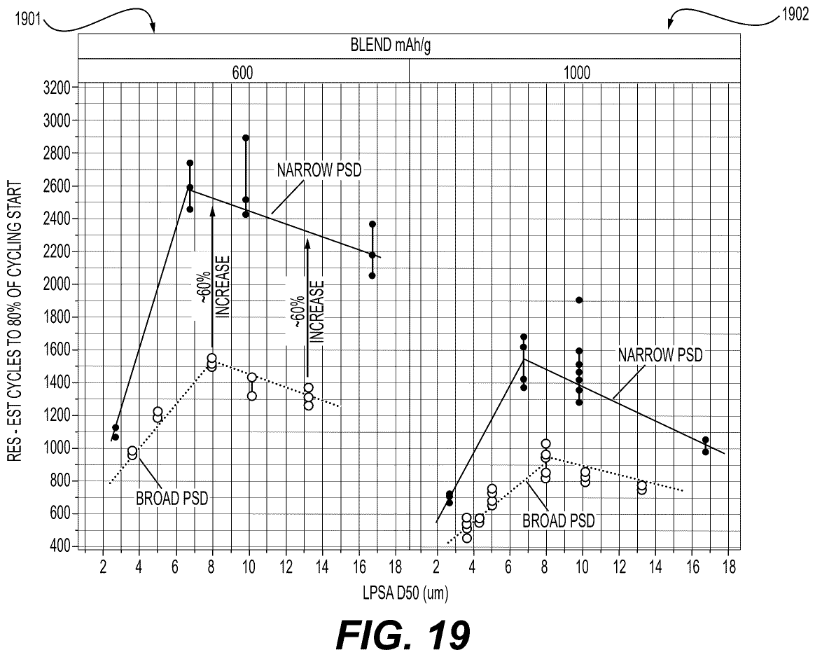

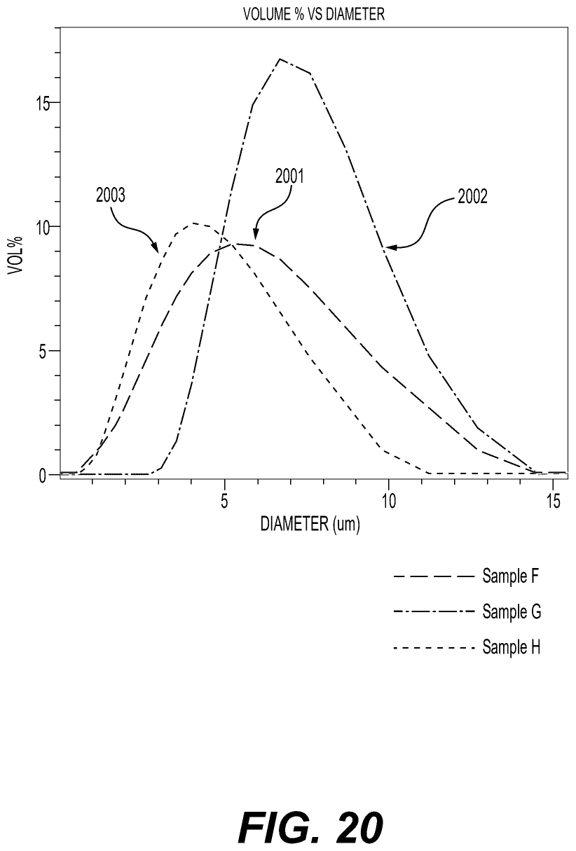

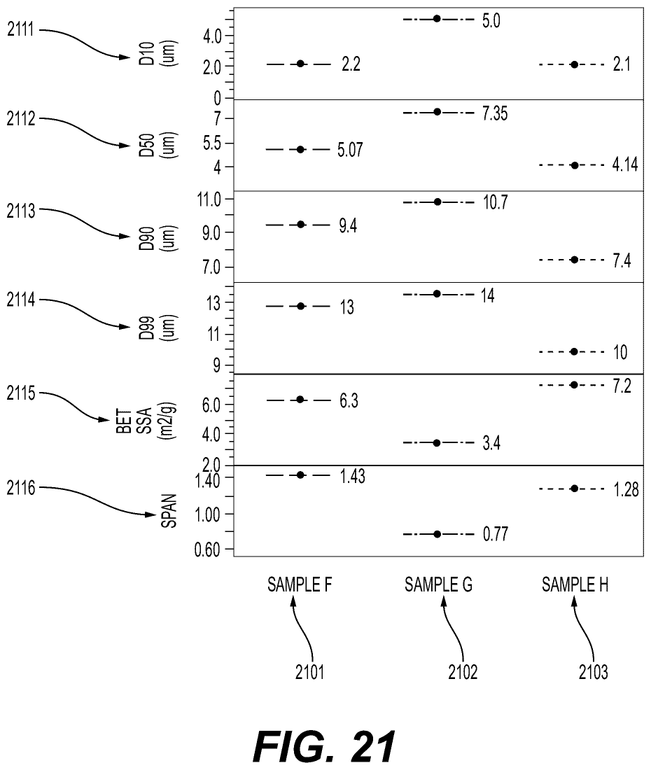

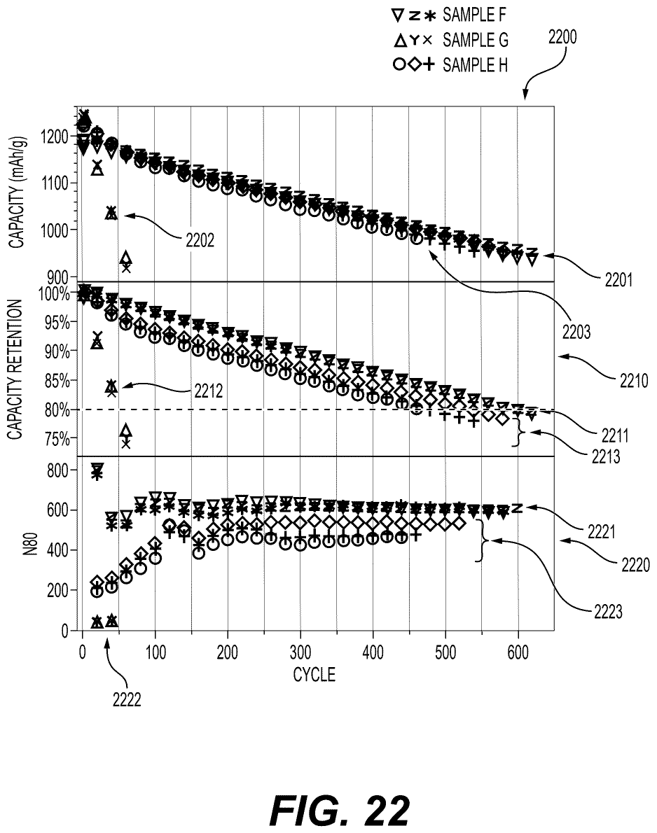

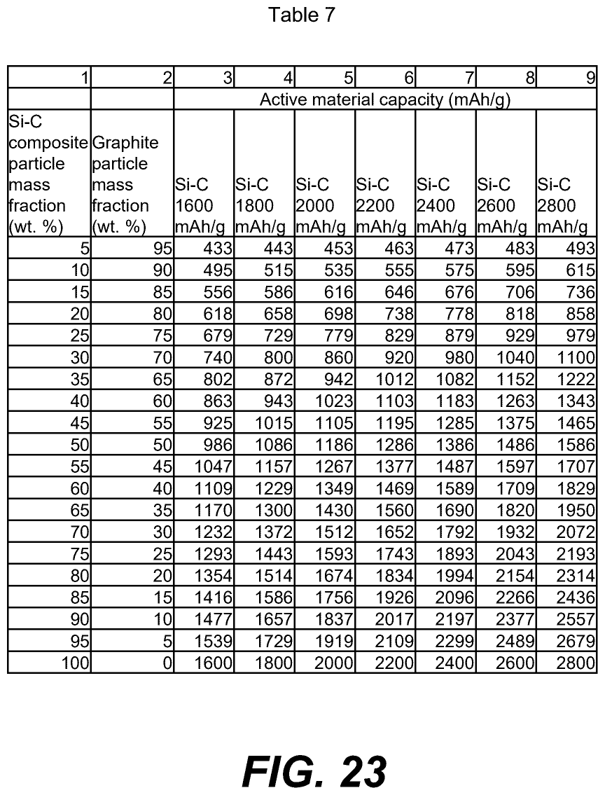

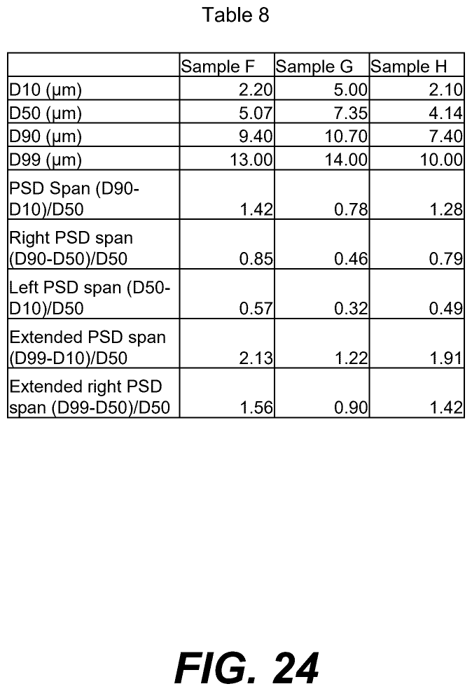

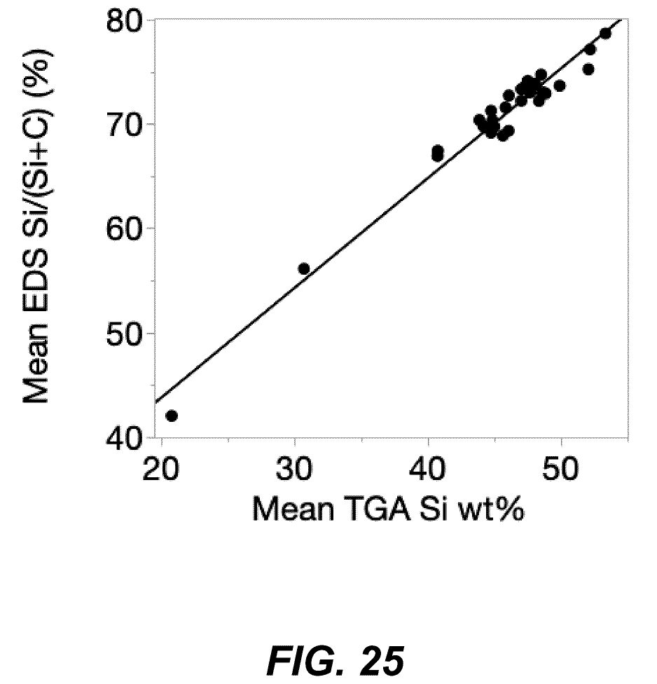

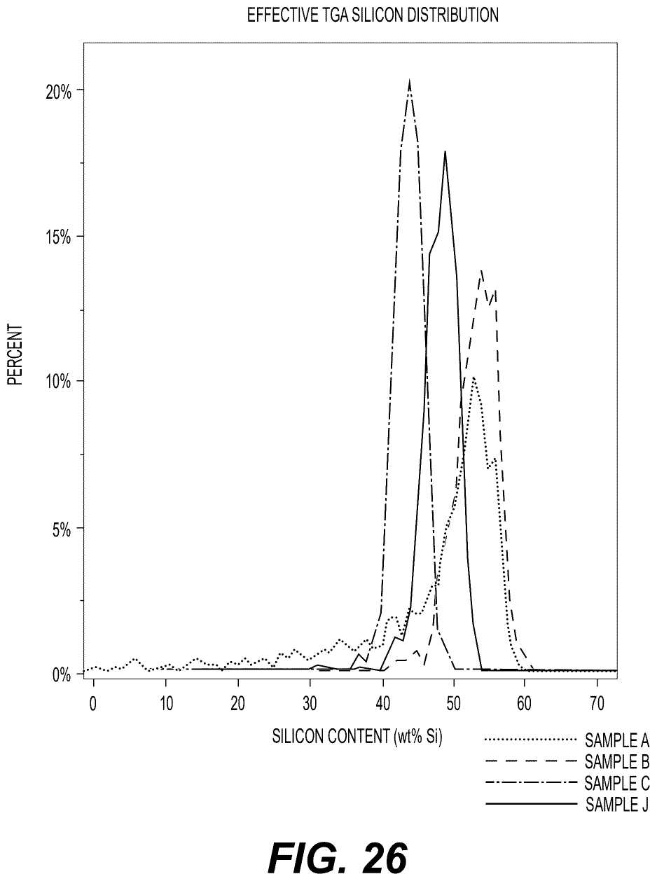

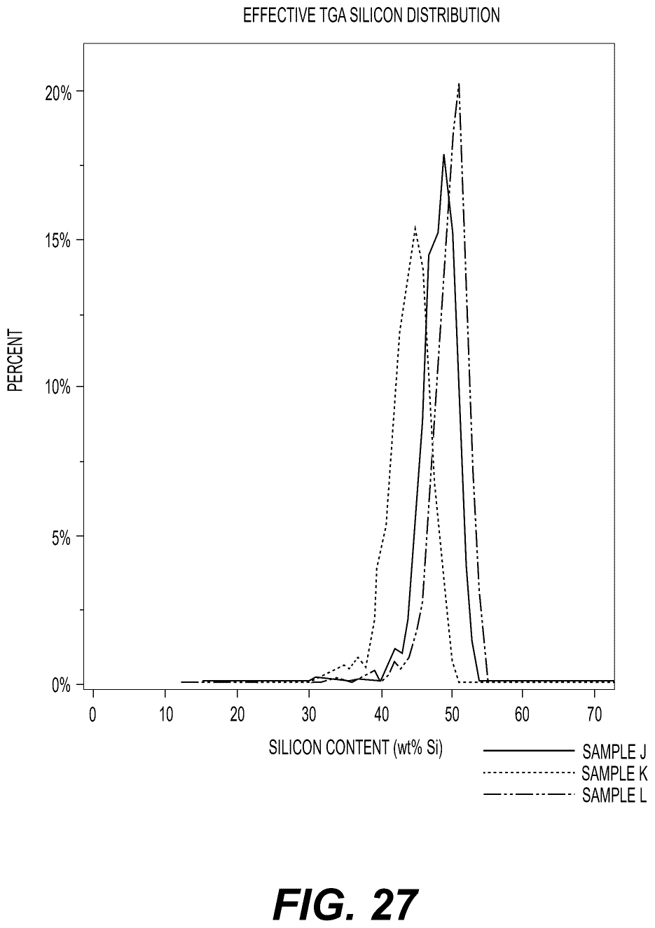

FIG. 8 is a flow diagram of a process 800 of carrying out statistical analysis on a silicon mass fraction distribution of a population of silicon-carbon composite particles. Process 800 includes stages 802, 804, 806, 808, and 810. Stage 802 relates to obtaining a Si mass fraction distribution, as described with reference to FIG. 6. The Si mass fraction distribution may be expressed as a number of as a particle count (e.g., Si—C (nano)composite particles) in each range of Si mass fraction. It is convenient to calculate an adjusted mass fraction of the silicon in a composite particle in a population of composite particles, as follows:

$$W = w - \overline{w} . \qquad ( Formula 2 )$$

Herein, W is the adjusted silicon mass fraction in the composite particle, w is a mass fraction of the silicon in the composite particles, and w is a mean of the mass fractions of the silicon in the composite particles of the population. The mean of the mass fractions is commensurate with zero on the adjusted Si mass fraction scale. One advantage of adopting the adjusted mass fraction for subsequent analysis is that multiple populations, which may exhibit different values of the means of the mass fractions, may be compared more readily.

Each of FIGS. 9A, 9B, and 9C includes a respective graphical plot 902, 912, 922 (shown in bar graph format). These bar graph plots are examples of adjusted Si mass fraction distributions obtained at stage 802. Each bar graph plot shows a distribution (a count of composite particles, in arbitrary units) as a function of the adjusted measured mass fractions of the silicon in the Si—C (nano)composite particles for respective populations of Si—C (nano)composite particles. FIGS. 9A, 9B, and 9C show data obtained from Samples A, B, and C of populations of Si—C (nano)composite particles, respectively.

FIG. 9A (902) has the broadest distribution, FIG. 9C (922) has the narrowest distribution, and FIG. 9B (912) has a distribution which is intermediate in span between those of FIGS. 9A and 9C. In these bar graph plots, each bar spans an adjusted mass fraction range of 0.02 (2 wt. %). It is possible to plot bar graph plots in which each bar spans a Si mass fraction (e.g., adjusted Si mass fraction) range that is smaller than or larger than 0.02 (2 wt. %). In bar graph plot 902, the peak 908 of the distribution is located to the right of the adjusted mass fraction of zero (906). The peak 908 of the distribution is at an adjusted Si mass fraction in a range of 6 to 8 wt. %. In bar graph plot 912, the peak 918 of the distribution is at an adjusted Si mass fraction in a range of 0 to 2 wt. %. In bar graph 922, the peak 928 of the distribution is at an adjusted Si mass fraction in a range of −2 to 2 wt. %. Accordingly, bar graph 902, which exhibits the broadest distribution is also the most asymmetrical distribution, and bar graph 922, which exhibits the narrowest distribution is also the least asymmetrical distribution, as determined by the deviation of the peaks of the distribution from the zero adjusted Si mass fractions. FIGS. 9A, 9B, and 9C represent EDX analysis data from about 5321, 2311, and 4598 Si—C (nano)composite particles. Detailed, quantitative analysis of the characteristics of these distributions may be carried out according to process 800.

Samples A, B, and C of Si—C (nano)composite particles were synthesized according to process 300. For each of these populations, biomass-derived porous carbon particles were procured from a supplier (stage 302). For the population of Sample A, physical activation (stage 304) was carried out in a rotary kiln, deposition of Si (stage 306) by chemical vapor deposition (CVD) was carried out in a static-bed reactor, and formation of a protective carbon (stage 308) was carried out in a static-bed reactor. For the population of Sample B, physical activation (stage 304) was carried out in a rotary kiln, deposition of Si (stage 306) by chemical vapor deposition (CVD) was carried out in a fluidized-bed reactor (FBR), and formation of a protective carbon (stage 308) was carried out in a fluidized-bed reactor (FBR). For the population of Sample C, physical activation (stage 304) was carried out in a fluidized-bed reactor (FBR), deposition of Si (stage 306) by chemical vapor deposition (CVD) was carried out in a fluidized-bed reactor (FBR), and formation of a protective carbon (stage 308) was carried out in a fluidized-bed reactor (FBR). Although a rotary kiln and a fluidized-bed reactor are both agitating reactors, a rotary kiln may segregate some particles during operation in some implementations, leading to greater particle-to-particle variations than for a fluidized-bed reactor. Samples A and B may exhibit broader (and more asymmetrical) adjusted Si mass fraction distributions than Sample C at least in part because of the use of the rotary kiln in activation. This suggests that particle-to-particle variations created during activation (e.g., particle-to-particle variations in pore characteristics such as pore volumes available for silicon insertion) may result in particle-to-particle variations in silicon mass fractions in the composite particles. Furthermore, the use of the FBR for silicon deposition for Samples B and C may be related to Samples B and C exhibiting narrower adjusted Si mass fraction distributions than Sample A. Also note that the use of FBR-type CVD reactors does not guarantee a uniform deposition of Si or a uniform deposition of C. It is important to ensure suitable deposition and agitation conditions to attain a high level of particle-to-particle uniformity.

Stage 804 includes calculating and plotting the best-fit probability density function (PDF) for a Si mass fraction (e.g., adjusted Si mass fraction) distribution. Each of FIGS. 9A, 9B, and 9C includes a line plot 904, 914, 924, respectively. Each of the line plots (904, 914, 924) is the best-fit PDF for the corresponding adjusted Si mass fraction distribution (902, 912, 922). A PDF is a plot of a probability as a function of the adjusted measured mass fractions of the silicon in the Si—C (nano)composite particles. The probability refers to a probability that a randomly-chosen composite particle will exhibit the respective adjusted mass fraction. For ease of comparison, the PDFs are shown side-by-side in FIG. 9D. One can readily observe from FIG. 9D that (1) PDF 904 has the broadest distribution and the lowest height at its peak (lowest probability), (2) PDF 924 has the narrowest distribution and the tallest height at its peak (highest probability), and (3) PDF 914 has an intermediate span and an intermediate height at its peak (intermediate probability) between those of 904 and 924.

FIG. 10 shows graphical plots of the predicted number of cycles to reach 80% of the cycling-start discharge capacity (sometimes abbreviated as N80), as a function of number of cycles (room-temperature cycling), for two groups of lithium-ion battery cells. The cycling-start discharge capacity is defined as the discharge capacity upon completion of cycle 3 (cycle number including formation cycles). In some implementations, the fully assembled cells undergo galvanostatic cycling using a testing system (e.g., Arbin LBT Series Tester). In some examples, a standard formation cycling protocol includes two charge/discharge cycles with a 10-hour charge (constant current, C/10) and 10-hour discharge (constant current, C/10) times. The charge portion of each charge/discharge cycle starts at the bottom of charge (e.g., 2.5 V) and ends at top of charge (e.g., 4.20 V). In some examples, a charge/discharge cycle according to a standard (long-term) cycling protocol includes a 1-hour charge step (constant current, 1C) followed by a constant voltage (CV) step with a taper to a current density of C/20, and 1-hour discharge step (constant current, 1C), wherein the charge portion of each cycle starts at the bottom of charge (e.g., 2.5 V) and ends at top of charge (e.g., 4.20 V). In the examples shown, the formation cycling and the long-term (standard) cycling are carried out at room temperature. There are two groups of lithium-ion battery test cells represented in FIG. 10: (1) Group 1 cells incorporating the Si—C (nano)composite particles of Sample A (broadest adjusted Si mass fraction distribution) and graphite particles in a mass ratio of about 50:50, and (2) Group 2 cells incorporating the Si—C (nano)composite particles of Sample C (narrowest adjusted Si mass fraction distribution) and graphite particles in a mass ratio of about 50:50. N80 values for Group 1 cells are shown as plots 1002. N80 values for Group 2 cells are shown as plots 1006. Notably, the N80 values for Group 1 cells are trending toward a range of about 650 to about 750 cycles, while the N80 values for Group 2 cells are trending above 100 cycles (e.g., a range of about 1100 to about 1300 cycles). The greater lifetimes of Group 2 cells compared to Group1 cells may be attributable to the narrower and more symmetrical adjusted Si mass fraction distributions.

The fabrication and testing of the lithium-ion battery test cells reported in FIG. 10 is as follows. Li-ion battery cells were produced using: (i) anodes with the active material being a mixture of Si—C nanocomposite particles and graphite particles in a 50:50 mass ratio (average Si mass fraction values in the composite particles were in a range of about 40 to 60 wt. %) casted on Cu current collector foil from a water-based suspension comprising the following solids: about 95.2 wt. % of active materials, a carboxymethylcellulose/styrene-butadiene rubber (CMC/SBR) binder (about 1.7 wt. % CMC, 3 wt. % SBR), and about 0.1 wt. % Tuball carbon nanotube conductive additive dispersion, (ii) a cathode comprising about 94 wt. % LiNi_{0.8}Co_{0.1}Mn_{0.1}O₂ (NCM-811) active material (with specific reversible capacity of about 200 mAh/g when normalized by the weight of NCM-811 active materials in the cathode) casted on Al current collector foil from an organic solvent suspension comprising a PVDF—based binder (about 2 wt. %) and Super P carbon black (about 4 wt. %) conductive additive, matched with the anode at anode: cathode (negative-to-positive, NP) areal capacity ratio of about 1.1:1 and areal reversible capacity loading of about 3.8 m Ah/cm², (iii) a polymer-ceramic separator, and (iv) an LiPF₆-based electrolyte comprising: about 13.92 wt. % LiPF₆, about 13.33 wt. % fluoroethylene carbonate (FEC, fluorinated cyclic carbonate), about 3.85 wt. % ethyl methyl carbonate (EMC, linear carbonate), about 5.04 wt. % ethylene carbonate (EC, cyclic carbonate), about 62.49 wt. % dimethyl carbonate (DMC, linear carbonate), about 0.85 wt. % lithium difluorophosphate, and about 0.52 wt. % vinylene carbonate (VC, cyclic carbonate). All electrochemical (ECT) tests were performed using Arbin Instruments LBT battery cyclers, running MITS X PRO software. Cycling was obtained using a voltage range of 2.5-4.2V at a 1C charge (with voltage hold to 0.05 C) and 1C discharge, with capacity check cycles using a 0.5 C charge to 4.2 V, then a voltage hold to 0.05 C, followed by a 0.2 C discharge. Si—C nanocomposite particles with D₅₀ values in a range of 5 to 8 μm were used.

Stage 806 includes obtaining statistical moments and other parameters from a PDF (e.g., 904, 914, 924). Some statistical moments, such as mean (set to zero for the adjusted Si mass fraction distributions), median, variance, standard deviation (SD), skewness (Sk), and kurtosis (Ku) are useful for characterizing the PDFs. A full-width at half-maximum (FWHM) is also useful for characterizing the PDFs. Standard deviation (SD) is defined as a square root of the variance. The skewness of a distribution may be characterized as positively skewed (e.g., relatively large tail of larger values (values towards the right of the plot)) or negatively skewed (e.g., relatively large tail of smaller values (values towards the left of the plot)) or of zero skew. For example, one can observe that PDF 904 is negatively skewed. The skewness can be defined as follows:

$$Sk = \frac{3 ( Mean - Median )}{SD} . \qquad ( Formula 3 )$$

Kurtosis is based on the fourth moment about the mean and is computed as follows:

$$\frac{n ( n + 1 )}{( n - 1 ) ( n - 2 ) ( n - 3 )} {\sum }_{i = 1}^{n} {{ω}_{i}^{2} ( \frac{{x}_{i} - \overline{x}}{s} )}^{4} - \frac{3 {( n - 1 )}^{2}}{( n - 2 ) ( n - 3 )} . \qquad ( Formula 4 )$$

Herein, wᵢ is a weight term (=1 for equally weighted items). Using this Formula 4, a normal distribution has a kurtosis of 0. The kurtosis as calculated by Formula 4 may be referred to as the excess kurtosis.

FIG. 11 (Table 1) shows selected statistical moments (variance, standard deviation, skewness, kurtosis) and full-width at half-maximum (FWHM) of the probability density functions (PDFs) of Samples A (904), B (914), and C (924). PDF 904 (Sample A) exhibits the greatest variance (1.45×10⁻²), PDF 914 (Sample B) exhibits an intermediate variance (1.39×10⁻³), and PDF 924 (Sample C) exhibits the smallest variance (8.28×10⁻⁴). Greater lifetimes may be attributable to narrower distributions of adjusted Si mass fractions. Accordingly, in some implementations, it may be preferable for the variance of the distribution of adjusted mass fractions of the silicon in the composite particles to be 1.45×10⁻² or less (e.g., 1.4×10⁻² or less, 1.0×10⁻² or less, 7×10⁻³ or less, 5×10⁻³ or less, 3×10⁻³ or less, 2×10⁻³ or less, or 1.5×10⁻³ or less). In some implementations, it may be more preferable for the variance of the distribution of adjusted mass fractions of the silicon in the composite particles to be 1.39×10⁻³ or less (e.g., 1.3×10⁻³ or less, 1.2×10⁻³ or less, 1.1×10⁻³ or less, 1.0×10⁻³ or less, or 9×10⁻⁴ or less). In some implementations, it may be even more preferable for the variance of the distribution of adjusted mass fractions of the silicon in the composite particles to be 8.28×10⁻⁴ or less (e.g., 8×10⁻⁴ or less, 7×10⁻⁴ or less, 6×10⁻⁴ or less, 5×10⁻⁴ or less, or 4×10⁻⁴ or less).

According to Table 1 (FIG. 11), PDF 904 (Sample A) exhibits the greatest standard deviation (0.12), PDF 914 (Sample B) exhibits an intermediate standard deviation (3.73×10⁻²), and PDF 924 (Sample C) exhibits the smallest standard deviation (2.88×10⁻²). Greater lifetimes may be attributable to narrower distributions of adjusted Si mass fractions. Accordingly, in some implementations, it may be preferable for the standard deviation of the distribution of adjusted mass fractions of the silicon in the composite particles to be 0.12 or less (e.g., 0.11 or less, 0.10 or less, 9×10⁻² or less, 8×10⁻² or less, 7×10⁻² or less, 6×10⁻² or less, 5×10⁻² or less, or 4×10⁻³ or less). In some implementations, it may be more preferable for the standard deviation of the distribution of adjusted mass fractions of the silicon in the composite particles to be 3.8×10⁻² or less (e.g., 3.6×10⁻² or less, 3.4×10⁻² or less, 3.2×10⁻² or less, or 3.0×10⁻² or less). In some implementations, it may be even more preferable for the standard deviation of the distribution of adjusted mass fractions of the silicon in the composite particles to be 2.9×10⁻² or less (e.g., 2.8×10⁻² or less, 2.6×10⁻² or less, 6×10⁻⁴ or less, 5×10⁻⁴ or less, or 4×10⁻⁴ or less).

According to Table 1 (FIG. 11), PDF 904 (Sample A) exhibits the greatest FWHM (7.0×10⁻²), PDF 914 (Sample B) exhibits an intermediate FWHM (5.8×10⁻²), and PDF 924 (Sample C) exhibits the smallest FWHM (4.3×10⁻²). Greater lifetimes may be attributable to narrower distributions of adjusted Si mass fractions. Accordingly, in some implementations, it may be preferable for the FWHM of the distribution of adjusted mass fractions of the silicon in the composite particles to be 7.0×10⁻² or less (e.g., 6.8×10⁻² or less, 6.6×10⁻² or less, 6.4×10⁻² or less, 6.2×10⁻² or less, or 6.0×10⁻² or less). In some implementations, it may be more preferable for the FWHM of the distribution of adjusted mass fractions of the silicon in the composite particles to be 5.8×10⁻² or less (e.g., 5.6×10⁻² or less, 5.4×10⁻² or less, 5.2×10⁻² or less, 5.0×10⁻² or less, 4.8×10⁻² or less, 4.6×10⁻² or less, or 4.4×10⁻² or less). In some implementations, it may be even more preferable for the standard deviation of the distribution of adjusted mass fractions of the silicon in the composite particles to be 4.3×10⁻² or less (e.g., 4.2×10⁻² or less, 4.0×10⁻² or less, 3×10⁻² or less, or 2×10⁻² or less).

According to Table 1 (FIG. 11), shows PDF 904 (Sample A) exhibits the greatest magnitude of skewness (−1.09), PDF 914 (Sample B) exhibits an intermediate magnitude of skewness (−0.389), and PDF 924 (Sample C) exhibits the smallest magnitude of skewness (−8.67×10⁻²). Greater lifetimes may be attributable to less asymmetrical distributions of adjusted Si mass fractions. Accordingly, in some implementations, it may be preferable for the magnitude of the skewness of the distribution of adjusted mass fractions of the silicon in the composite particles to be 1.1 or less (e.g., 1.0 or less, 0.9 or less, 0.8 or less, 0.7 or less, 0.6 or less, 0.5 or less, or 0.4 or less). In some implementations, it may be more preferable for the magnitude of the skewness of the distribution of adjusted mass fractions of the silicon in the composite particles to be 0.39 or less (e.g., 0.35 or less, 0.30 or less, 0.25 or less, 0.20 or less, 0.15 or less, or 0.10 or less). In some implementations, it may be even more preferable for the magnitude of the skewness of the distribution of adjusted mass fractions of the silicon in the composite particles to be 0.09 or less (e.g., 8×10⁻² or less, 6×10⁻² or less, 4×10⁻² or less, or 2×10⁻² or less).

Stage 808 includes calculating and plotting the (adjusted) Si mass fractions as a function of cumulative probabilities. FIGS. 12A, 12B, and 12C are examples of such plots. FIGS. 12A, 12B, and 12C are graphical plots of the adjusted Si mass fractions as a function of cumulative probabilities in a range of 0 to 100%, corresponding to the probability density functions (PDFs) of Samples A, B, and C, respectively. FIGS. 12A, 12B, and 12C were obtained by further data manipulation of PDFs 904 (Sample A, broadest distribution), 914 (Sample B, intermediate distribution), and 924 (Sample C, narrowest distribution), respectively. In the example of FIG. 12A, the adjusted Si mass fraction is about 0.0276 at a cumulative probability of 40% (data point 1201). This may be interpreted in terms of a corresponding population of composite particles (Sample A) from which the PDF was derived: 40% of the population is expected to exhibit an adjusted Si mass fraction of about 0.0276 or less. FIG. 12A shows that the minimum adjusted Si mass fraction is about −0.548 (data point 1202 is at a cumulative probability of about 0%). Accordingly, 40% of the population (between the 0^{th} percentile and 40th percentile of the population) is expected to exhibit an adjusted Si mass fraction in a range of about −0.548 (−54.8%) to about 0.0276 (2.76%). FIG. 12A shows that the maximum adjusted Si mass fraction is about 0.163 (data point 1204 is at a cumulative probability of about 100%). Accordingly, 60% (between the 40^{th} percentile and 100^{th} percentile) of the population is expected to exhibit an adjusted Si mass fraction in a range of about 0.0276 (2.76%) to about 0.163 (16.3%).

Stage 810 includes obtaining (e.g., calculating) a span of (adjusted) Si mass fractions in a range of cumulative probabilities. This calculation may be carried out using the data obtained at stage 808, showing the dependence of the (adjusted) Si mass fractions on cumulative probabilities. Consider an example of calculating a span of adjusted Si mass fractions for the distribution of FIG. 12A, in a cumulative probability range between 40% and 60%. The adjusted Si mass fraction is about 0.0276 at a cumulative probability of 40% (40^{th} percentile) (data point 1201). The adjusted Si mass fraction is about 0.0578 at a cumulative probability of 60% (60^{th} percentile) (data point 1203). The span in adjusted Si mass fractions is about 0.0302 or 3.02% (i.e., 0.0578-0.0276) in a cumulative probability range of 40 to 60% (between the 40^{th} percentile and the 60th percentile). This calculation result is shown in Table 2 (FIG. 13) at row 8 and column 3.

Table 2 (FIG. 13) shows spans of the adjusted Si mass fractions distributions between minimum and maximum cumulative probabilities (minimum and maximum percentiles) for the probability density functions (PDFs) of Samples A (column 3), B (column 4), and C (column 5). In the examples shown, the minimum and maximum cumulative probabilities (minimum and maximum percentiles) are chosen to be symmetrical about a cumulative probability of 50% (50^{th} percentile). The minimum cumulative probabilities (minimum percentiles) are shown at column 1 and the maximum cumulative probabilities (maximum percentiles) are shown at column 2. Column 6 shows a comparison parameter, defined as a span of Sample A (broadest) adjusted Si mass fraction distribution divided by a span of the Sample C (narrowest) adjusted Si mass fraction distribution. The comparison parameters are in a range of 4.00 to 5.59 for the entries in rows 1 (5^{th} to 95^{th} percentile) to 5 (25^{th} to 75^{th} percentile), and in a range of 2.95 to 3.71 for the entries in rows 6 (30^{th} to 70^{th} percentile) to 9 (45^{th} to 55^{th} percentile). In this example, the comparison parameter may be employed to readily discern that the Sample A distribution has a greater span than the Sample C distribution. In some implementations, it may be preferable for a span of the adjusted Si mass fraction between a minimum percentile (column 1) and a maximum percentile (column 2) to be an approximate value of the span of the Sample A distribution (column 3) or less. In some implementations, it may be more preferable for a span of the adjusted Si mass fraction between a minimum percentile (column 1) and a maximum percentile (column 2) to be an approximate value of the span of the Sample B distribution (column 4) or less. In some implementations, it may be even more preferable for a span of the adjusted Si mass fraction between a minimum percentile (column 1) and a maximum percentile (column 2) to be an approximate value of the span of the Sample C distribution (column 5) or less. The following limitations are some examples. In some implementations, it may be preferable for (1) a span #1 of the adjusted Si mass fractions between a 5^{th} percentile and a 95^{th} percentile of the population to be 0.39 or less (e.g., 0.30 or less, or 0.20 or less), or (2) a span #2 of the adjusted Si mass fractions between a 10^{th} percentile and a 90th percentile of the population to be 0.28 or less (e.g., 0.20 or less, or 0.10 or less), or (3) a span #3 of the adjusted Si mass fractions between a 15^{th} percentile and an 85^{th} percentile of the population to be 0.19 or less (e.g., 0.15 or less, or 0.10 or less), or (4) a span #4 of the adjusted Si mass fractions between a 20^{th} percentile and an 80^{th} percentile of the population to be 0.14 or less (e.g., 0.10 or less, or 0.05 or less), or (5) a span #5 of the adjusted Si mass fractions between a 25^{th} percentile and a 75^{th} percentile of the population to be 0.11 or less (e.g., 0.10 or less, or 0.05 or less). In some implementations, it may be more preferable for (1) the span #1 to be 0.10 or less, or (2) the span #2 to be 7.6×10⁻² or less, or (3) the span #3 to be 6.0×10⁻² or less, or (4) the span #4 to be 4.8×10⁻² or less, or (5) the span #5 to be 3.8×10⁻² or less. In some implementations, it may be even more preferable for (1) the span #1 to be 6.9×10⁻² or less, or (2) the span #2 to be 5.2×10⁻² or less, or (3) the span #3 to be 4.1×10⁻² or less, or (4) the span #4 to be 3.3×10⁻² or less, or (5) the span #5 to be 2.7×10⁻² or less.

Table 3 (FIG. 14) and Table 4 (FIG. 15) show spans of the adjusted Si mass fractions between minimum and maximum cumulative probabilities (minimum and maximum percentiles), for the probability density functions (PDFs) of Samples A, B, and C. In Table 3, the cumulative probabilities are chosen to be 50% or less (50^{th} percentile or less); hence, Table 3 shows spans in the “left side” of the adjusted Si mass fraction distribution (e.g., span #L1 corresponds to a range of 5^{th} percentile to 35^{th} percentile). In Table 4, the cumulative probabilities are chosen to be 50% or more (50^{th} percentile or more); hence, Table 4 shows spans in the “right side” of the adjusted Si mass fraction distribution (e.g., span #R1 corresponds to a range of 65^{th} percentile to 95^{th} percentile). Table 3 and Table 4 are laid out in a manner similar to that of Table 2. The minimum cumulative probability (minimum percentile) and the maximum cumulative probability (maximum percentile) are shown in columns 1 and 2, respectively. The spans of the adjusted Si mass fractions distributions between minimum and maximum cumulative probabilities (minimum and maximum percentiles) for the probability density functions (PDFs) of Samples A, B, and C are shown in columns 3, 4, and 5, respectively. Column 6 shows a comparison parameter, defined as a span of Sample A (broadest) adjusted Si mass fraction distribution divided by a span of the Sample C (narrowest) adjusted Si mass fraction distribution.

Each pair of left-side cumulative probabilities (percentiles) (Table 3) and each corresponding pair of right-side cumulative probabilities (percentiles) (Table 4) are symmetrical about a cumulative probability of 50% (50^{th} percentile). For example, the ranges of cumulative probabilities (percentiles) for row #L1 (5^{th} to 35^{th} percentile) and row #R1 (65^{th} to 95^{th} percentile) are symmetrical about the 50^{th} percentile. For Sample A (broadest), span #L1 is about 0.2925 and span #R1 is about 0.0431. These values of the span are quite different. A span ratio is defined as (1) a left-side span divided by a right-side span (which is symmetrical to the left-side span about the 50^{th} percentile) if the left-side span is less than or equal to the right-side span, or (2) the right-side span divided by the left-side span if the right-side span is less than the left-side span. For all of the spans reported in Table 3 and Table 4, the right-side spans are less than the respective right-side spans (note the foregoing discussion about the skewness of the Sample A, B, and C distributions being negative). In these examples, a span ratio may be calculated as the right-side span divided by the left-side span. The span ratio #A1, corresponding to span #L1 (left-side span) and span #R1 (right-side span), is about 14.7%.

Span ratio values for each pair of left-side spans (Table 3) and right-side spans (Table 4) are shown in Table 5 (FIG. 16) for the probability density functions (PDFs) of Samples A (column 3), B (column 4), and C (column 5). The span ratios are in a range of about 12% to 46% for Sample A (broadest distribution), in a range of about 57% to about 88% for Sample B (intermediate distribution), and in a range of about 93.6% to about 99.4% for Sample C (narrowest distribution). A span ratio is one indicator of the degree of asymmetry of an adjusted Si mass fraction about the 50^{th} percentile: a span ratio of about 50% or less (e.g., 40% or less, 30% or less, or 20% or less) may indicate a relatively high degree of asymmetry and a span ratio in a range of about 90 to 100% (e.g., 92-100%, 94-100%, 96-100%, or 98-100%) may indicate a relatively low degree of asymmetry.

In some implementations, it may be preferable for a span ratio of the adjusted Si mass fraction between a left-side range (column 1) and a right-side range (column 2) to be in a range of an approximate value of the span ratio of the Sample A distribution (column 3) to 1.00. In some implementations, it may be more preferable for a span ratio of the adjusted Si mass fraction between a left-side range (column 1) and a right-side range (column 2) to be in a range of an approximate value of the span ratio of the Sample B distribution (column 4) to 1.00. In some implementations, it may be even more preferable for a span ratio of the adjusted Si mass fraction between a left-side range (column 1) and a right-side range (column 2) to be in a range of an approximate value of the span ratio of the Sample C distribution (column 5) to 1.00. The following limitations are some examples. In some implementations, it may be preferable for (A1) a span ratio #A1, which is (1-1) a span #L1 of the adjusted mass fractions between a 5^{th} percentile and a 35^{th} percentile of the population, divided by a span #R1 of the adjusted mass fractions between a 65^{th} percentile and a 95^{th} percentile of the population if the span #L1 is less than or equal to the span #R1, or (1-2) the span #R1 divided by the span #L1 if the span #R1 is less than the span #L1, to be in a range of 0.14 to 1.0 (e.g., 0.2-1.0, 0.3-1.0, 0.4-1.0, 0.5-1.0, or 0.6-1.0); or (A2) a span ratio #A2, which is (2-1) a span #L2 of the adjusted mass fractions between a 10^{th} percentile and a 40^{th} percentile of the population, divided by a span #R2 of the adjusted mass fractions between a 60^{th} percentile and a 90^{th} percentile of the population if the span #L2 is less than or equal to the span #R2, or (2-2) the span #R2 divided by the span #L2 if the span #R2 is less than the span #L2, to be in a range of 0.18 to 1.0 (e.g., 0.2-1.0, 0.3-1.0, 0.4-1.0, 0.5-1.0, or 0.6-1.0); or (A3) a span ratio #A3, which is (3-1) a span #L3 of the adjusted mass fractions between a 15^{th} percentile and a 45^{th} percentile of the population, divided by a span #R3 of the adjusted mass fractions between a 55^{th} percentile and a 85^{th} percentile of the population if the span #L3 is less than or equal to the span #R3, or (3-2) the span #R3 divided by the span #L3 if the span #R3 is less than the span #L3, to be in a range of 0.25 to 1.0 (e.g., 0.3-1.0, 0.4-1.0, 0.5-1.0, 0.6-1.0, or 0.7-1.0); or (A4) a span ratio #A4, which is (4-1) a span #L4 of the adjusted mass fractions between a 20^{th} percentile and a 50^{th} percentile of the population, divided by a span #R4 of the adjusted mass fractions between a 50^{th} percentile and an 80th percentile of the population if the span #L4 is less than or equal to the span #R4, or (4-2) the span #R4 divided by the span #L4 if the span #R4 is less than the span #L4, to be in a range of 0.33 to 1.0 (e.g., 0.4-1.0, 0.5-1.0, 0.6-1.0, or 0.7-1.0). In some implementations, it may be more preferable for (A1) the span ratio #A1 to be in a range of 0.61 to 1.0 (e.g., 0.7-1.0, 0.8-1.0, or 0.9-1.0), or (A2) the span ratio #A2 to be in a range of 0.67 to 1.0 (e.g., 0.7-1.0, 0.8-1.0, or 0.9-1.0), or (A3) the span ratio #A3 to be in a range of 0.73 to 1.0 (e.g., 0.8-1.0, or 0.9-1.0), or (A4) the span ratio #A4 to be in a range of 0.80 to 1.0 (e.g., 0.85-1.0, or 0.9-1.0). In some implementations, it may be even more preferable for (A1) the span ratio #A1 to be in a range of 0.94 to 1.0 (e.g., 0.96-1.0, or 0.98-1.0), or (A2) the span ratio #A2 to be in a range of 0.97 to 1.0 (e.g., 0.98-1.0), or (A3) the span ratio #A3 to be in a range of 0.98 to 1.0 (e.g., 0.99-1.0), or (A4) the span ratio #A4 to be in a range of 0.98 to 1.0 (e.g., 0.99-1.0).

FIG. 17A shows graphical plots 1701 and 1702 of volume-weighted particle size distributions (PSDs) (expressed in volume %) of example populations of jagged composite particles. Graphical plot 1701 shows the PSDs of example populations of respective D₅₀ values exhibiting relatively broad PSDs, before any optimization of the respective PSDs. Graphical plot 1702 shows (1) the PSD of an example population before any optimization of its PSD (D₅₀ of about 10.1 μm) and (2) the PSD of an example population after optimization of its PSD (D₅₀ of about 9.8 μm). The PSD optimization processes include removal of fine particles and removal of coarse particles. As a result of these PSD optimization processes, the PSD has changed from a relatively broader PSD (e.g., greater span, greater FWHM) to a relatively narrower PSD (e.g., smaller span, smaller FWHM). As illustrated in FIG. 17A, the FWHM refers to the full-width at half-maximum of the PSD distribution.

Table 6 (FIG. 17B) summarizes selected characteristics (D₁₀, D₅₀, D₉₀, D₉₉, PSD span, FWHM, D₁₀/D₅₀, BET-SSA) of example populations of jagged composite particles. Graphical plot 1701 shows the PSDs of (1) a population with a D₅₀ of about 3.65 μm, corresponding to composite particle sample #1 in Table 6; (2) a population with a D₅₀ of about 5.03 μm, corresponding to composite particle sample #2 in Table 6; (3) a population with a D₅₀ of about 8.02 μm, corresponding to composite particle sample #3 in Table 6; and (4) a population with a D₅₀ of about 13.31 μm, corresponding to composite particle sample #5 in Table 6. As indicated in Table 6, these population samples (#1, #2, #3, and #5) have not undergone any optimization of its PSD (so-called “broad” PSD). Graphical plot 1701 illustrates that populations of jagged composite particles with a range of D₅₀ values (e.g., in the example shown, ranging between about 3.65 to about 13.31 μm) with a relatively broad span (e.g., in a range of about 1.9 to about 2.07) may be obtained by tuning conditions for the synthesis of the composite particles and the comminution of larger particles into smaller particles. Populations that have not undergone PSD optimization (e.g., the samples shown in 1701) may have undergone comminution to obtain a desired average particle size (e.g., D₅₀), but have not undergone removal of fines and coarse particles.

Graphical plot 1702 shows the PSDs of (1) a population with a D₅₀ of about 9.82 μm, corresponding to composite particle sample #8 in Table 6; and (2) a population with a D₅₀ of about 10.16 μm, corresponding to composite particle sample #4 in Table 6. Graphical plot 1702 compares the span of a population of jagged composite particles that has not undergone PSD optimization (sample #4 with a span of about 1.97 and FWHM of about 23.0 μm) and the span of a population of jagged composite particles that has undergone PSD optimization (sample #8 with a span of about 0.67 and a FWHM of about 6.0 μm). Accordingly, graphical plot 1702 illustrates the sizable impact of carrying out PSD optimization (e.g., fines removal, coarse particles removal) on the span and the FWHM of populations of jagged composite particles.

In Table 6 (FIG. 17B), population sample #1, #2, #3, #4, and #5 have not undergone PSD optimization processes and are referred to as having “broad” PSDs. Population sample #6, #7, #8, and #9 have undergone PSD optimization processes and are referred to as having “narrow” PSDs. Each population sample was used in making blended anode electrodes of two types: type A and type B. Each population sample of jagged composite Si—C particles exhibited a specific first cycle lithiation capacity of about 1900 mAh/g (corresponding to a Si mass fraction in the Si—C (nano)composite particles of about 51 wt. %, with the remainder of the Si—C (nano)composite particles including carbon). In the examples shown, a blended anode electrode active material comprises a blended mixture of graphite particles and the respective jagged composite particles. In type A electrodes, the electrode active material exhibited a first cycle lithiation capacity of about 600 mAh and comprised about 16 wt. % of the respective jagged composite particles and about 84 wt. % of graphite particles. In type B electrodes, the electrode active material exhibited a first cycle lithiation capacity of about 1000 mAh and comprised about 42 wt. % of the respective jagged composite particles and about 58 wt. % of graphite particles. For each electrode type (type A, type B) of each population sample, a coating density measured after calendering is reported in Table 6. For each electrode type of each population sample, Li-ion battery cells were fabricated, and performance characteristics were evaluated. A cycle life is reported for Li-ion battery cells of each electrode type and each composite particle population. In some implementations of a blended anode (e.g., a blended mixture of Si—C (nano)composite particles and graphite particles), a mass fraction of the Si—C (nano)composite particles (e.g., jagged Si—C (nano)composite particles) in the battery electrode composition (excluding any binder) may be in a range of about 10 wt. % to about 70 wt. % (e.g., about 10-20 wt. %, about 20-30 wt. %, about 30-40 wt. %, about 40-50 wt. %, about 50-60 wt. %, or about 60-70 wt. %). In some implementations of a blended anode (e.g., a blended mixture of Si—C (nano)composite particles and graphite particles), a mass fraction of the graphite particles in the battery electrode composition (excluding any binder) may be in a range of about 30 wt. % to about 90 wt. % (e.g., about 30-40 wt. %, about 40-50 wt. %, about 50-60 wt. %, about 60-70 wt. %, about 70-80 wt. %, or about 80-90 wt. %).

Details of the preparation and testing of electrodes and Li-ion battery cells reported in Table 6 are as follows. For type A (˜600 mAh/g) electrodes, a water-based slurry containing a polyacrylic acid (PAA) salt copolymer-based binder (about 4 wt. %), single-walled carbon nanotubes (about 0.05 wt. %), and an anode electrode active material (about 95.95 wt. %) was coated onto a 10 μm-thick copper foil at an areal capacity loading of about 4.1 mAh/cm². The electrode active material (about 100 weight parts) was a blended mixture of Si—C (nano)composite particles (about 16 weight parts) and graphite particles (about 84 weight parts). The type A electrodes were calendered with an applied force of 16 tons to attain coating densities in a range of about 1.53 to about 1.76 g/cm³. For type B (˜1000 mAh/g) electrodes, a water-based slurry containing a polyacrylic acid (PAA) salt copolymer-based binder (about 6.6 wt. %), single-walled carbon nanotubes (about 0.1 wt. %), and an anode electrode active material (about 93.3 wt. %) was coated onto a 10 μm-thick copper foil at an areal capacity loading of about 4.1 mAh/cm². The electrode active material (about 100 weight parts) was a blended mixture of Si—C (nano)composite particles (about 42 weight parts) and graphite particles (about 58 weight parts). The type B electrodes were calendered with an applied force of 14 tons to attain coating densities in a range of about 1.27 to about 1.42 g/cm³. The electrodes were then assembled into single-layer pouch full cells (area of about 6.25 cm²) with a NCM811 (a lithium nickel manganese cobalt oxide (NCM) of approximate composition Li[Ni_{0.8}Co_{0.1}Mn_{0.1}]O₂) cathode, a 10 μm ceramic separator, and an electrolyte formulation comprising 13.92 wt. % of LiPF₆ (as a primary lithium salt), 13.33 wt. % of fluoroethylene carbonate (FEC), 5.04 wt. % of ethylene carbonate (EC), 3.85 wt. % of ethyl methyl carbonate (EMC), 62.49 wt. % of dimethyl carbonate DMC, 0.52 wt. % of vinylene carbonate (VC), and 0.85 wt. % of lithium difluorophosphate (LFO). After the electrolyte formulation was added to the Li-ion battery cell, the cell was cycled under the following charge/discharge test conditions. Charge/discharge test conditions comprise constant current, constant potential (CCCP) at 2 C charge to 4.0V and taper to 1 C, followed by the CCCP at 1 C charge to 4.2V and taper to 0.05 C, followed by 1 C discharge.

Table 6 (FIG. 17B) reports the cycle life performance of Li-ion battery cells obtained from each composite particle population and electrode type. For each composite particle population, cells with type A (˜600 mAh/g) electrodes exhibited greater cycle life values than cells with type B (˜1000 mAh/g) electrodes. Cycle life values of greater than 1900 cycles were measured in three of the “narrow” PSD samples: (1) population #7, electrode type A, D₁₀ of about 4.69 μm, D₅₀ of about 6.77 μm, a ratio D₁₀/D₅₀ of about 69%, span of about 0.74, BET-SSA of about 6.7 m²/g, 2251 cycles; (2) population #8, electrode type A, D₁₀ of about 7.05 μm, D₅₀ of about 9.82 μm, a ratio D₁₀/D₅₀ of about 72%, span of about 0.67, BET-SSA of about 3.7 m²/g, 2276 cycles; and (3) population #9, electrode type A, D₁₀ of about 11.61 μm, D₅₀ of about 16.8 μm, a ratio D₁₀/D₅₀ of about 69%, span of about 0.74, BET-SSA of about 2.8 m²/g, 1919 cycles. Cycle life values of another “narrow” PSD sample were not as good, e.g., population #6, electrode type A, D₁₀ of about 0.9 μm, D₅₀ of about 2.69 μm, a ratio D₁₀/D₅₀ of about 33%, span of about 1.58, BET-SSA of about 14.5 m²/g, 983 cycles. Population #6 exhibits a smaller D₁₀, a smaller D₅₀, a greater span, and a greater BET-SSA than the other “narrow” PSD populations #7, #8, and #9. For further comparison, the “broad” PSD populations implemented in type A electrodes exhibited cycle life values in a range of about 973 cycles to 1380 cycles. The “broad” PSD populations exhibited a D₁₀ in a range of 1.1 μm to 3.01 μm (corresponding to ratios D₁₀/D₅₀ in a range of 23 to 30%), a span in a range of about 1.9 to about 2.07, and BET-SSA in a range of about 5.8 to 14.3 m²/g. In some implementations, beneficial effects to cycle life (and other battery characteristics) may be observed when the span is less than about 2.1, less than about 1.9, less than about 1.8, less than about 1.5, less than about 1.2, less than about 1.0, or less than about 0.8. Additionally, in some implementations, the span may be greater than about 0.3, greater than about 0.5, or greater than about 0.6. In some implementations, beneficial effects to cycle life (and other battery characteristics) may be observed when the BET-SSA of the composite particles is less than about 15 m²/g, less than about 12 m²/g, less than about 10 m²/g, less than about 8 m²/g, less than about 7 m²/g, less than about 6 m²/g, less than about 5 m²/g, less than about 4 m²/g, or less than about 3 m²/g. Additionally, in some implementations, the BET-SSA may be greater than about 1 m²/g, greater than about 2 m²/g, greater than about 5 m²/g, or greater than about 8 m²/g. In some implementations, beneficial effects to cycle life (and other battery characteristics) may be observed when the D₁₀ is greater than about 0.5 μm, greater than about 1.0 μm, greater than about 1.5 μm, or greater than about 2.0 μm. In some implementations, beneficial effects to cycle life (and other battery characteristics) may be observed when the ratio D₁₀/D₅₀ is greater than about 35%, greater than about 45%, greater than about 55%, or greater than about 65%. Additionally, in some implementations, the ratio D₁₀/D₅₀ may be less than about 80% or less than about 75%.

FIG. 18 shows graphical plots 1802, 1804, and 1806 of selected PSD characteristics of example populations of jagged composite particles. Graphical plot 1802 shows the dependence of D₉₉ values on D₅₀ values of respective populations of jagged composite particles, illustrating trends among populations that have not undergone PSD optimization (so-called “broad” PSDs) and populations that have undergone PSD optimization (so-called “narrow” PSDs). Graphical plot 1804 shows the dependence of D₉₀ values on D₅₀ values of respective populations of jagged composite particles, illustrating trends among populations that have not undergone PSD optimization (so-called “broad” PSDs) and populations that have undergone PSD optimization (so-called “narrow” PSDs). Graphical plot 1806 shows the dependence of D₁₀ values on D₅₀ values of respective populations of jagged composite particles, illustrating trends among populations that have not undergone PSD optimization (so-called “broad” PSDs) and populations that have undergone PSD optimization (so-called “narrow” PSDs).

FIG. 19 shows graphical plots 1901 and 1902 showing the dependence of cycle life performance of Li-ion batteries (made with Si—C nanocomposite and graphite blended anode/NCM cathode) made using respective example populations of jagged composite particles in the anode on the D₅₀ values of the respective example populations. The fabrication and testing of electrodes and battery cells are as described herein with reference to the results shown in FIG. 17A and Table 1 (FIG. 17B). Graphical plots 1901 and 1902 illustrate trends among populations that have not undergone PSD optimization (so-called “broad” PSDs) and populations that have undergone PSD optimization (so-called “narrow” PSDs). In the examples shown, the Li-ion batteries employed anodes comprising a mixture of the jagged composite particles and graphite particles (“active material mixtures”). Graphical plot 1901 shows cycle life (N80) data of Li-ion batteries employing type A electrodes (˜600 mAh/g electrode active material capacity). Graphical plot 1902 shows cycle life data (N80) of Li-ion batteries employing type B electrodes (˜1000 mAh/g electrode active material capacity).

For a particular value of D₅₀ of the composite particle population and for particular electrode type (˜600 mAh/g or ˜1000 mAh/g electrode active material capacity), Li-ion battery cells employing “narrow” PSDs that have undergone PSD optimization exhibited greater cycle life data (N80) than Li-ion battery cells employing “broad” PSD that have not undergone PSD optimization. The improvement in cycle life (N80) by employing “narrow” PSDs is pronounced for type A electrodes (˜600 mAh/g electrode active material capacity), for which N80 is observed to increase by more than 60% to exceed 2400 cycles in some cases. The improvement of cycle life from employing “narrow” PSDs is also observed in type B electrodes, for which cycle life values (N80) are observed to increase by more than 60% in some cases. For a particular value of D₅₀ of the composite particle population, Li-ion battery cells with a lower capacity blended anode (˜600 mAh/g electrode active material capacity) typically resulted in longer cycle life (N80) relative to Li-ion battery cells with a higher capacity blended anode (˜1000 mAh/g electrode active material capacity) (FIG. 19). As the D₅₀ values increase starting from about 2˜3 μm, better cycling stability (e.g., greater cycle life (N80)) is initially observed, likely due to factors such as less frequent occurrences of side reactions between the electrolyte and the composite particles (e.g., as exemplified by smaller growth of SEI or solid-electrolyte interphase). This trend of increasing cycle life (N80) is observed until optimal ranges (e.g., about 6-9 μm, about 6-10 μm, about 6-12 μm) in the D₅₀ values are reached. As the D₅₀ values increase beyond optimal D₅₀ ranges, mechanical and other issues that limit cycle life may arise and the cycle life decreases to some extent. In some implementations, adoption of composite particles with “narrow” PSDs can significantly boost cycle stability (e.g., cycle life).

FIG. 20 shows graphical plots of the PSDs of three populations of Si—C (nano)composite particles. Plots 2001, 2002, and 2003 are PSDs of Samples F, G, and H, respectively. The y-axis shows the volume fraction (in arbitrary units) and the x-axis shows the D₅₀ of each sample population in μm.

More detailed information about the particle characteristics of Samples F, G, and His shown in FIG. 21. FIG. 21 shows selected PSD characteristics (D₁₀ at row 2111, D₅₀ at row 2112, D₉₀ at row 2113, D₉₉ at row 2114, PSD span at row 2116) and the BET-SSA (at row 2115) of Samples F (at column 2101), G (column 2102), and H (column 2103) of populations of Si—C (nano)composite particles. Among these three sample populations, Sample F exhibits the largest PSD span (1.43), Sample G exhibits the smallest PSD span (0.77), and Sample H exhibits a PSD span (1.28) that is intermediate between those of Samples F and G. The D₅₀ values of the samples, ordered from smallest to largest, are Sample H (4.14 μm), Sample F (5.07 μm), and Sample G (7.35 μm). The D₁₀ values of the samples, ordered from smallest to largest, are Sample H (2.10 μm), Sample F (2.20 μm), and Sample G (5.0 μm).

The three samples of Si—C (nano)composite particles (Samples F, G, H) were evaluated as anode active materials in lithium-ion battery test cells. The Si—C (nano)composite particles constitute about 100% of the anode active material, excluding binder, conductive additives, and other additives (no graphite particles were added to the anode active material). Selected results from these test cells are shown in FIG. 22. FIG. 22 shows graphical plots of the capacity (plot 2200), the capacity retention (expressed as a percentage of the cycling-start capacity) (plot 2210), and the estimated number of cycles to reach 80% of the cycling-start capacity (plot 2220), as a function of cycle number, for lithium-ion batteries with anodes employing Samples F, G, and H of Si—C (nano)composite particles. The first-cycle lithiation capacities of the lithium-ion battery test cells, as measured with respect to the mass of the respective anode active materials, were approximately 1600 mAh/g (Sample F), 1700 mAh/g (Sample G), and 1635 mAh/g (Sample H). The first-cycle efficiencies of the lithium-ion battery test cells were approximately 90.7% (Sample F), 89.5% (Sample G), and 90.0% (Sample H). The Sample F results are indicated as 2201 (plot 2200), 2211 (plot 2210), and 2221 (plot 2220). The Sample G results are indicated as 2202 (plot 2200), 2212 (plot 2210), and 2222 (plot 2220). The Sample H results are indicated as 2203 (plot 2200), 2213 (plot 2210), and 2223 (plot 2220). The Sample G test cells (among the three samples, smallest PSD span of 0.77 and largest D₁₀ of 5.0 μm) exhibited the worst performance, with the capacity and capacity retention degrading rapidly and an N80 value of about 50 cycles or less. The capacity, capacity retention, and N80 values were better for the Sample F and Sample H test cells. Between Samples F and H, the capacity, capacity retention, and N80 were better for the Sample F test cells (among the three samples, largest PSD span of 1.43 and second-to-smallest D₁₀ of 2.2 μm). Trends that may be observed in the data of FIG. 22 include: (1) the PSD span is preferably 0.85 or greater (e.g., 1.00 or greater, 1.15 or greater, 1.30 or greater, or 1.40 or greater) for some implementations; and (2) the D₁₀ is in a range of 1.0 to 4.0 μm (e.g., 1.0 to 3.5 μm, 1.0 to 3.0 μm, 1.0 to 2.5 μm, 1.5 to 3.5 μm, 1.5 to 3.0 μm, 1.5 to 2.5 μm, or 2.0 to 2.5 μm) for some implementations.

Li-ion battery test cells employing Samples F, G, and H of Si—C (nano)composite particles (at 100% of the anode active material) exhibited first-cycle lithiation capacities in a range of about 1600 to 1700 mAh/g. In other implementations, Si—C (nano)composite particles may exhibit other relatively high first-cycle lithiation capacities such as in a range of 1600 to 1800 mAh/g, in a range of 1800 to 2000 mAh/g, in a range of 2000 to 2200 mAh/g, in a range of 2200 mAh/g to 2400 mAh/g, in a range of 2400 mAh/g to 2600 mAh/g, in a range of 2600 mAh/g to 2800 mAh/g, or greater than 2800 mAh/g (e.g., up to about 3500 mAh/g). Note that these first-cycle lithiation capacities are calculated in terms of the mass of the anode active material. FIG. 23 (Table 7) lists estimated capacities (e.g., first-cycle lithiation capacities) of selected mixtures of Si—C (nano)composite particles (of varying capacities) and graphite particles as the anode active materials. Columns 1 and 2 show the respective mass fractions (in wt. %) of the Si—C (nano)composite particles and the graphite particles. The capacities (e.g., first-cycle lithiation capacities) of anode active materials for Si—C (nano)composite particles of respective example capacities (e.g., first-cycle lithiation capacities) are shown at column 3 (Si—C (nano)composite particle capacity of 1600 mAh/g), column 4 (Si—C (nano)composite particle capacity of 1800 mAh/g), column 5 (Si—C (nano)composite particle capacity of 2000 mAh/g), column 6 (Si—C (nano)composite particle capacity of 2200 mAh/g), column 7 (Si—C (nano)composite particle capacity of 2400 mAh/g), column 8 (Si—C (nano)composite particle capacity of 2600 mAh/g), and column 9 (Si—C (nano)composite particle capacity of 2800 mAh/g). Graphite is assumed to contribute a capacity (e.g., first-cycle lithiation capacity) of 372 mAh/g. In the example of an anode active material comprising a mixture of Si—C (nano)composite particles (first-cycle lithiation capacity of 1600 mAh/g) at 10 wt. % of the anode active material and graphite particles at 90 wt. % of the anode active material, the first-cycle lithiation capacity may be about 495 mAh/g, which would be significantly higher than that of graphite particles (e.g., about 372 mAh/g). In some implementations, in blended anodes comprising Si—C (nano)composite particles and graphite particles, the mass fraction of the composite particles in the anode active material is preferably 10 wt. % or greater, up to 100 wt. %.

The capacity of an anode active material increases with increasing mass fractions of Si—C (nano)composite particles in the anode active material. The mass fraction of Si—C (nano)composite particles in an electrode (e.g., electrode) active material may be referred to as a composite mass fraction. As the composite mass fraction increases (e.g., 40 wt. % or greater, 50 wt. % or greater, 55 wt. % or greater, 60 wt. % or greater, 65 wt. % or greater, 70 wt. % or greater, 75 wt. % or greater, 80 wt. % or greater, 85 wt. % or greater, 90 wt. % or greater, 95 wt. % or greater, or 100 wt. %), it may be more preferable to adopt composite particles of (1) certain relatively broad PSDs (e.g., PSD span, right PSD span, left PSD span, extended PSD span, and/or extended right PSD span) and (2) D₁₀ values of the PSD in certain preferred ranges. In addition, as the Si mass fraction in Si—C (nano)composite particles increases, the capacity (e.g., first-cycle lithiation capacity) of the Si—C (nano)composite particles is expected to increase. However, as the silicon mass fraction increases, the properties of the Si—C (nano) composite particles may evolve (e.g., the particles may become more brittle, packing conditions of the anode active material in the electrode may change because of the greater swelling and contraction of the composite particles during cycling and other factors). Accordingly, as the first-cycle lithiation capacity of the Si—C (nano)composite particles increases (e.g., 1300 mAh/g or greater, 1400 mAh/g or greater, 1500 mAh/g or greater, 1600 mAh/g or greater, 1700 mAh/g or greater, 1800 mAh/g or greater, 1900 mAh/g or greater, or 2000 mAh/g or greater, or 2100 mAh/g or greater, 2200 mAh/g or greater, 2400 mAh/g or greater, 2600 mAh/g or greater, or 2800 mAh/g or greater), it may be more preferable to adopt composite particles of (1) certain relatively broad PSDs (e.g., PSD span, right PSD span, left PSD span, extended PSD span, and/or extended right PSD span) and (2) D₁₀ values of the PSD in certain preferred ranges.

FIG. 24 (Table 8) shows selected PSD characteristics (D₁₀, D₅₀, D₉₀, D₉₉, PSD span, right PSD span, left PSD span, extended PSD span, and extended right PSD span) of Samples F, G, and H of populations of Si—C (nano)composite particles. Trends that may be observed in the data of Table 8 include: (1) the D₁₀ is in a range of 1.0 to 4.5 μm (e.g., 1.0-4.0 μm, 1.0-3.5 μm, 1.0-3.0 μm, 1.0-2.5 μm, 1.5-3.5 μm, 1.5-3.0 μm, 1.5-2.5 μm, or 2.0-2.5 μm) for some implementations (e.g., for higher wt. % Si—C in the anode active material blends or up to 100 wt. % Si—C in active material anode composition); (2) the PSD span is preferably 0.85 or greater (e.g., 1.00 or greater, 1.15 or greater, 1.30 or greater, or 1.40 or greater) for some implementations; (3) the right PSD span is preferably 0.50 or greater (e.g., 0.60 or greater, 0.70 or greater, 0.80 or greater, or 0.85 or greater) for some implementations; (4) the left PSD span is preferably 0.35 or greater (e.g., 0.40 or greater, 0.45 or greater, 0.50 or greater, or 0.55 or greater) for some implementations; (5) the extended PSD span is preferably 1.30 or greater (e.g., 1.50 or greater, 1.70 or greater, 1.90 or greater, or 2.10 or greater) for some implementations; (6) the extended right PSD span is preferably 0.95 or greater (e.g., 1.10 or greater, 1.25 or greater, 1.40 or greater, or 1.55 or greater) for some implementations; (7) the PSD span is preferably 2.60 or less (e.g., 2.50 or less, 2.40 or less, 2.30 or less, or 2.20 or less) for some implementations; and (8) the extended PSD span is preferably 3.60 or less (e.g., 3.40 or less, 3.20 or less, 3.00 or less, or 2.80 or less) for some implementations.

In implementations of a battery anode electrode composition in which (a1) the Si—C (nano)composite mass fraction is in a range of 45 to 100 wt. % or (a2) the electrode active material (blended or non-blended) exhibits a first-cycle lithiation capacity of at least 1000 mAh/g (e.g., preferably at least 1300 mAh/g: (a3) the D₁₀ of the Si—C (nano)composite particles may be in a range of 1.0 to 4.5 μm; and the PSD of the Si—C (nano)composite particles may satisfy one or more of the following characteristics: (a4) the PSD span is 0.85 or greater, (a5) the right PSD span is 0.50 or greater, (a6) the left PSD span is 0.35 or greater, (a7) the extended PSD span is 1.30 or greater, and (a8) the extended right PSD span is 0.95 or greater.

In implementations of a battery anode electrode composition, in which (b1) the Si—C (nano)composite mass fraction is in a range of 55 to 100 wt. % or (b2) the first-cycle lithiation capacity is at least 1500 mAh/g: (b3) the D₁₀ of the Si—C (nano)composite particles may be in a range of 1.0 to 4.0 μm; and the PSD of the Si—C (nano)composite particles may satisfy one or more of the following characteristics: (b4) the PSD span is 1.00 or greater, (b5) the right PSD span is 0.60 or greater, (b6) the left PSD span is 0.40 or greater, (b7) the extended PSD span is 1.50 or greater, and (b8) the extended right PSD span is 1.10 or greater.

In implementations of a battery electrode composition in which (c1) the Si—C (nano)composite mass fraction is in a range of 65 to 100 wt. % or (c2) the first-cycle lithiation capacity is at least 1700 mAh/g: (c3) the D₁₀ of the Si—C (nano)composite particles may be in a range of 1.0 to 3.5 μm; and the PSD of the Si—C (nano)composite particles may satisfy one or more of the following characteristics: (c4) the PSD span is 1.15 or greater, (c5) the right PSD span is 0.70 or greater, (c6) the left PSD span is 0.45 or greater, (c7) the extended PSD span is 1.70 or greater, and (c8) the extended right PSD span is 1.25 or greater.

In implementations of a battery electrode composition in which (d1) the Si—C (nano)composite mass fraction is in a range of 75 to 100 wt. % or (d2) the first-cycle lithiation capacity is at least 1900 mAh/g: (d3) the D₁₀ of the Si—C (nano)composite particles may be in a range of 1.0 to 3.0 μm; and the PSD of the Si—C (nano)composite particles may satisfy one or more of the following characteristics: (d4) the PSD span is 1.30 or greater, (d5) the right PSD span is 0.80 or greater, (d6) the left PSD span is 0.50 or greater, (d7) the extended PSD span is 1.90 or greater, and (d8) the extended right PSD span is 1.40 or greater.

In implementations of a battery electrode composition in which (e1) the Si—C (nano)composite mass fraction is in a range of 85 to 100 wt. % or (e2) the first-cycle lithiation capacity is at least 2100 mAh/g: (e3) the D₁₀ of the Si—C (nano)composite particles may be in a range of 1.5 to 3.0 μm; and the PSD of the Si—C (nano)composite particles may satisfy one or more of the following characteristics: (e4) the PSD span is 1.40 or greater, (e5) the right PSD span is 0.85 or greater, (e6) the left PSD span is 0.55 or greater, (e7) the extended PSD span is 2.10 or greater, and (e8) the extended right PSD span is 1.55 or greater.

FIG. 25 shows the linear correlation between the average Si weight fraction in Si—C (nano)composites as measured using (i) SEM-EDX (defined as Si wt. % divided by the sum of Si wt. % and C wt. %, collected by fitting the corresponding SEM-EDX (SEM-EDS) peaks collected on individual Si—C composite particles and averaged, as outlined with reference to FIG. 6 or another suitable process) and (ii) thermogravimetric analysis (TGA) carried out on the population of Si—C composite particles, as outlined with reference to FIG. 4. The correlation via linear regression for populations of Si—C (nano)composite particles of varying Si concentrations shown in FIG. 25 was found to be: f_{Si}(TGA)=−19.3+0.92·f_{Si}(SEM-EDX), wherein f_{Si}(TGA) is the mean Si mass fraction as determined by TGA and f_{Si}(SEM-EDX) is the average fraction of Si wt. % divided by a sum of the Si wt. % and the C wt. %, as determined by SEM-EDX (SEM-EDS). This correlation was used for converting the distribution of mass fractions of Si obtained by SEM-EDX (SEM-EDS) to an estimated Si mass fraction (Si wt. %) obtained by TGA. Accordingly, this correlation (conversion) is suitable for comparing varying Si distributions (e.g., populations of different Si concentrations). Such calculations assume the Si mass fraction estimated by TGA to be more accurate than Si mass fractions estimated by SEM-EDX (SEM-EDS). In some examples, the Si mass fraction in the Si—C (nano)composite particles can be in a range of about 35 to about 70 wt. %, as estimated by TGA, which can correspond to a range of about 59 to about 97 wt. % as estimated by SEM-EDX analysis. In some examples, the Si mass fraction in the Si—C (nano)composite particles can be in a range of about 40 to about 60 wt. %, as estimated by TGA, which can correspond to a range of about 64 to about 86 wt. % as estimated by SEM-EDX analysis. This mass fraction can refer to a mean mass fraction of a population of Si—C (nano)composite particles.

FIGS. 26 and 27 show numerical fraction distributions (number of particles of a Si mass fraction, divided by total number of particles), as a function of converted Si mass fractions (i.e., Si mass fractions originally determined by the SEM-EDX process and converted to Si mass fractions by TGA, using the correlation shown in FIG. 25), for several populations of Si—C (nano)composite particles. FIG. 26 shows the converted Si mass fraction distributions of Samples A, B, C, and J, where Sample J was synthesized using the same reactor processes as Sample C, but synthesized with a higher target mean Si mass fraction. Narrow distributions of Si mass fractions are achievable for varying mean Si mass fraction targets. Narrower breadths of distributions of Si mass fraction were achievable with synthesis pathways described for Sample B and even more so for Sample C and Sample J. Higher levels of particle-to-particle uniformity in Si mass fraction were found to be instrumental for attaining high-performance Li-ion battery cells with superior cycle stability and service life, critically needed to meet the key performance parameters for such cells in applications. Less uniform materials showed inferior performance and could not meet the required performance targets to be employed in applications, especially for higher wt. % Si in Si—C (nano)composites (e.g., for >40 wt. %, more so for >45 wt. %, more so for >50 wt. %, more so for >55 wt. %, more so for >60 wt. %, more so for >65 wt. %, or more so for >70 wt. %, as measured using the TGA method) and for higher wt. % Si—C composite in the anodes (e.g., >10 wt. %, more so for >15 wt. %, more so for >20 wt. %, more so for >25 wt. %, more so for >30 wt. %, more so for >40 wt. %, more so for >50 wt. % relative to all anode active materials, such as Si—C and graphite).

FIG. 27 shows the converted Si mass fraction distributions of Samples J, K, and L, where Sample K and Sample L were synthesized using the same reactor methods as Sample C, but with different mean Si mass fraction synthesis targets. Both higher and lower wt. % of Si can be attained in Si—C (nano)composites. Generally speaking, higher capacity and higher Si content can be attained by one or more of: (i) using porous carbon particles with more porosity (particles with higher pore volume) and/or using porous particles with a fine-tuned or more uniform pore size distribution having with no too small/narrow pores (too small or narrow for Si to be deposited therein) or too large pores (too large for Si to fully fill); (ii) tuning Si deposition conditions or Si deposition reactors; (iii) tuning C deposition conditions or C deposition reactors. Fine-tuning Si CVD deposition protocols can include, for example, using lower deposition temperatures to attain more uniform Si deposition within the particles (while avoiding or minimizing depositing Si on the outer surface) or by using lower temperature combined with higher temperature annealing to crystalize Si and thus attain higher density or by using well-agitated reactors to attain more uniform Si deposition while avoiding or minimizing depositing Si on the outer surface, etc.). Fine-tuning C CVD deposition protocols to reduce the total amount of C needed to seal the particles and reduce the total amount of C in Si—C composites, can include, for example, using controlled temperature (sufficiently high to seal particles without filling remaining internal pores with C and sufficiently low to avoid forming chemical bonds between Si and C, which reduce capacity and to avoid particle-to-particle nonuniformities), controlled agitation conditions (e.g. ensuring good thermal and mass transport in such reactors, while avoiding damaging the particles by forming cracks or fractures, etc.), using plasma enhancement or other means.

Some embodiments of the present disclosure on Li-ion batteries may benefit from the use of certain electrolyte compositions in battery cell fabrication to attain superior characteristics. In some designs, suitable electrolyte composition may comprise (i) one, two, three or more Li salts with the total concentration in the range from about 0.8M to about 2.0M (e.g., about 0.8-1.0M; about 1.0-1.1M; about 1.1-1.2M; about 1.2-1.3M; about 1.3-1.4M; about 1.4-1.6M; about 1.6-1.7M; about 1.7-1.8M; about 1.8-2.0M), wherein at least one Li salt may be LiPF₆ (in some designs, LiPF₆ may comprise at least 10 wt. % of all Li salts in the Li salt mixture; for example 10-30 wt. % or 30-50 wt. % or 50-80 wt. % or 80-100 wt. %); wherein at least one Li salt may be lithium bis(fluorosulfonyl)imide (LiFSI) in some designs (in some designs, LiFSI may comprise at least 10 wt. % of all Li salts in the Li salt mixture; for example 10-30 wt. % or 30-50 wt. % or 50-90 wt. %); (ii) one, two or more cyclic carbonates (in some designs, fluorinated cyclic carbonates, such as FEC, among others), (iii) zero, one, two, three or more nitrogen-comprising co-solvents (in some designs, at least some of the nitrogen comprising co-solvents may advantageously comprise two or three or more nitrogen atoms per molecules), (iv) zero, one, two, three or more sulfur comprising co-solvents, (v) zero, one, two, three or more phosphorous comprising co-solvents (note that some co-solvents may advantageously comprise both phosphorus and sulfur), (vi) zero, one, two, three or more linear or branched esters as co-solvents, (vii) zero, one, two, or more linear carbonates as co-solvents, (viii) zero, one, two, three or more additional electrolyte co-solvents or additives, or (ix) any combination thereof. In some designs, the volume fraction of linear esters (as a fraction of all co-solvents in the electrolyte) may range from about 20 vol. % to about 85 vol. % (about 20-40 vol. %; about 40-60 vol. %; about 60-85 vol. %). In some designs, the volume fraction of branched esters (as a fraction of all co-solvents in the electrolyte) may range from about 10 vol. % to about 80 vol. % (about 10-30 vol. %; about 30-60 vol. %; about 60-80 vol. %). In some designs, the volume fraction of cyclic carbonates (as a fraction of all co-solvents in the electrolyte) may range from about 5 vol. % to about 40 vol. % (e.g., about 5-10 vol. %; about 10-20 vol. %; about 20-40 vol. %). In some designs, the volume fraction of fluorinated cyclic carbonates (as a fraction of all co-solvents in the electrolyte) may range from about 1 vol. % to about 20 vol. % (e.g., about 1-4 vol. %; about 4-6 vol. %; about 6-12 vol. %; about 12-20 vol. %). In some designs, the volume fraction of vinylene carbonate (VC) (as a fraction of all co-solvents in the electrolyte) may range from about 0.25 vol. % to about 6 vol. % (e.g., about 0.25-0.5 vol. %; about 0.5-1 vol. %; about 1-2 vol. %; about 2-6 vol. %). In some designs, about 50 vol. % or more of the co-solvents may advantageously exhibit a melting point below about minus (−) 60° C. (in some designs, below about −70° C. or below about −80° C.). In some designs utilizing two or more salts (e.g., two, three, four, or five salts), it may be advantageous for at least one of the salts to comprise LiPF₆. In some designs, the incorporation of such salts may enhance properties (e.g., cycle stability, resistance, thermal stability, performance at high or low temperatures) of the cathode electrolyte interphase (CEI) layer or the anode solid electrolyte interface (SEI) layer or provide other performance advantages. In some designs, it may be further advantageous for at least one other salt to also be a salt of Li. Examples of some of such suitable salts include: LiFSI, LiTFSI, LiBETI and/or other Li imide salts, Li bis(oxalato)borate (LiBOB), Li difluoro(oxalato)borate (LiDFOB), Li 2-trifluoromethyl-4,5-dicyanoimidazolide (LiTDi), Li 4,5-dicyano-2-(pentafluoroethyl)imidazolide (LiPDi), Li difluorophosphate (LiDFP), Li nitrate (LiNO₃). LiFSI may be particularly helpful in enhancing conductivity and SEI stability.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1: A battery electrode composition, comprising: a population of (nano)composite particles, each of the (nano)composite particles comprising silicon (Si) and carbon (C), wherein: the population is characterized by a distribution of adjusted mass fractions of the Si in the (nano)composite particles; the adjusted mass fraction W of the Si in a respective one of the (nano)composite particles is given by: W=w−w̅ (Formula 2), w being a mass fraction of the Si in the respective one of the (nano)composite particles and w̅ being a mean of the mass fractions of the Si in the (nano)composite particles of the population; and a standard deviation of the distribution is 0.12 or less.

Clause 2: The battery electrode composition of clause 1, wherein: the standard deviation is 3.8×10⁻² or less.

Clause 3: The battery electrode composition of any of clauses 1 to 2, wherein: the standard deviation is 2.9×10⁻² or less.

Clause 4: The battery electrode composition of any of clauses 1 to 3, wherein: a magnitude of a skewness of the distribution is 1.1 or less.

Clause 5: The battery electrode composition of any of clauses 1 to 4, wherein: the magnitude of the skewness of the distribution is 0.39 or less.

Clause 6: The battery electrode composition of any of clauses 1 to 5, wherein: the magnitude of the skewness of the distribution is 0.09 or less.

Clause 7: The battery electrode composition of any of clauses 1 to 6, wherein: a full-width at half-maximum (FWHM) of the distribution is 7.0×10⁻² or less.

Clause 8: The battery electrode composition of any of clauses 1 to 7, wherein: the FWHM of the distribution is 5.8×10⁻² or less.

Clause 9: The battery electrode composition of any of clauses 1 to 8, wherein: the FWHM of the distribution is 4.3×10⁻² or less.

Clause 10: The battery electrode composition of any of clauses 1 to 9, wherein: a span #1 of the adjusted mass fractions between a 5^{th} percentile and a 95^{th} percentile of the population is 0.39 or less; or a span #2 of the adjusted mass fractions between a 10th percentile and a 90^{th} percentile of the population is 0.28 or less; or a span #3 of the adjusted mass fractions between a 15^{th} percentile and an 85^{th} percentile of the population is 0.19 or less; or a span #4 of the adjusted mass fractions between a 20^{th} percentile and an 80^{th} percentile of the population is 0.14 or less; or a span #5 of the adjusted mass fractions between a 25^{th} percentile and a 75^{th} percentile of the population is 0.11 or less.

Clause 11: The battery electrode composition of any of clauses 1 to 10, wherein: the span #1 is 0.10 or less; or the span #2 is 7.6×10⁻² or less; or the span #3 is 6.0×10⁻² or less; or the span #4 is 4.8×10⁻² or less; or the span #5 is 3.8×10⁻² or less.

Clause 12: The battery electrode composition of any of clauses 1 to 11, wherein: the span #1 is 6.9×10⁻² or less; or the span #2 is 5.2×10⁻² or less; or the span #3 is 4.1×10⁻² or less; or the span #4 is 3.3×10⁻² or less; or the span #5 is 2.7×10⁻² or less.

Clause 13: The battery electrode composition of any of clauses 1 to 12, wherein: a span ratio #A1, which is (1-1) a span #L1 of the adjusted mass fractions between a 5^{th} percentile and a 35^{th} percentile of the population, divided by a span #R1 of the adjusted mass fractions between a 65^{th} percentile and a 95^{th} percentile of the population if the span #L1 is less than or equal to the span #R1, or (1-2) the span #R1 divided by the span #L1 if the span #R1 is less than the span #L1, is in a range of 0.14 to 1.0; or a span ratio #A2, which is (2-1) a span #L2 of the adjusted mass fractions between a 10^{th} percentile and a 40^{th} percentile of the population, divided by a span #R2 of the adjusted mass fractions between a 60^{th} percentile and a 90^{th} percentile of the population if the span #L2 is less than or equal to the span #R2, or (2-2) the span #R2 divided by the span #L2 if the span #R2 is less than the span #L2, is in a range of 0.18 to 1.0; or a span ratio #A3, which is (3-1) a span #L3 of the adjusted mass fractions between a 15th percentile and a 45^{th} percentile of the population, divided by a span #R3 of the adjusted mass fractions between a 55^{th} percentile and a 85^{th} percentile of the population if the span #L3 is less than or equal to the span #R3, or (3-2) the span #R3 divided by the span #L3 if the span #R3 is less than the span #L3, is in a range of 0.25 to 1.0; or a span ratio #A4, which is (4-1) a span #L4 of the adjusted mass fractions between a 20^{th} percentile and a 50^{th} percentile of the population, divided by a span #R4 of the adjusted mass fractions between a 50^{th} percentile and an 80^{th} percentile of the population if the span #L4 is less than or equal to the span #R4, or (4-2) the span #R4 divided by the span #L4 if the span #R4 is less than the span #L4, is in a range of 0.33 to 1.0.

Clause 14: The battery electrode composition of any of clauses 1 to 13, wherein: the span ratio #A1 is in a range of 0.61 to 1.0; or the span ratio #A2 is in a range of 0.67 to 1.0; or the span ratio #A3 is in a range of 0.73 to 1.0; or the span ratio #A4 is in a range of 0.80 to 1.0.

Clause 15: The battery electrode composition of any of clauses 1 to 14, wherein: the span ratio #A1 is in a range of 0.94 to 1.0; or the span ratio #A2 is in a range of 0.97 to 1.0; or the span ratio #A3 is in a range of 0.98 to 1.0; or the span ratio #A4 is in a range of 0.98 to 1.0.

Clause 16: The battery electrode composition of any of clauses 1 to 15, wherein: the mean corresponds to a mass fraction of the Si in the (nano)composite particles in a range of 35 to 70 wt. % as estimated by thermogravimetric analysis (TGA) or in a range of 59 to 97 wt. % as estimated by scanning electron microscopy with energy dispersive x-ray spectroscopy (SEM-EDX) analysis.

Clause 17: The battery electrode composition of any of clauses 1 to 16, wherein: the mass fraction of the Si in the (nano)composite particles is in a range of 40 to 60 wt. % by TGA or in a range of 64 to 86 wt. % by SEM-EDX analysis.

Clause 18: The battery electrode composition of any of clauses 1 to 17, wherein: the (nano)composite particles comprise protective material thereon; and the protective material comprises one or more of the following: protective carbon, hydrocarbon, polymer, silicon oxide, silicon nitride, silicon phosphide, and ceramic material.

Clause 19: The battery electrode composition of any of clauses 1 to 18, wherein: a Brunauer-Emmett-Teller specific surface area (BET-SSA) of the population is in a range of about 0.5 m²/g to about 18 m²/g.

Clause 20: The battery electrode composition of any of clauses 1 to 19, wherein: the BET-SSA is in a range of about 0.5 m²/g to about 9 m²/g.

Clause 21: The battery electrode composition of any of clauses 1 to 20, wherein: the BET-SSA is in a range of about 0.5 m²/g to about 5 m²/g.

Clause 22: The battery electrode composition of any of clauses 1 to 21, further comprising a binder and/or conductive additives.

Clause 23: The battery electrode composition of any of clauses 1 to 22, wherein: the battery electrode composition comprises an electrode active material, the electrode active material comprising the (nano)composite particles and excluding any binder; and a composite mass fraction of the (nano)composite particles in the electrode active material is in a range of 10 to 100 wt. %.

Clause 24: The battery electrode composition of any of clauses 1 to 23, wherein: the electrode active material comprises graphite particles mixed with the (nano)composite particles.

Clause 25: The battery electrode composition of any of clauses 1 to 24, wherein: (a1) the composite mass fraction is in a range of 45 to 100 wt. % or (a2) the electrode active material exhibits a first-cycle lithiation capacity of at least 1300 mAh/g; the population is characterized by a particle size distribution (PSD) as determined by laser particle size distribution analysis (LPSA), the PSD being described by a tenth-percentile volume-weighted particle size parameter (D₁₀), a fiftieth-percentile volume-weighted particle size parameter (D₅₀), a ninetieth-percentile volume-weighted particle size parameter (D₉₀), a ninety-ninth-percentile volume-weighted particle size parameter (D₉₉), a PSD span defined as (D₉₀-D₁₀)/D₅₀, a right PSD span defined as (D₉₀-D₅₀)/D₅₀, a left PSD span defined (D₅₀-D₁₀)/D₅₀, an extended PSD span defined as (D₉₉-D₁₀)/D₅₀, and an extended right PSD span defined as (D₉₉-D₅₀)/D₅₀; (a3) the D₁₀ is in a range of 1.0 to 4.5 μm; and (a4) the PSD span is 0.85 or greater, or (a5) the right PSD span is 0.50 or greater, or (a6) the left PSD span is 0.35 or greater, or (a7) the extended PSD span is 1.30 or greater, or (a8) the extended right PSD span is 0.95 or greater.

Clause 26: The battery electrode composition of any of clauses 1 to 25, wherein: (b1) the composite mass fraction is in a range of 55 to 100 wt. % or (b2) the first-cycle lithiation capacity is at least 1500 mAh/g; (b3) the D₁₀ is in a range of 1.0 to 4.0 μm; and (b4) the PSD span is 1.00 or greater, or (b5) the right PSD span is 0.60 or greater, or (b6) the left PSD span is 0.40 or greater, or (b7) the extended PSD span is 1.50 or greater, or (b8) the extended right PSD span is 1.10 or greater.

Clause 27: The battery electrode composition of any of clauses 1 to 26, wherein: (c1) the composite mass fraction is in a range of 65 to 100 wt. % or (c2) the first-cycle lithiation capacity is at least 1700 mAh/g; (c3) the D₁₀ is in a range of 1.0 to 3.5 μm; and (c4) the PSD span is 1.15 or greater, or (c5) the right PSD span is 0.70 or greater, or (c6) the left PSD span is 0.45 or greater, or (c7) the extended PSD span is 1.70 or greater, or (c8) the extended right PSD span is 1.25 or greater.

Clause 28: The battery electrode composition of any of clauses 1 to 27, wherein: (d1) the composite mass fraction is in a range of 75 to 100 wt. % or (d2) the first-cycle lithiation capacity is at least 1900 mAh/g; (d3) the D₁₀ is in a range of 1.0 to 3.0 μm; and (d4) the PSD span is 1.30 or greater, or (d5) the right PSD span is 0.80 or greater, or (d6) the left PSD span is 0.50 or greater, or (d7) the extended PSD span is 1.90 or greater, or (d8) the extended right PSD span is 1.40 or greater.

Clause 29: The battery electrode composition of any of clauses 1 to 28, wherein: (e1) the composite mass fraction is in a range of 85 to 100 wt. % or (e2) the first-cycle lithiation capacity is at least 2100 mAh/g; (e3) the D₁₀ is in a range of 1.5 to 3.0 μm; and (e4) the PSD span is 1.40 or greater, or (e5) the right PSD span is 0.85 or greater, or (e6) the left PSD span is 0.55 or greater, or (e7) the extended PSD span is 2.10 or greater, or (e8) the extended right PSD span is 1.55 or greater.

Clause 30: The battery electrode composition of any of clauses 1 to 29, wherein: the Si is amorphous as determined by x-ray diffraction.

Clause 31: The battery electrode composition of any of clauses 1 to 30, wherein: the Si exhibits an average crystalline grain size of 10 nm or less, as determined by x-ray diffraction.

Clause 32: The battery electrode composition of any of clauses 1 to 31, wherein: the average crystalline grain size is 5 nm or less.

Clause 33: A battery electrode, comprising: the battery electrode composition of any of clauses 1 to 32 disposed on or in a current collector.

Clause 34: A lithium-ion battery, comprising: the battery electrode of any of clauses 1 to 33 configured as an anode; a cathode; and an electrolyte ionically coupling the anode and the cathode.

Clause 35: A method comprising: (a1) providing porous particles comprising carbon (C); and (a2) depositing silicon (Si) in the porous particles under agitation to form a population of (nano)composite particles, each of the (nano)composite particles comprising the Si and the C; and (a3) obtaining a battery electrode composition from the population of (nano)composite particles, wherein: the population is characterized by a distribution of adjusted mass fractions of the Si in the (nano)composite particles; the adjusted mass fraction of the Si in a respective one of the (nano)composite particles W is given by: W=w−w̅ (Formula 2), w being a mass fraction of the Si in the respective one of the (nano)composite particles and w being a mean of the mass fractions of the Si in the (nano)composite particles of the population; and a standard deviation of the distribution is 0.12 or less.

Clause 36: The method of clause 35, wherein: the standard deviation is 3.8×10⁻² or less.

Clause 37: The method of any of clauses 35 to 36, wherein: the standard deviation is 2.9×10⁻² or less.

Clause 38: The method of any of clauses 35 to 37, wherein: a magnitude of a skewness of the distribution is 1.1 or less.

Clause 39: The method of any of clauses 35 to 38, wherein: the magnitude of the skewness of the distribution is 0.39 or less.

Clause 40: The method of any of clauses 35 to 39, wherein: the magnitude of the skewness of the distribution is 0.09 or less.

Clause 41: The method of any of clauses 35 to 40, wherein: a full-width at half-maximum (FWHM) of the distribution is 7.0×10⁻² or less.

Clause 42: The method of any of clauses 35 to 41, wherein: the FWHM of the distribution is 5.8×10⁻² or less.

Clause 43: The method of any of clauses 35 to 42, wherein: the FWHM of the distribution is 4.3×10⁻² or less.

Clause 44: The method of any of clauses 35 to 43, wherein: a span #1 of the adjusted mass fractions between a 5^{th} percentile and a 95^{th} percentile of the population is 0.39 or less; or a span #2 of the adjusted mass fractions between a 10^{th} percentile and a 90^{th} percentile of the population is 0.28 or less; or a span #3 of the adjusted mass fractions between a 15^{th} percentile and an 85^{th} percentile of the population is 0.19 or less; or a span #4 of the adjusted mass fractions between a 20^{th} percentile and an 80^{th} percentile of the population is 0.14 or less; or a span #5 of the adjusted mass fractions between a 25th percentile and a 75^{th} percentile of the population is 0.11 or less.

Clause 45: The method of any of clauses 35 to 44, wherein: the span #1 is 0.10 or less; or the span #2 is 7.6×10⁻² or less; or the span #3 is 6.0×10⁻² or less; or the span #4 is 4.8×10⁻² or less; or the span #5 is 3.8×10⁻² or less.

Clause 46: The method of any of clauses 35 to 45, wherein: the span #1 is 6.9×10⁻² or less; or the span #2 is 5.2×10⁻² or less; or the span #3 is 4.1×10⁻² or less; or the span #4 is 3.3×10⁻² or less; or the span #5 is 2.7×10⁻² or less.

Clause 47: The method of any of clauses 35 to 46, wherein: a span ratio #A1, which is (1-1) a span #L1 of the adjusted mass fractions between a 5^{th} percentile and a 35^{th} percentile of the population, divided by a span #R1 of the adjusted mass fractions between a 65^{th} percentile and a 95^{th} percentile of the population if the span #L1 is less than or equal to the span #R1, or (1-2) the span #R1 divided by the span #L1 if the span #R1 is less than the span #L1, is in a range of 0.14 to 1.0; or a span ratio #A2, which is (2-1) a span #L2 of the adjusted mass fractions between a 10^{th} percentile and a 40th percentile of the population, divided by a span #R2 of the adjusted mass fractions between a 60^{th} percentile and a 90^{th} percentile of the population if the span #L2 is less than or equal to the span #R2, or (2-2) the span #R2 divided by the span #L2 if the span #R2 is less than the span #L2, is in a range of 0.18 to 1.0; or a span ratio #A3, which is (3-1) a span #L3 of the adjusted mass fractions between a 15^{th} percentile and a 45^{th} percentile of the population, divided by a span #R3 of the adjusted mass fractions between a 55^{th} percentile and a 85^{th} percentile of the population if the span #L3 is less than or equal to the span #R3, or (3-2) the span #R3 divided by the span #L3 if the span #R3 is less than the span #L3, is in a range of 0.25 to 1.0; or a span ratio #A4, which is (4-1) a span #L4 of the adjusted mass fractions between a 20^{th} percentile and a 50^{th} percentile of the population, divided by a span #R4 of the adjusted mass fractions between a 50^{th} percentile and an 80th percentile of the population if the span #L4 is less than or equal to the span #R4, or (4-2) the span #R4 divided by the span #L4 if the span #R4 is less than the span #L4, is in a range of 0.33 to 1.0.

Clause 48: The method of any of clauses 35 to 47, wherein: the span ratio #A1 is in a range of 0.61 to 1.0; or the span ratio #A2 is in a range of 0.67 to 1.0; or the span ratio #A3 is in a range of 0.73 to 1.0; or the span ratio #A4 is in a range of 0.80 to 1.0.

Clause 49: The method of any of clauses 35 to 48, wherein: the span ratio #A1 is in a range of 0.94 to 1.0; or the span ratio #A2 is in a range of 0.97 to 1.0; or the span ratio #A3 is in a range of 0.98 to 1.0; or the span ratio #A4 is in a range of 0.98 to 1.0.

Clause 50: The method of any of clauses 35 to 49, wherein: the mean corresponds to a mass fraction of the Si in the (nano)composite particles in a range of 35 to 70 wt. % as estimated by thermogravimetric analysis (TGA) or in a range of 59 to 97 wt. % as estimated by scanning electron microscopy with energy dispersive x-ray spectroscopy (SEM-EDX) analysis.

Clause 51: The method of any of clauses 35 to 50, wherein: the mass fraction of the Si in the (nano)composite particles is in a range of 40 to 60 wt. % by TGA or in a range of 64 to 86 wt. % by SEM-EDX analysis.

Clause 52: The method of any of clauses 35 to 51, wherein the depositing of the Si (a2) is carried out using a first agitating reactor selected from: a fluidized-bed reactor, a rotary kiln, a moving-bed reactor, a vertical shaft kiln, a stirred-tank reactor, and a multiple hearth furnace.

Clause 53: The method of any of clauses 35 to 52, wherein the depositing of the Si (a2) is carried out by thermal decomposition of a Si-comprising gas in a temperature range of about 370° C. to about 750° C. or by plasma-enhanced deposition of the Si-comprising gas in a temperature range of about 150° C. to about 550° C.

Clause 54: The method of any of clauses 35 to 53, wherein the Si-comprising gas is selected from: monosilane (SiH₄), disilane (Si₂H₆), trisilane (Si₃H₈), tetrachlorosilane (SiCl₄), trichlorosilane (SiHCl₃), dichlorosilane (SiH₂Cl₂), and monochlorosilane (SiH₃Cl).

Clause 55: The method of any of clauses 35 to 54, further comprising: (b1) forming protective material on the (nano)composite particles, wherein: the protective material comprises one or more of the following: protective carbon, hydrocarbon, polymer, silicon oxide, silicon nitride, silicon phosphide, and ceramic material.

Clause 56: The method of any of clauses 35 to 55, wherein the protective material comprises protective carbon and the forming of the protective material (b1) comprises depositing the protective carbon on the (nano)composite particles under agitation.

Clause 57: The method of any of clauses 35 to 56, wherein the depositing of the protective carbon is carried out in a second agitating reactor selected from: a fluidized-bed reactor, a rotary kiln, a moving-bed reactor, a vertical shaft kiln, a stirred-tank reactor, and a multiple hearth furnace.

Clause 58: The method of any of clauses 35 to 57, wherein the depositing of the protective carbon is carried out by thermal decomposition of a C-comprising gas in a temperature range of about 450° C. to about 800° C. or by plasma-enhanced deposition of the Si-comprising gas in a temperature range of about 150° C. to about 550° C.

Clause 59: The method of any of clauses 35 to 58, wherein the C-comprising gas is selected from: alkanes, alkenes, dienes, alkynes, and aromatic hydrocarbons.

Clause 60: The method of any of clauses 35 to 59, wherein a Brunauer-Emmett-Teller specific surface area (BET-SSA) of the population, upon completion of (b1), is in a range of about 0.5 m²/g to about 18 m²/g.

Clause 61: The method of any of clauses 35 to 60, wherein: the BET-SSA is in a range of about 0.5 m²/g to about 9 m²/g.

Clause 62: The method of any of clauses 35 to 61, wherein: the BET-SSA is in a range of about 0.5 m²/g to about 5 m²/g.

Clause 63: The method of any of clauses 35 to 62, wherein: the providing of the porous particles (a1) comprises activating precursor carbonaceous particles under agitation.

Clause 64: The method of any of clauses 35 to 63, wherein the activating of the precursor carbonaceous particles is carried out in a third agitating reactor selected from: a fluidized-bed reactor, a rotary kiln, a moving-bed reactor, a vertical shaft kiln, a stirred-tank reactor, and a multiple hearth furnace.

Clause 65: The method of any of clauses 35 to 64, wherein the activating of the precursor carbonaceous particles is carried out in an environment comprising one or more of H₂O, CO₂, and O₂ in a temperature range of about 700° C. to about 1300° C.

Clause 66: The method of any of clauses 35 to 65, wherein the environment further comprises inert diluent gas.

Clause 67: The method of any of clauses 35 to 66, wherein the porous particles are characterized by a Brunauer-Emmett-Teller specific surface area (BET-SSA) of about 1000 m²/g or more.

Clause 68: The method of any of clauses 35 to 67, wherein the BET-SSA is in a range of about 1000 m²/g to about 3500 m²/g.

Clause 69: The method of any of clauses 35 to 68, wherein: (a3) comprises mixing the (nano)composite particles with a binder and/or conductive additives to obtain the battery electrode composition.

Clause 70: The method of any of clauses 35 to 69, wherein: the battery electrode composition comprises an electrode active material, the electrode active material comprising the (nano)composite particles and excluding any binder; and a composite mass fraction of the (nano)composite particles in the electrode active material is in a range of 10 to 100 wt. %.

Clause 71: The method of any of clauses 35 to 70, wherein: (a3) comprises mixing the (nano)composite particles with graphite particles, the electrode active material comprising the graphite particles mixed with the (nano)composite particles.

Clause 72: The method of any of clauses 35 to 71, wherein: (a1) the composite mass fraction is in a range of 45 to 100 wt. % or (a2) the electrode active material exhibits a first-cycle lithiation capacity of at least 1300 mAh/g; the population is characterized by a particle size distribution (PSD) as determined by laser particle size distribution analysis (LPSA), the PSD being described by a tenth-percentile volume-weighted particle size parameter (D₁₀), a fiftieth-percentile volume-weighted particle size parameter (D₅₀), a ninetieth-percentile volume-weighted particle size parameter (D₉₀), a ninety-ninth-percentile volume-weighted particle size parameter (D₉₉), a PSD span defined as (D₉₀-D₁₀)/D₅₀, a right PSD span defined as (D₉₀-D₅₀)/D₅₀, a left PSD span defined (D₅₀-D₁₀)/D₅₀, an extended PSD span defined as (D₉₉-D₁₀)/D₅₀, and an extended right PSD span defined as (D₉₉-D₅₀)/D₅₀; (a3) the D₁₀ is in a range of 1.0 to 4.5 μm; and (a4) the PSD span is 0.85 or greater, or (a5) the right PSD span is 0.50 or greater, or (a6) the left PSD span is 0.35 or greater, or (a7) the extended PSD span is 1.30 or greater, or (a8) the extended right PSD span is 0.95 or greater.

Clause 73: The method of any of clauses 35 to 72, wherein: (b1) the composite mass fraction is in a range of 55 to 100 wt. % or (b2) the first-cycle lithiation capacity is at least 1500 mAh/g; (b3) the D₁₀ is in a range of 1.0 to 4.0 μm; and (b4) the PSD span is 1.00 or greater, or (b5) the right PSD span is 0.60 or greater, or (b6) the left PSD span is 0.40 or greater, or (b7) the extended PSD span is 1.50 or greater, or (b8) the extended right PSD span is 1.10 or greater.

Clause 74: The method of any of clauses 35 to 73, wherein: (c1) the composite mass fraction is in a range of 65 to 100 wt. % or (c2) the first-cycle lithiation capacity is at least 1700 mAh/g; (c3) the D₁₀ is in a range of 1.0 to 3.5 μm; and (c4) the PSD span is 1.15 or greater, or (c5) the right PSD span is 0.70 or greater, or (c6) the left PSD span is 0.45 or greater, or (c7) the extended PSD span is 1.70 or greater, or (c8) the extended right PSD span is 1.25 or greater.

Clause 75: The method of any of clauses 35 to 74, wherein: (d1) the composite mass fraction is in a range of 75 to 100 wt. % or (d2) the first-cycle lithiation capacity is at least 1900 mAh/g; (d3) the D₁₀ is in a range of 1.0 to 3.0 μm; and (d4) the PSD span is 1.30 or greater, or (d5) the right PSD span is 0.80 or greater, or (d6) the left PSD span is 0.50 or greater, or (d7) the extended PSD span is 1.90 or greater, or (d8) the extended right PSD span is 1.40 or greater.

Clause 76: The method of any of clauses 35 to 75, wherein: (e1) the composite mass fraction is in a range of 85 to 100 wt. % or (e2) the first-cycle lithiation capacity is at least 2100 mAh/g; (e3) the D₁₀ is in a range of 1.5 to 3.0 μm; and (e4) the PSD span is 1.40 or greater, or (e5) the right PSD span is 0.85 or greater, or (e6) the left PSD span is 0.55 or greater, or (e7) the extended PSD span is 2.10 or greater, or (e8) the extended right PSD span is 1.55 or greater.

Clause 77: The method of any of clauses 35 to 76, wherein: the Si is amorphous as determined by x-ray diffraction.

Clause 78: The method of any of clauses 35 to 77, wherein: the Si exhibits an average crystalline grain size of 10 nm or less, as determined by x-ray diffraction.

Clause 79: The method of any of clauses 35 to 78, wherein: the average crystalline grain size is 5 nm or less.

Clause 80: The method of any of clauses 35 to 79, further comprising: (c1) making a slurry comprising the battery electrode composition; and (c2) casting the slurry on or in a current collector to form a battery electrode.

Clause 81: The method of any of clauses 35 to 80, further comprising: (d1) providing or making a cathode; (d2) assembling a cell from at least the cathode and an anode, the battery electrode being configured as the anode; and (d3) filling a space in the cell between the anode and the cathode with an electrolyte ionically coupling the anode and the cathode to form a lithium-ion battery.

Clause 82: The method of any of clauses 35 to 81, wherein: the cathode comprises one or more of: lithium cobalt oxide (LCO), lithium nickel manganese cobalt oxides (NCM), lithium nickel cobalt aluminum oxides (NCA), lithium nickel cobalt manganese aluminum oxides (NCMA), lithium manganese oxides (LMO), lithium nickel manganese oxides (LMNO), lithium manganese-rich oxides (LMR), lithium iron phosphate (LFP), lithium manganese iron phosphate (LMFP).

Clause 83: The method of any of clauses 35 to 82, wherein: the cell further comprises a porous separator in the space between the anode and the cathode, the porous separator comprising a ceramic.

Clause 84: The method of any of clauses 35 to 83, wherein: the cell further comprises a porous separator in the space between the anode and the cathode, a polymer adhesive layer comprising an adhesive being coated on one side or both sides of the porous separator.

Clause 85: The method of any of clauses 35 to 84, wherein: the adhesive comprises polyvinylidene fluoride (PVDF); and for each side of the porous separator coated with the adhesive, the adhesive coats a geometrical area of said side in a range of 2 areal % to 50 areal %.

This description is provided to enable any person skilled in the art to make or use embodiments of the present invention. It will be appreciated, however, that the present invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the invention.

1. A battery electrode composition, comprising:
a population of (nano)composite particles, each of the (nano)composite particles comprising silicon (Si) and carbon (C),
wherein:
the population is characterized by a distribution of adjusted mass fractions of the Si in the (nano)composite particles;
the adjusted mass fraction W of the Si in a respective one of the (nano)composite particles is given by:
$$W = w - \overline{w} , \qquad ( Formula 2 )$$
w being a mass fraction of the Si in the respective one of the (nano)composite particles and w̅ being a mean of the mass fractions of the Si in the (nano)composite particles of the population; and
a standard deviation of the distribution is 0.12 or less.

2. The battery electrode composition of claim 1, wherein:
the standard deviation is 3.8×10⁻² or less.

3. The battery electrode composition of claim 2, wherein:
the standard deviation is 2.9×10⁻² or less.

4. The battery electrode composition of claim 1, wherein:
a magnitude of a skewness of the distribution is 1.1 or less.

5. The battery electrode composition of claim 4, wherein:
the magnitude of the skewness of the distribution is 0.39 or less.

6. The battery electrode composition of claim 5, wherein:
the magnitude of the skewness of the distribution is 0.09 or less.

7. The battery electrode composition of claim 1, wherein:
a full-width at half-maximum (FWHM) of the distribution is 7.0×10⁻² or less.

8. The battery electrode composition of claim 7, wherein:
the FWHM of the distribution is 5.8×10⁻² or less.

9. The battery electrode composition of claim 8, wherein:
the FWHM of the distribution is 4.3×10⁻² or less.

10. The battery electrode composition of claim 1, wherein:
a span #1 of the adjusted mass fractions between a 5^{th} percentile and a 95th percentile of the population is 0.39 or less; or
a span #2 of the adjusted mass fractions between a 10^{th} percentile and a 90th percentile of the population is 0.28 or less; or
a span #3 of the adjusted mass fractions between a 15^{th} percentile and an 85th percentile of the population is 0.19 or less; or
a span #4 of the adjusted mass fractions between a 20^{th} percentile and an 80th percentile of the population is 0.14 or less; or
a span #5 of the adjusted mass fractions between a 25^{th} percentile and a 75th percentile of the population is 0.11 or less.

11. The battery electrode composition of claim 10, wherein:
the span #1 is 0.10 or less; or
the span #2 is 7.6×10⁻² or less; or
the span #3 is 6.0×10⁻² or less; or
the span #4 is 4.8×10⁻² or less; or
the span #5 is 3.8×10⁻² or less.

12. The battery electrode composition of claim 11, wherein:
the span #1 is 6.9×10⁻² or less; or
the span #2 is 5.2×10⁻² or less; or
the span #3 is 4.1×10⁻² or less; or
the span #4 is 3.3×10⁻² or less; or
the span #5 is 2.7×10⁻² or less.

13. The battery electrode composition of claim 1, wherein:
a span ratio #A1, which is (1-1) a span #L1 of the adjusted mass fractions between a 5^{th} percentile and a 35^{th} percentile of the population, divided by a span #R1 of the adjusted mass fractions between a 65^{th} percentile and a 95^{th} percentile of the population if the span #L1 is less than or equal to the span #R1, or (1-2) the span #R1 divided by the span #L1 if the span #R1 is less than the span #L1, is in a range of 0.14 to 1.0; or
a span ratio #A2, which is (2-1) a span #L2 of the adjusted mass fractions between a 10^{th} percentile and a 40^{th} percentile of the population, divided by a span #R2 of the adjusted mass fractions between a 60^{th} percentile and a 90^{th} percentile of the population if the span #L2 is less than or equal to the span #R2, or (2-2) the span #R2 divided by the span #L2 if the span #R2 is less than the span #L2, is in a range of 0.18 to 1.0; or
a span ratio #A3, which is (3-1) a span #L3 of the adjusted mass fractions between a 15^{th} percentile and a 45^{th} percentile of the population, divided by a span #R3 of the adjusted mass fractions between a 55^{th} percentile and a 85^{th} percentile of the population if the span #L3 is less than or equal to the span #R3, or (3-2) the span #R3 divided by the span #L3 if the span #R3 is less than the span #L3, is in a range of 0.25 to 1.0; or
a span ratio #A4, which is (4-1) a span #L4 of the adjusted mass fractions between a 20^{th} percentile and a 50^{th} percentile of the population, divided by a span #R4 of the adjusted mass fractions between a 50^{th} percentile and an 80^{th} percentile of the population if the span #L4 is less than or equal to the span #R4, or (4-2) the span #R4 divided by the span #L4 if the span #R4 is less than the span #L4, is in a range of 0.33 to 1.0.

14. The battery electrode composition of claim 13, wherein:
the span ratio #A1 is in a range of 0.61 to 1.0; or
the span ratio #A2 is in a range of 0.67 to 1.0; or
the span ratio #A3 is in a range of 0.73 to 1.0; or
the span ratio #A4 is in a range of 0.80 to 1.0.

15. The battery electrode composition of claim 14, wherein:
the span ratio #A1 is in a range of 0.94 to 1.0; or
the span ratio #A2 is in a range of 0.97 to 1.0; or
the span ratio #A3 is in a range of 0.98 to 1.0; or
the span ratio #A4 is in a range of 0.98 to 1.0.

16. The battery electrode composition of claim 1, wherein:
the mean corresponds to a mass fraction of the Si in the (nano)composite particles in a range of 35 to 70 wt. % as estimated by thermogravimetric analysis (TGA) or in a range of 59 to 97 wt. % as estimated by scanning electron microscopy with energy dispersive x-ray spectroscopy (SEM-EDX) analysis.

17. The battery electrode composition of claim 16, wherein:
the mass fraction of the Si in the (nano)composite particles is in a range of 40 to 60 wt. % by TGA or in a range of 64 to 86 wt. % by SEM-EDX analysis.

18. The battery electrode composition of claim 1, wherein:
the (nano)composite particles comprise protective material thereon; and
the protective material comprises one or more of the following: protective carbon, hydrocarbon, polymer, silicon oxide, silicon nitride, silicon phosphide, and ceramic material.

19. The battery electrode composition of claim 18, wherein:
a Brunauer-Emmett-Teller specific surface area (BET-SSA) of the population is in a range of about 0.5 m²/g to about 18 m²/g.

20. The battery electrode composition of claim 19, wherein:
the BET-SSA is in a range of about 0.5 m²/g to about 9 m²/g.

21. The battery electrode composition of claim 20, wherein:
the BET-SSA is in a range of about 0.5 m²/g to about 5 m²/g.

22. The battery electrode composition of claim 1, further comprising a binder and/or conductive additives.

23. The battery electrode composition of claim 1, wherein:
the battery electrode composition comprises an electrode active material, the electrode active material comprising the (nano)composite particles and excluding any binder; and
a composite mass fraction of the (nano)composite particles in the electrode active material is in a range of 10 to 100 wt. %.

24. The battery electrode composition of claim 23, wherein:
the electrode active material comprises graphite particles mixed with the (nano)composite particles.

25. The battery electrode composition of claim 23, wherein:
(a1) the composite mass fraction is in a range of 45 to 100 wt. % or (a2) the electrode active material exhibits a first-cycle lithiation capacity of at least 1300 mAh/g;
the population is characterized by a particle size distribution (PSD) as determined by laser particle size distribution analysis (LPSA), the PSD being described by a tenth-percentile volume-weighted particle size parameter (D₁₀), a fiftieth-percentile volume-weighted particle size parameter (D₅₀), a ninetieth-percentile volume-weighted particle size parameter (D₉₀), a ninety-ninth-percentile volume-weighted particle size parameter (D₉₉), a PSD span defined as (D₉₀-D₁₀)/D₅₀, a right PSD span defined as (D₉₀-D₅₀)/D₅₀, a left PSD span defined (D₅₀-D₁₀)/D₅₀, an extended PSD span defined as (D₉₉-D₁₀)/D₅₀, and an extended right PSD span defined as (D₉₉-D₅₀)/D₅₀;
(a3) the D₁₀ is in a range of 1.0 to 4.5 μm; and
(a4) the PSD span is 0.85 or greater, or (a5) the right PSD span is 0.50 or greater, or (a6) the left PSD span is 0.35 or greater, or (a7) the extended PSD span is 1.30 or greater, or (a8) the extended right PSD span is 0.95 or greater.

26. The battery electrode composition of claim 25, wherein:
(b1) the composite mass fraction is in a range of 55 to 100 wt. % or (b2) the first-cycle lithiation capacity is at least 1500 mAh/g;
(b3) the D₁₀ is in a range of 1.0 to 4.0 μm; and
(b4) the PSD span is 1.00 or greater, or (b5) the right PSD span is 0.60 or greater, or (b6) the left PSD span is 0.40 or greater, or (b7) the extended PSD span is 1.50 or greater, or (b8) the extended right PSD span is 1.10 or greater.

27. The battery electrode composition of claim 26, wherein:
(c1) the composite mass fraction is in a range of 65 to 100 wt. % or (c2) the first-cycle lithiation capacity is at least 1700 mAh/g;
(c3) the D₁₀ is in a range of 1.0 to 3.5 μm; and
(c4) the PSD span is 1.15 or greater, or (c5) the right PSD span is 0.70 or greater, or (c6) the left PSD span is 0.45 or greater, or (c7) the extended PSD span is 1.70 or greater, or (c8) the extended right PSD span is 1.25 or greater.

28. The battery electrode composition of claim 27, wherein:
(d1) the composite mass fraction is in a range of 75 to 100 wt. % or (d2) the first-cycle lithiation capacity is at least 1900 mAh/g;
(d3) the D₁₀ is in a range of 1.0 to 3.0 μm; and
(d4) the PSD span is 1.30 or greater, or (d5) the right PSD span is 0.80 or greater, or (d6) the left PSD span is 0.50 or greater, or (d7) the extended PSD span is 1.90 or greater, or (d8) the extended right PSD span is 1.40 or greater.

29. The battery electrode composition of claim 28, wherein:
(e1) the composite mass fraction is in a range of 85 to 100 wt. % or (e2) the first-cycle lithiation capacity is at least 2100 mAh/g;
(e3) the D₁₀ is in a range of 1.5 to 3.0 μm; and
(e4) the PSD span is 1.40 or greater, or (e5) the right PSD span is 0.85 or greater, or (e6) the left PSD span is 0.55 or greater, or (e7) the extended PSD span is 2.10 or greater, or (e8) the extended right PSD span is 1.55 or greater.

30. The battery electrode composition of claim 1, wherein:
the Si is amorphous as determined by x-ray diffraction.

31. The battery electrode composition of claim 1, wherein:
the Si exhibits an average crystalline grain size of 10 nm or less, as determined by x-ray diffraction.

32. The battery electrode composition of claim 31, wherein:
the average crystalline grain size is 5 nm or less.

33. A battery electrode, comprising:
the battery electrode composition of claim 1 disposed on or in a current collector.

34. A lithium-ion battery, comprising:
the battery electrode of claim 33 configured as an anode;
a cathode; and
an electrolyte ionically coupling the anode and the cathode.
